(19) United States
(12) Patent Application Publication
(10) Pub. No.: US 2022/0089810 A1
(43) Pub. Date: Mar. 24, 2022

(54) POLYCYCLIC POLYPHENOLIC RESIN AND METHOD FOR PRODUCING POLYCYCLIC POLYPHENOLIC RESIN

(71) Applicant: Mitsubishi Gas Chemical Company, Inc., Tokyo (JP)

(72) Inventors: Tadashi OMATSU, Hiratsuka-shi, Kanagawa (JP); Hiroaki YAMAMOTO, Hiratsuka-shi, Kanagawa (JP); Junya HORIUCHI, Hiratsuka-shi, Kanagawa (JP); Takashi MAKINOSHIMA, Hiratsuka-shi, Kanagawa (JP); Masatoshi ECHIGO, Chiyoda-ku, Tokyo (JP)

(21) Appl. No.: 17/421,691

(22) PCT Filed: Jan. 10, 2020
(86) PCT No.: PCT/JP2020/000772

§ 371 Date: Jul. 8, 2021

(30) Foreign Application Priority Data
Jan. 11, 2019 (JP) 2019-003493

(51) Int. Cl. C08G 61/10

(52) U.S. Cl. CPC C08G 61/10; C08G 2261/1422; C08G 2261/43; C08G 2261/314; C08G 2261/76; C08G 2261/312

(57) ABSTRACT

A polycyclic polyphenolic resin having a repeating unit derived from at least one monomer selected from the group consisting of an aromatic hydroxy compound represented by the following formulae (1A) and (1B),
wherein the repeating units are linked to each other by a direct bond between aromatic rings,

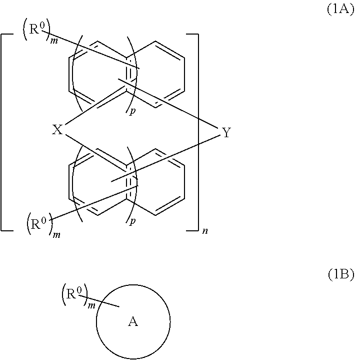

wherein X represents an oxygen atom, a sulfur atom, a single bond or non-crosslinked state, and Y represents a 2n-valent group having 1 to 60 carbon atoms or a single bond, wherein when X is non-crosslinked state, Y represents the 2n-valent group; A represents a benzene ring or a fused ring; each R⁰ is independently an alkyl group having 1 to 40 carbon atoms and optionally having a substituent, an aryl group having 6 to 40 carbon atoms and optionally having a substituent, an alkenyl group having 2 to 40 carbon atoms and optionally having a substituent, an alkynyl group having 2 to 40 carbon atoms, an alkoxy group having 1 to 40 carbon atoms and optionally having a substituent, a halogen atom, a thiol group, or a hydroxy group, wherein at least one R⁰ is a hydroxy group; and each m is independently an integer of 1 to 9; and n is an integer of 1 to 4; and each p is independently an integer of 0 to 3.

### TECHNICAL FIELD

The present invention relates to a polycyclic polyphenolic resin and a method for producing a polycyclic polyphenolic resin.

### BACKGROUND ART

Polyphenol-based resins having a repeating unit derived from a hydroxy-substituted aromatic compound or the like are known as sealants, coating agents, resist materials, and semiconductor underlayer film forming materials for semiconductors. For example, Patent Literatures 1 and 2 propose the use of a polyphenol compound or resin having a specific skeleton.

Incidentally, as a method for producing a polyphenol-based resin, there is known a method for producing a novolac resin or a resol resin by addition-condensation of a phenol and formalin in the presence of an acid or an alkali catalyst. However, in the method for producing a phenol resin, formaldehyde, which has been pointed out to have a risk of impairing human health in recent years, is used as a raw material for the phenol resin, and safety has become an issue. As a method for producing a polyphenol-based resin to solve this problem, there has been proposed a method for producing a phenol polymer by oxidative polymerization of a phenol in a solvent such as water or an organic solvent using an enzyme having a peroxidase activity such as peroxidase and a peroxide such as hydrogen peroxide. Further, there is also known a method for producing polyphenylene oxide (PPO) by oxidative polymerization of 2,6-dimethylphenol (see Non Patent Literature 1).

### CITATION LIST

### Patent Literature

Patent Literature 1: International Publication No. WO 2013/024778
Patent Literature 2: International Publication No. WO 2013/024779

### Non Patent Literature

Non Patent Literature 1: Hideyuki Higashimura, Shiro Kobayashi, Chemistry and Industry, 53, 501 (2000)

### SUMMARY OF INVENTION

### Technical Problem

The materials described in Patent Literatures 1 and 2 still have room for improvement in performance such as heat resistance and etching resistance, and there is a need to develop new materials that are even better in these properties.

Further, the polyphenol-based resin obtained based on the method of Non Patent Literature 1 usually has, as constituent units, both an oxyphenol unit obtained by forming a bond between a carbon atom on the aromatic ring of one phenol as a monomer and a phenolic hydroxy group of the other phenol, and a unit obtained by bonding between carbon atoms on the aromatic ring of a phenol as a monomer and having a phenolic hydroxy group in the resulting molecule. Such a polyphenol-based resin becomes a flexible polymer because the aromatic rings are bonded to each other via oxygen atoms, but from the viewpoint of crosslinkability and heat resistance, it is not preferable because the phenolic hydroxy groups disappear.

The present invention has been made in view of the above problems, and an object thereof is to provide a polycyclic polyphenolic resin having more excellent performance such as heat resistance and etching resistance, and a method for producing the polycyclic polyphenolic resin.

### Solution to Problem

In view of the above circumstances, the present inventors conducted intensive research and found that the above problems can be solved by polycyclic polyphenolic resin having a specific structure, thereby completing the present invention.

Specifically, the present invention includes the following aspects.

[1]

A polycyclic polyphenolic resin having a repeating unit derived from at least one monomer selected from the group consisting of an aromatic hydroxy compound represented by the following formulae (1A) and (1B),

wherein the repeating units are linked to each other by a direct bond between aromatic rings:

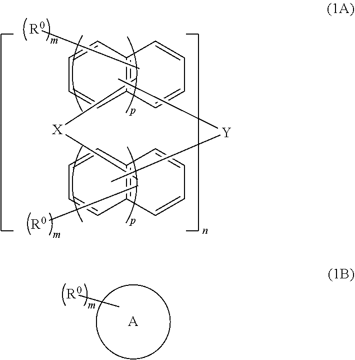

wherein X represents an oxygen atom, a sulfur atom, a single bond or non-crosslinked state, and Y represents a 2n-valent group having 1 to 60 carbon atoms or a single bond, wherein when X is non-crosslinked state, Y represents the 2n-valent group; A represents a benzene ring or a fused ring; each R⁰ is independently an alkyl group having 1 to 40 carbon atoms and optionally having a substituent, an aryl group having 6 to 40 carbon atoms and optionally having a substituent, an alkenyl group having 2 to 40 carbon atoms and optionally having a substituent, an alkynyl group having 2 to 40 carbon atoms and optionally having a substituent, an alkoxy group having 1 to 40 carbon atoms and optionally having a substituent, a halogen atom, a thiol group, or a hydroxy group, wherein at least one R⁰ is a hydroxy group; and each m is independently an integer of 1 to 9; and n is an integer of 1 to 4; and each p is independently an integer of 0 to 3.
[2]

The polycyclic polyphenolic resin according to [1], wherein the aromatic hydroxy compound represented by the formula (1A) is an aromatic hydroxy compound represented by the following formula (1):

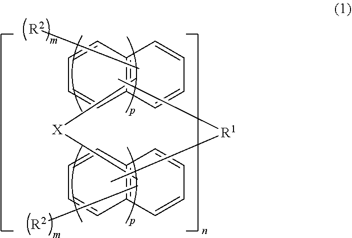

wherein X, m, n, and p are as defined in the formula (1A); R¹ is as defined in Y in the formula (1A); and each R² is independently an alkyl group having 1 to 40 carbon atoms, an aryl group having 6 to 40 carbon atoms, an alkenyl group having 2 to 40 carbon atoms, an alkynyl group having 2 to 40 carbon atoms, an alkoxy group having 1 to 40 carbon atoms, a halogen atom, a thiol group, or a hydroxy group, wherein at least one R² is a hydroxy group.
[3]

The polycyclic polyphenolic resin according to [2], wherein the aromatic hydroxy compound represented by the formula (1) is an aromatic hydroxy compound represented by the following formula (1-1):

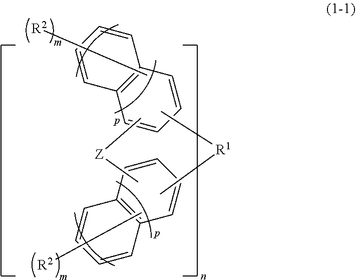

wherein Z is an oxygen atom or a sulfur atom; and R¹, R², m, p, and n are as defined in the formula (1).
[4]

The polycyclic polyphenolic resin according to [3], wherein the aromatic hydroxy compound represented by the formula (1-1) is an aromatic hydroxy compound represented by the following formula (1-2):

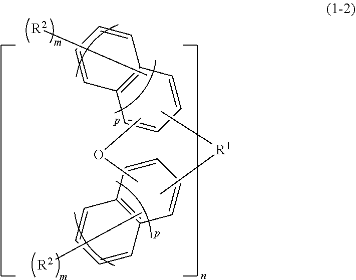

wherein R¹, R², m, p, and n are as defined in the formula (1).
[5]

The polycyclic polyphenolic resin according to [4], wherein the aromatic hydroxy compound represented by the formula (1-2) is an aromatic hydroxy compound represented by the following formula (1-3):

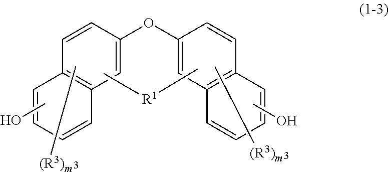

wherein R¹ is as defined in the formula (1); each R³ is independently an alkyl group having 1 to 40 carbon atoms, an aryl group having 6 to 40 carbon atoms, an alkenyl group having 2 to 40 carbon atoms, an alkynyl group having 2 to 40 carbon atoms, an alkoxy group having 1 to 40 carbon atoms, a halogen atom, or a thiol group; and each m³ is independently an integer of 0 to 5.
[6]

The polycyclic polyphenolic resin according to [1], wherein the aromatic hydroxy compound represented by the formula (1A) is an aromatic hydroxy compound represented by the following formula (2):

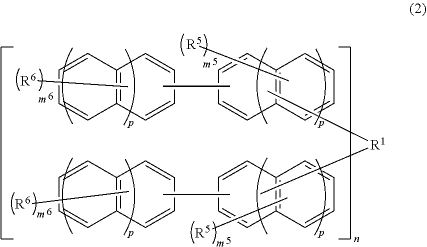

wherein R¹ is as defined in Y in the formula (1A); and R⁵, n, and p are as defined in the formula (1A), each R⁶ is independently a hydrogen atom, an alkyl group having 1 to 34 carbon atoms, an aryl group having 6 to 34 carbon atoms, an alkenyl group having 2 to 34 carbon atoms, an alkynyl group having 2 to 40 carbon atoms, an alkoxy group having 1 to 34 carbon atoms, a halogen atom, a thiol group, or a hydroxy group; each m⁵ is independently an integer of 1 to 6; and each m⁶ is independently an integer of 1 to 7, wherein at least one R⁵ is a hydroxy group.
[7]

The polycyclic polyphenolic resin according to [6], wherein the aromatic hydroxy compound represented by the formula (2) is an aromatic hydroxy compound represented by the following formula (2-1):

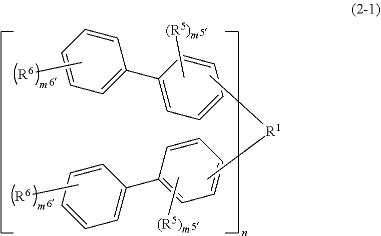

wherein R¹, R⁵, R⁶, and n are as defined in the formula (2); each m⁵′ is independently an integer of 1 to 4; and each m⁶′ is independently an integer of 1 to 5, wherein at least one R⁵ is a hydroxy group.
[8]

The polycyclic polyphenolic resin according to [6] or [7], wherein at least one R⁶ is a hydroxy group.

[9]

The polycyclic polyphenolic resin according to [7] or [8], wherein the aromatic hydroxy compound represented by the formula (2-1) is an aromatic hydroxy compound represented by the following formula (2-2):

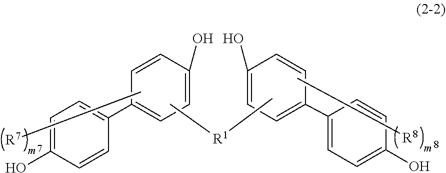

wherein R¹ is as defined in the formula (2); R⁷ and R⁸ are each independently a hydrogen atom, an alkyl group having 1 to 40 carbon atoms, an aryl group having 6 to 40 carbon atoms, an alkenyl group having 2 to 40 carbon atoms, an alkynyl group having 2 to 40 carbon atoms, an alkoxy group having 1 to 40 carbon atoms, a halogen atom, a thiol group, or a hydroxy group; and m⁷ and m⁸ are each independently an integer of 0 to 7.
[10]

The polycyclic polyphenolic resin according to any one of [1] to [9], further having a modified moiety derived from a crosslinking compound.

[11]

The polycyclic polyphenolic resin according to [10], wherein the crosslinking compound is an aldehyde or a ketone.

[12]

The polycyclic polyphenolic resin according to any one of [1] to [11], wherein the polycyclic polyphenolic resin has a mass average molecular weight of 400 to 100,000.

[13]

The polycyclic polyphenolic resin according to any one of claims 1 to 12, wherein the polycyclic polyphenolic resin has a solubility in 1-methoxy-2-propanol and/or propylene glycol monomethyl ether acetate of 1% by mass or more.

[14]

The polycyclic polyphenolic resin according to any one of claims 1 to 13, wherein A in the formula (1B) is the fused ring.

[15]

The polycyclic polyphenolic resin according to any one of claims 2 to 14, wherein the R¹ is a group represented by R^{A}—R^{B}, wherein R^{A} is a methine group, and R^{B} is an aryl group having 6 to 30 carbon atoms and optionally having a substituent.

[16]

A composition comprising the polycyclic polyphenolic resin according to any one of claims 1 to 15.

[17]

The composition according to claim 16, further comprising a solvent.

[18]

The composition according to claim 17, wherein the solvent comprises one or more selected from the group consisting of propylene glycol monomethyl ether, propylene glycol monomethyl ether acetate, cyclohexanone, cyclopentanone, ethyl lactate, and methyl hydroxyisobutyrate.

[19]

The composition according to any one of claims 16 to 18, wherein a content of impurity metal is less than 500 ppb for each metallic species.

[20]

The composition according to claim 19, wherein the impurity metal comprises at least one selected from the group consisting of copper, manganese, iron, cobalt, ruthenium, chromium, nickel, tin, lead, silver and palladium.

[21]

The composition according to claim 19 or 20, wherein the content of the impurity metal is 1 ppb or less.

[22]

A method for producing the polycyclic polyphenolic resin according to any one of claims 1 to 15, the method comprising:

polymerizing one or more aromatic hydroxy compounds in a presence of an oxidizing agent.

[23]

The method for producing the polycyclic polyphenolic resin according to claim 22, wherein the oxidizing agent is a metal salt or a metal complex comprising at least one selected from the group consisting of copper, manganese, iron, cobalt, ruthenium, chromium, nickel, tin, lead, silver and palladium.

### Advantageous Effects of Invention

According to the present invention, it is possible to provide a polycyclic polyphenolic resin having more excellent performance such as heat resistance and etching resistance, and a method for producing the polycyclic polyphenolic resin.

### DESCRIPTION OF EMBODIMENT

An embodiment for carrying out the present invention (hereinafter referred to as “the present embodiment”) will be described in detail below, but the present invention is not limited to this, and various modifications can be made without departing from the spirit thereof.

### [Polycyclic Polyphenolic Resin]

A polycyclic polyphenolic resin of the present embodiment is a polycyclic polyphenolic resin having a repeating unit derived from at least one monomer selected from the group consisting of an aromatic hydroxy compound represented by the following formulae (1A) and (1B), in which the repeating units are linked to each other by a direct bond between aromatic rings. Since the polycyclic polyphenolic resin of the present embodiment is configured as described above, the polycyclic polyphenolic resin has more excellent performance such as heat resistance and etching resistance.

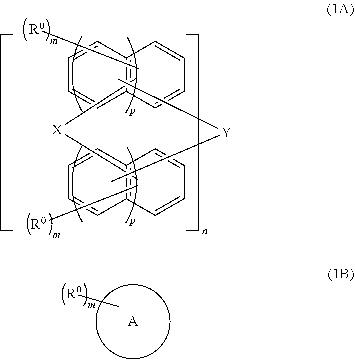

(In the formula (1A), X represents an oxygen atom, a sulfur atom, a single bond or non-crosslinked state, and Y represents a 2n-valent group having 1 to 60 carbon atoms or a single bond, wherein when X is non-crosslinked state, Y represents the 2n-valent group. In the formula (1B), A represents a benzene ring or a fused ring. In the formulas (1A) and (1B), each R⁰ is independently an alkyl group having 1 to 40 carbon atoms and optionally having a substituent, an aryl group having 6 to 40 carbon atoms and optionally having a substituent, an alkenyl group having 2 to 40 carbon atoms and optionally having a substituent, an alkynyl group having 2 to 40 carbon atoms and optionally having a substituent, an alkoxy group having 1 to 40 carbon atoms and optionally having a substituent, a halogen atom, a thiol group, or a hydroxy group, wherein at least one R⁰ is a hydroxy group; and each m is independently an integer of 1 to 9, provided that all m are not 0 at the same time. n is an integer of 1 to 4; and each p is independently an integer of 0 to 3.)

The polycyclic polyphenolic resin of the present embodiment typically has the following characteristics (1) to (4), but is not limited thereto:

(1) The polycyclic polyphenolic resin of the present embodiment has excellent solubility in an organic solvent (particularly, a safe solvent). Therefore, for example, when the polycyclic polyphenolic resin of the present embodiment is used as a film forming material for lithography, films for lithography can be formed by a wet process such as spin coating or screen printing.
(2) In the polycyclic polyphenolic resin of the present embodiment, the carbon concentration is relatively high and the oxygen concentration is relatively low. In addition, since the polycyclic polyphenolic resin according to the present embodiment has a phenolic hydroxy group in the molecule, it is useful for formation of a cured product through the reaction with a curing agent, but it can also form a cured product on its own through the crosslinking reaction of the phenolic hydroxy group upon baking at a high temperature. Due to the above, the polyphenolic resin of the present embodiment can exhibit high heat resistance, and when used as a film forming material for lithography, degradation of the film upon baking at a high temperature is suppressed and a film for lithography excellent in etching resistance to oxygen plasma etching and the like can be formed.
(3) The polycyclic polyphenolic resin of the present embodiment can exhibit high heat resistance and etching resistance, as described above, and also has excellent adhesiveness to a resist layer and a resist intermediate layer film material. Therefore, when the polycyclic polyphenolic resin according to the present embodiment is used as a film forming material for lithography, films for lithography excellent in resist pattern formability can be formed. The term “resist pattern formability” herein refers to a property in which there are no major defects in the resist pattern shape and both resolution and sensitivity are excellent.
(4) The polycyclic polyphenolic resin of the present embodiment has a high refractive index due to its high aromatic ring density, and even after a heat treatment, coloration is suppressed and transparency is excellent.

It is considered that the polycyclic polyphenolic resin of the present embodiment can be preferably applied as a film forming material for lithography due to such properties, and thus the above desired characteristics are imparted to the film forming composition for lithography of the present embodiment. In particular, since the aromatic ring density is higher than that of a resin crosslinked with a divalent organic group or an oxygen atom, and the carbon-carbon atoms of the aromatic rings are linked to each other by a direct bond, it is considered that the resin has more excellent performance such as heat resistance and etching resistance, even if the resin has a relatively low molecular weight.

Hereinafter, the above formulas (1A) and (1B) will be described in detail.

In the formula (1A), X represents an oxygen atom, a sulfur atom, a single bond or non-crosslinked state. X is preferably an oxygen atom from the viewpoint of heat resistance.

In the formula (1A), Y represents a 2n-valent group having 1 to 60 carbon atoms or a single bond, wherein when X is non-crosslinked state, Y represents the 2n-valent group.

The 2n-valent group having 1 to 60 carbon atoms refers to, for example, a 2n-valent hydrocarbon group, and the hydrocarbon group may have various functional groups described later as substituents. Further, the 2n-valent hydrocarbon group refers to an alkylene group having 1 to 60 carbon atoms when n is 1, an alkanetetrayl group having 1 to 60 carbon atoms when n is 2, an alkanehexayl group having 2 to 60 carbon atoms when n is 3, and an alkaneoctayl group having 3 to 60 carbon atoms when n is 4. Examples of the 2n-valent group include in which an 2n+1 valent hydrocarbon group is bonded to a linear hydrocarbon group, a branched hydrocarbon group, or an alicyclic hydrocarbon group. Herein, the alicyclic hydrocarbon group also includes a bridged alicyclic hydrocarbon group.

Examples of the 2n+1-valent hydrocarbon group include, but not limited to, a 3-valent methine group and an ethyne group.

Further, the 2n-valent hydrocarbon group may have a double bond, a heteroatom, and/or an aryl group having 6 to 59 carbon atoms. Further, Y may contain a group derived from a compound having a fluorene skeleton such as fluorene or benzofluorene, but as used herein, the term “aryl group” is used to refer to a group that does not contain a group derived from a compound having a fluorene skeleton such as fluorene or benzofluorene.

In the present embodiment, the 2n-valent group may contain a halogen group, a nitro group, an amino group, a hydroxy group, an alkoxy group, a thiol group, or an aryl group having 6 to 40 carbon atoms. Furthermore, the 2n-valent group may contain an ether bond, a ketone bond, an ester bond, or a double bond.

In the present embodiment, from the viewpoint of heat resistance, the 2n-valent group preferably includes a branched hydrocarbon group or an alicyclic hydrocarbon group rather than a linear hydrocarbon group, and more preferably includes an alicyclic hydrocarbon group. Further, in the present embodiment, the 2n-valent group particularly preferably has an aryl group having 6 to 60 carbon atoms.

The linear hydrocarbon group and the branched hydrocarbon group which may be contained in the 2n-valent group as a substituent are not particularly limited, and examples thereof include an unsubstituted methyl group, an ethyl group, a n-propyl group, an i-propyl group, a n-butyl group, an i-butyl group, a t-butyl group, a n-pentyl group, a n-hexyl group, a n-dodecyl group, and a valeryl group.

Examples of substituents which may be included in the 2n-valent group include, but not particularly limited to, an alicyclic hydrocarbon group and an aromatic group having 6 to 60 carbon atoms, such as an unsubstituted phenyl group, a naphthalene group, a biphenyl group, an anthracyl group, a pyrenyl group, a cyclohexyl group, a cyclododecyl group, a dicyclopentyl group, a tricyclodecyl group, an adamantyl group, a phenylene group, a naphthalenediyl group, a biphenyldiyl group, an anthracenediyl group, a pyrendiyl group, a cyclohexanediyl group, a cyclododecanediyl group, a dicyclopentanediyl group, a tricyclodecanediyl group, an adamantanediyl group, a benzenetriyl group, a naphthalenetriyl group, a biphenyltriyl group, an anthracenetriyl group, a pyrenetriyl group, a cyclohexantriyl group, a cyclododecantriyl group, a dicyclopentanetriyl group, a tricyclodecantriyl group, an adamantanetriyl group, a benzenetetrayl group, a naphthalenetetrayl group, a biphenyltetrayl group, an anthracentetrayl group, a pyrenetrayl group, a cyclohexanetetrayl group, a cyclododecanetetrayl group, a dicyclopentanetetrayl group, a tricyclodecantetrayl group, and an adamantanetrayl group.

Each R⁰ is independently an alkyl group having 1 to 40 carbon atoms and optionally having a substituent, an aryl group having 6 to 40 carbon atoms and optionally having a substituent, an alkenyl group having 2 to 40 carbon atoms and optionally having a substituent, an alkynyl group having 2 to 40 carbon atoms and optionally having a substituent, an alkoxy group having 1 to 40 carbon atoms and optionally having a substituent, a halogen atom, a thiol group, or a hydroxy group. The alkyl group may be either linear, branched or cyclic.

Herein, at least one R⁰ is a hydroxy group.

Examples of the alkyl group having 1 to 40 carbon atoms include, but not limited to, a methyl group, an ethyl group, a n-propyl group, an i-propyl group, a n-butyl group, an i-butyl group, a t-butyl group, a n-pentyl group, a n-hexyl group, a n-dodecyl group, and a valeryl group.

Examples of the aryl group having 6 to 40 carbon atoms include, but not limited to, a phenyl group, a naphthalene group, a biphenyl group, an anthracyl group, a pyrenyl group, and a perylene group.

Examples of the alkenyl group having 2 to 40 carbon atoms include, but not limited to, an ethynyl group, a propenyl group, a butynyl group, and a pentynyl group.

Examples of the alkynyl group having 2 to 40 carbon atoms include, but not limited to, an acetylene group and an ethynyl group.

Examples of the alkoxy group having 1 to 40 carbon atoms include, but not limited to, a methoxy group, an ethoxy group, a propoxy group, a butoxy group, and a pentoxy group.

Each m is independently an integer of 1 to 9. From the viewpoint of solubility, m is preferably 1 to 6, more preferably 1 to 4, and from the viewpoint of availability of raw materials, still more preferably 1.

n is an integer of 1 to 4. From the viewpoint of solubility, n is preferably 1 to 2 and from the viewpoint of availability of raw materials, still more preferably 1.

Each p is independently an integer of 0 to 3. From the viewpoint of heat resistance, p is preferably 1 to 2 from the viewpoint of availability of raw materials, still more preferably 1.

In the present embodiment, as the aromatic hydroxy compound, those represented by any of the formulas (1A) and (1B) can be used alone, or two or more kinds thereof can be used together. In the present embodiment, from the viewpoint of achieving both solvent solubility and heat resistance, it is preferable to use the compound represented by the formula (1A) as the aromatic hydroxy compound. Further, from the viewpoint of achieving both solvent solubility and heat resistance, it is also preferable to use the compound represented by the formula (1B) as the aromatic hydroxy compound.

In the present embodiment, the aromatic hydroxy compound represented by the formula (1A) is preferably the compound represented by the following formula (1) from the viewpoint of ease of production.

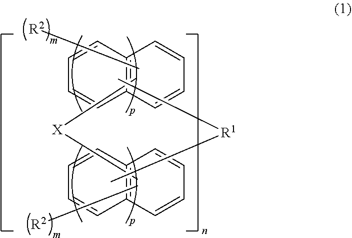

(In the formula (1), X, m, n, and p are as defined in the formula (1A); R¹ is as defined in Y in the formula (1A); and each R² is independently an alkyl group having 1 to 40 carbon atoms, an aryl group having 6 to 40 carbon atoms, an alkenyl group having 2 to 40 carbon atoms, an alkynyl group having 2 to 40 carbon atoms, an alkoxy group having 1 to 40 carbon atoms, a halogen atom, a thiol group, or a hydroxy group, wherein at least one R² is a hydroxy group.)

The aromatic hydroxy compound represented by the formula (1) is preferably an aromatic hydroxy compound represented by the following formula (1-1) from the viewpoint of heat resistance.

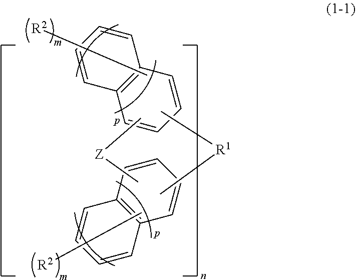

(In the formula (1-1), Z is an oxygen atom or a sulfur atom; and R¹, R², m, p, and n are as defined in the formula (1).)

Furthermore, the aromatic hydroxy compound represented by the formula (1-1) is preferably an aromatic hydroxy compound represented by the following formula (1-2) from the viewpoint of availability of raw materials.

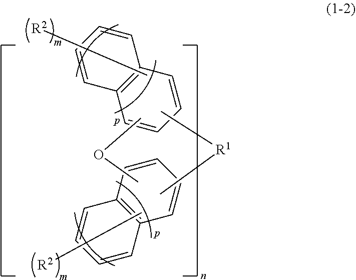

(In the formula (1-2), R¹, R², m, p and n are as defined in the formula (1).)

Furthermore, the aromatic hydroxy compound represented by the formula (1-2) is preferably an aromatic hydroxy compound represented by the following formula (1-3) from the viewpoint of improving solubility.

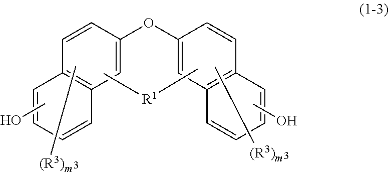

(In the formula (1-3), R¹ is as defined in the formula (1); each R³ is independently an alkyl group having 1 to 40 carbon atoms, an aryl group having 6 to 40 carbon atoms, an alkenyl group having 2 to 40 carbon atoms, an alkynyl group having 2 to 40 carbon atoms, an alkoxy group having 1 to 40 carbon atoms, a halogen atom, or a thiol group; and each m³ is independently an integer of 0 to 5.)

Further, the aromatic hydroxy compound represented by the formula (1A) is preferably an aromatic hydroxy compound represented by the following formula (2) from the viewpoint of dissolution stability.

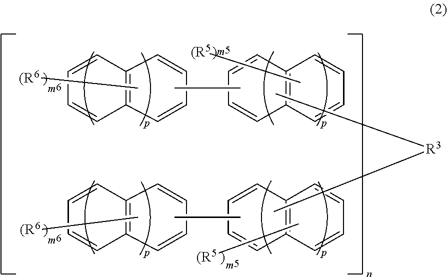

(In the formula (2), R¹ is as defined in Y in the formula (1A); R⁵, n, and p are as defined in the formula (1A); each R⁶ is independently a hydrogen atom, an alkyl group having 1 to 34 carbon atoms, an aryl group having 6 to 34 carbon atoms, an alkenyl group having 2 to 34 carbon atoms, an alkynyl group having 2 to 34 carbon atoms, an alkoxy group having 1 to 34 carbon atoms, a halogen atom, a thiol group, or a hydroxy group; each m⁵ is independently an integer of 1 to 6; and each m⁶ is independently an integer of 1 to 7, wherein at least one R⁵ is a hydroxy group.)

Furthermore, the aromatic hydroxy compound represented by the formula (2) is preferably an aromatic hydroxy compound represented by the following formula (2-1) from the viewpoint of dissolution stability.

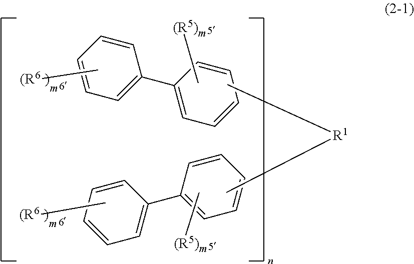

(In the formula (2-1), R¹, R⁵, R⁶, and n are as defined in the formula (2); each m⁵′ is independently an integer of 1 to 4; and each m⁶′ is independently an integer of 1 to 5, wherein at least one R⁵ is a hydroxy group.)

In the formula (2) or formula (2-1), at least one R⁶ is preferably a hydroxy group from the viewpoint of dissolution stability.

Furthermore, the aromatic hydroxy compound represented by the formula (2-1) is preferably an aromatic hydroxy compound represented by the following formula (2-2) from the viewpoint of availability of raw materials.

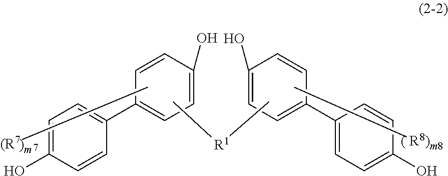

(In the formula (2-2), R¹ is as defined in the formula (2); R⁷ and R⁸ are each independently a hydrogen atom, an alkyl group having 1 to 40 carbon atoms, an aryl group having 6 to 40 carbon atoms, an alkenyl group having 2 to 40 carbon atoms, an alkynyl group having 2 to 34 carbon atoms, an alkoxy group having 1 to 40 carbon atoms, a halogen atom, a thiol group, or a hydroxy group; and m⁷ and m⁸ are each independently an integer of 0 to 7.)

In the formula (1), the formula (1-1), the formula (1-2), the formula (1-3), the formula (2), the formula (2-1), or the formula (2-2), it is preferable that the R¹ is a group represented by R^{A}—R^{B}, in which R^{A} is a methine group, and R^{B} is an aryl group having 6 to 30 carbon atoms and optionally having a substituent, from the viewpoint of further high heat resistance and solubility. In the present embodiment, examples of the aryl group having 6 to 30 carbon atoms include, but not limited to, a phenyl group, a naphthalene group, a biphenyl group, an anthracyl group, and a pyrenyl group. As described above, the group derived from a compound having a fluorene skeleton such as fluorene or benzofluorene is not included in the “aryl group having 6 to 30 carbon atoms”.

Specific examples of the aromatic hydroxy compound represented by the formula (1A), the formula (1), the formula (1-1), the formula (1-2), the formula (1-3), the formula (2), the formula (2-1), or the formula (2-2) will be listed below, but are not limited thereto.

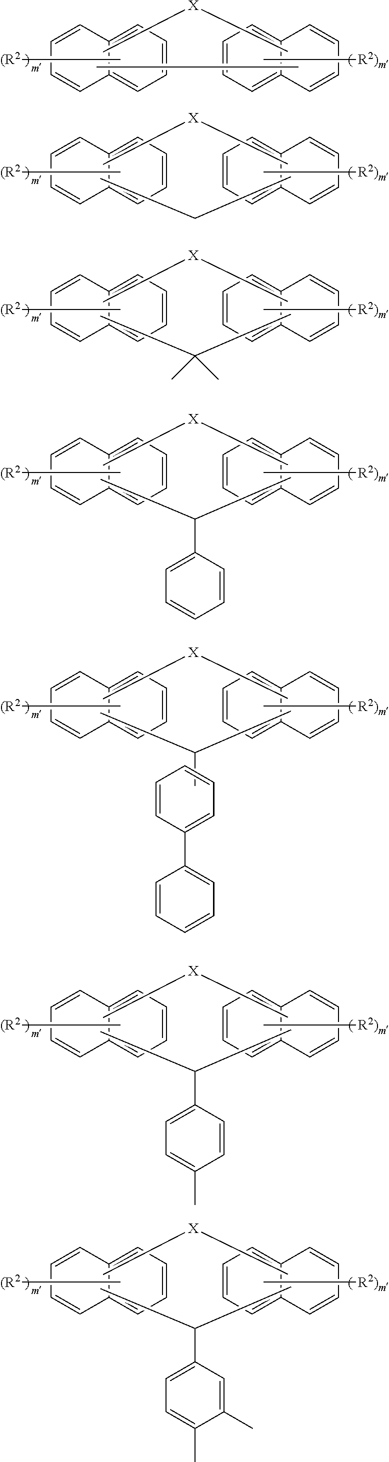

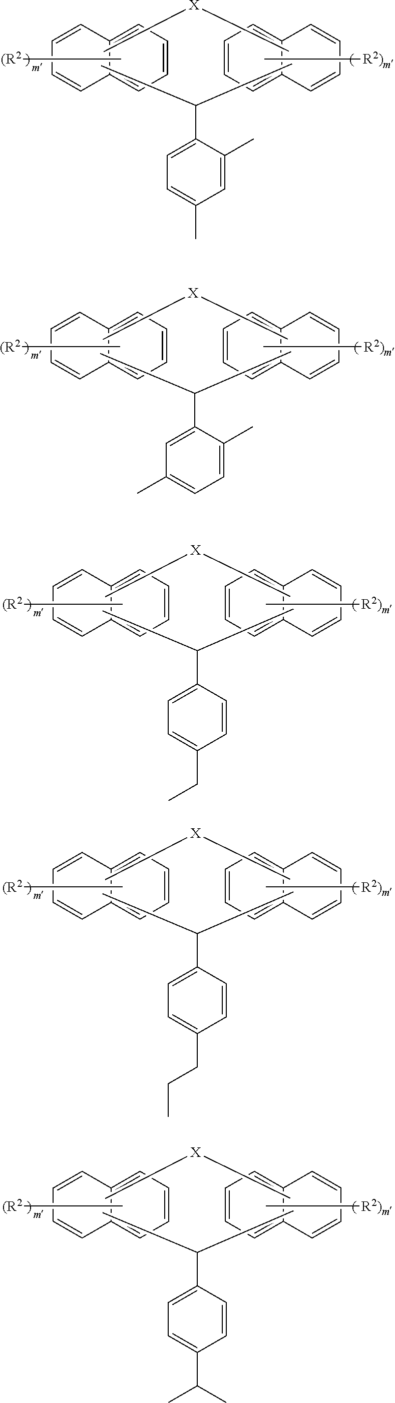

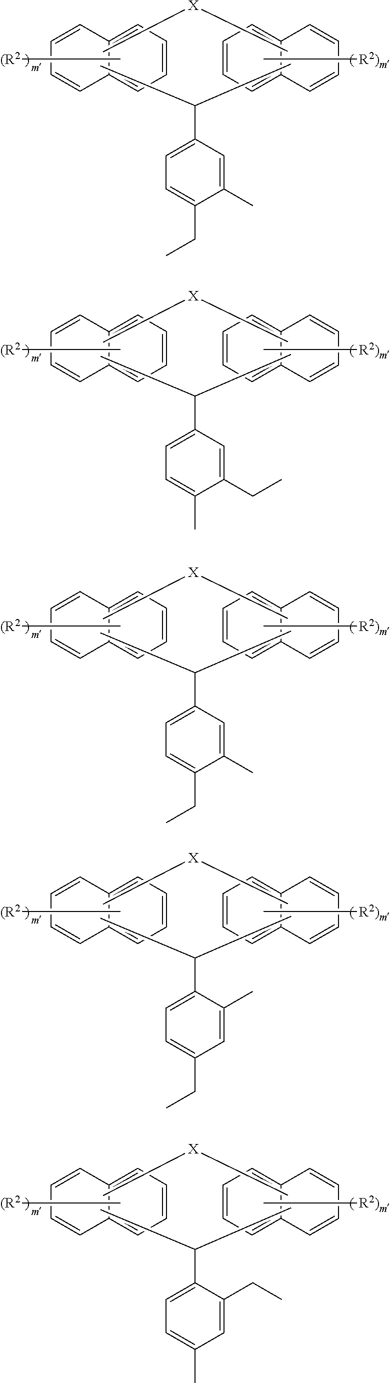

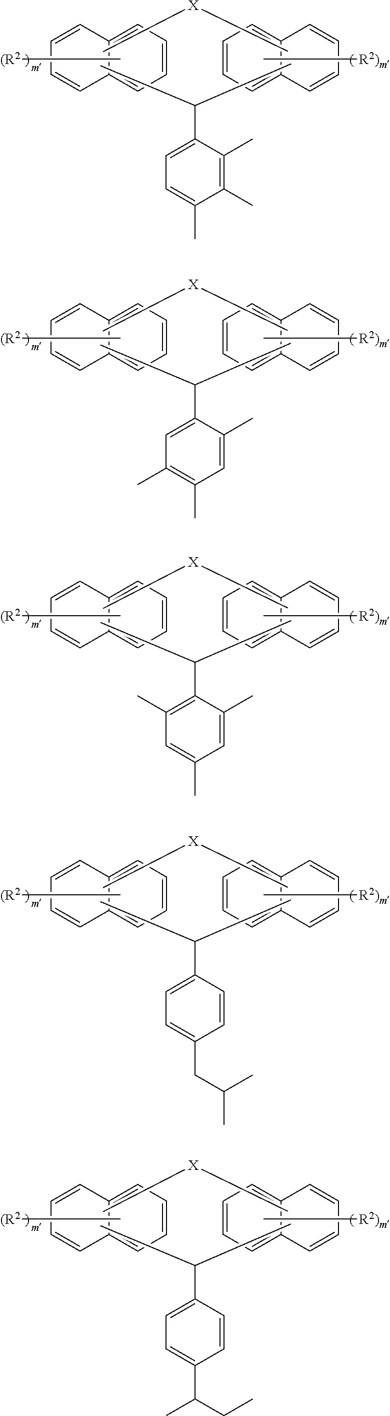

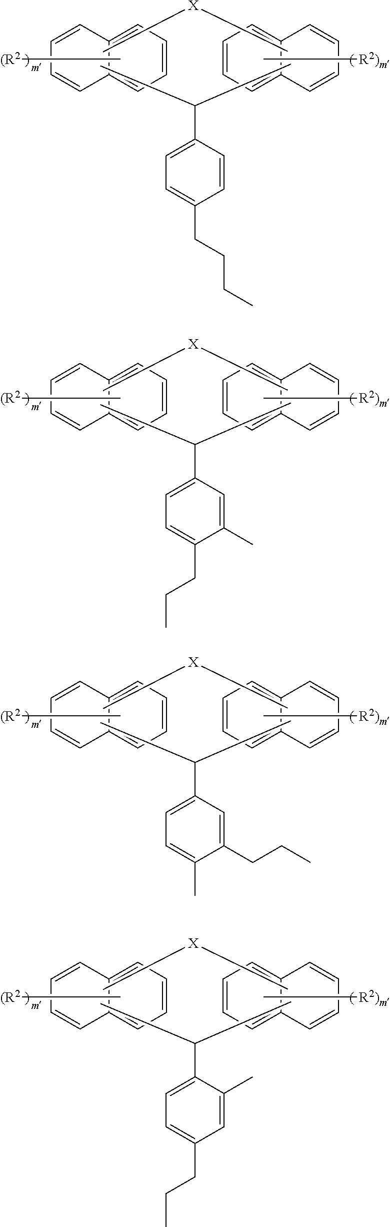

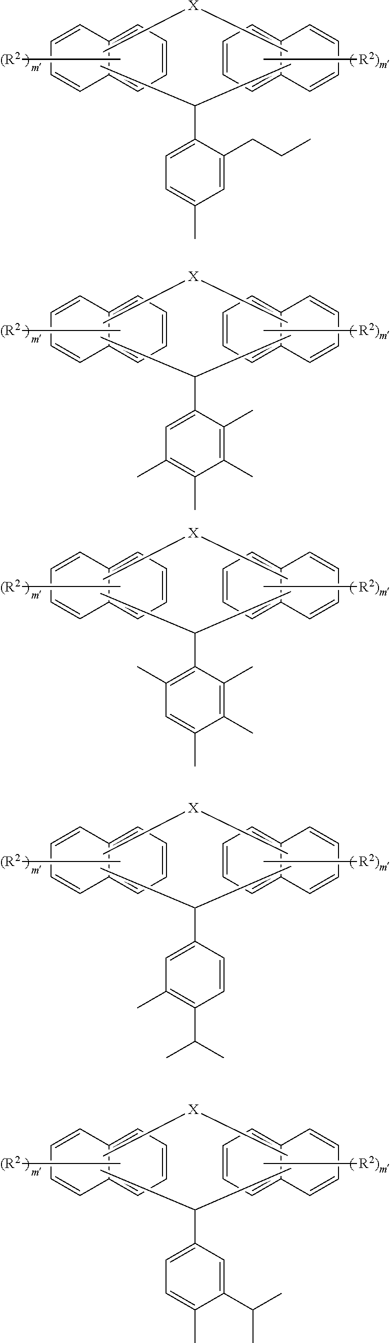

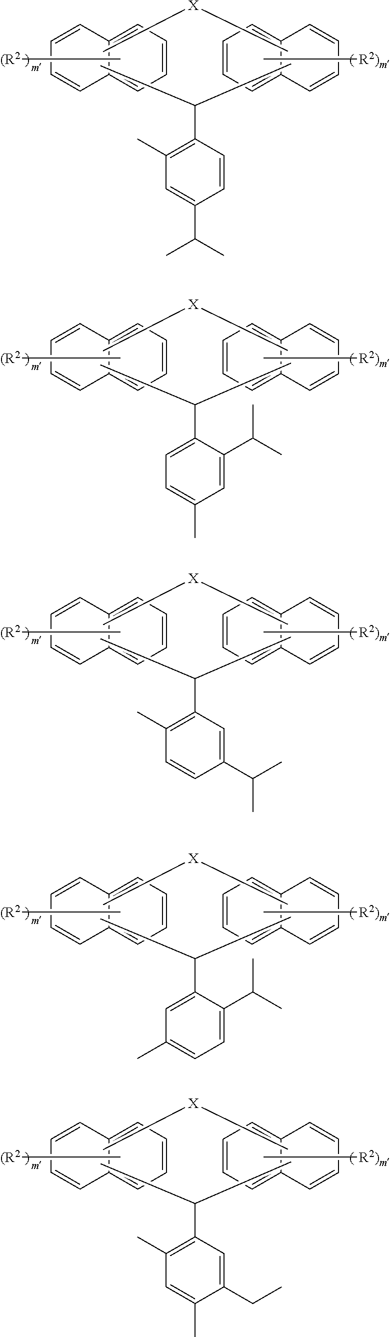

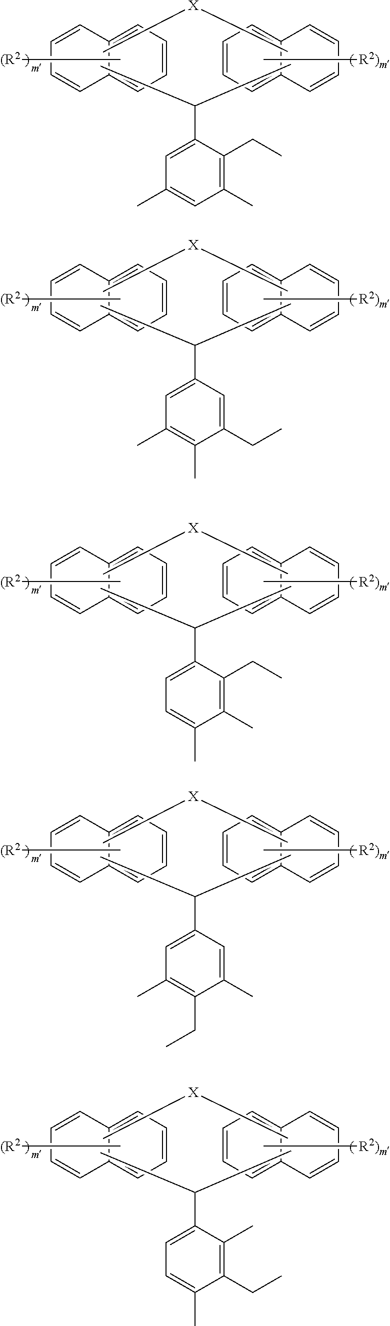

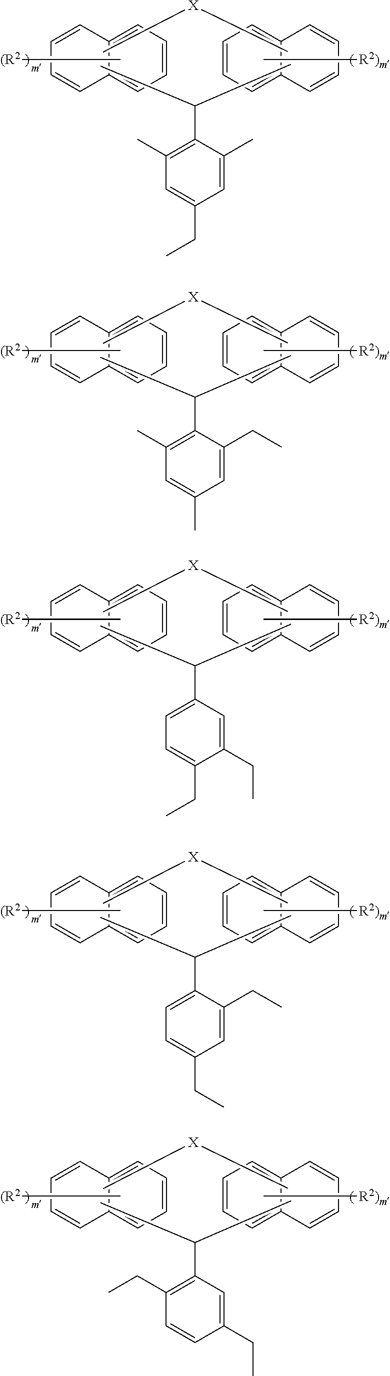

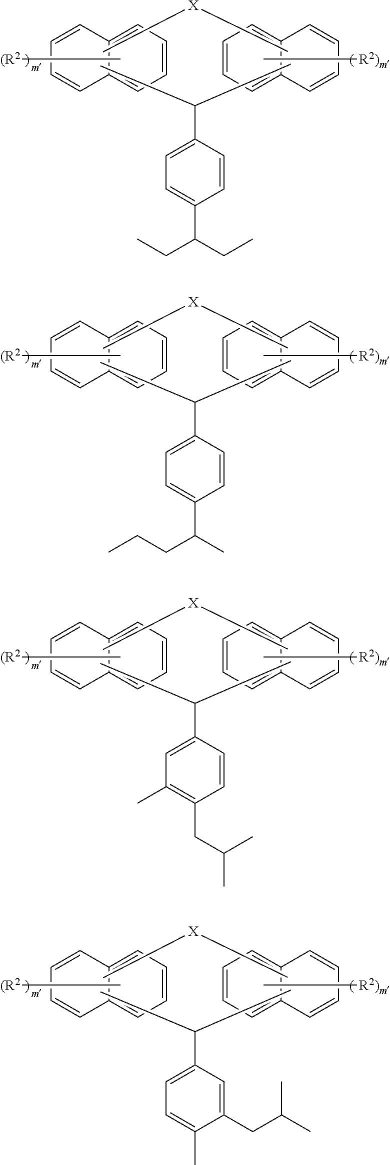

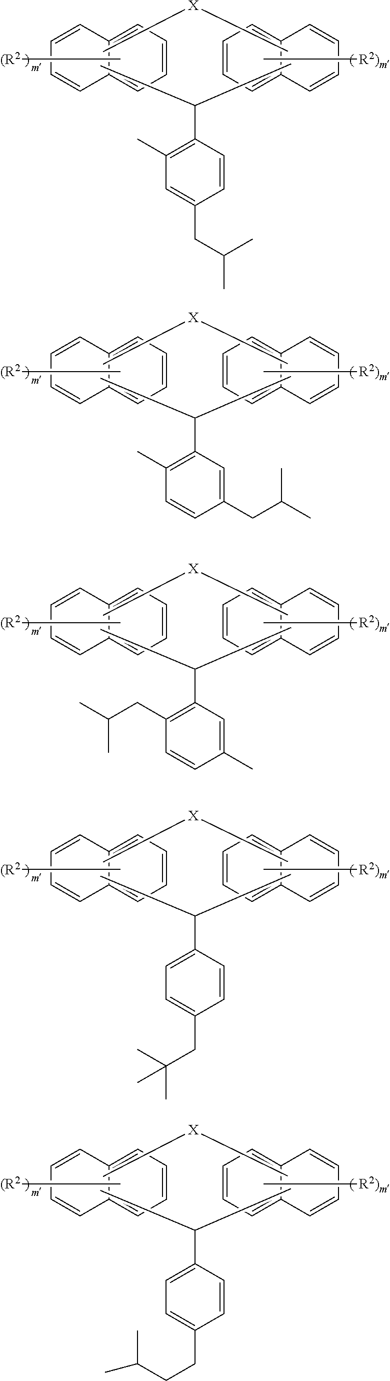

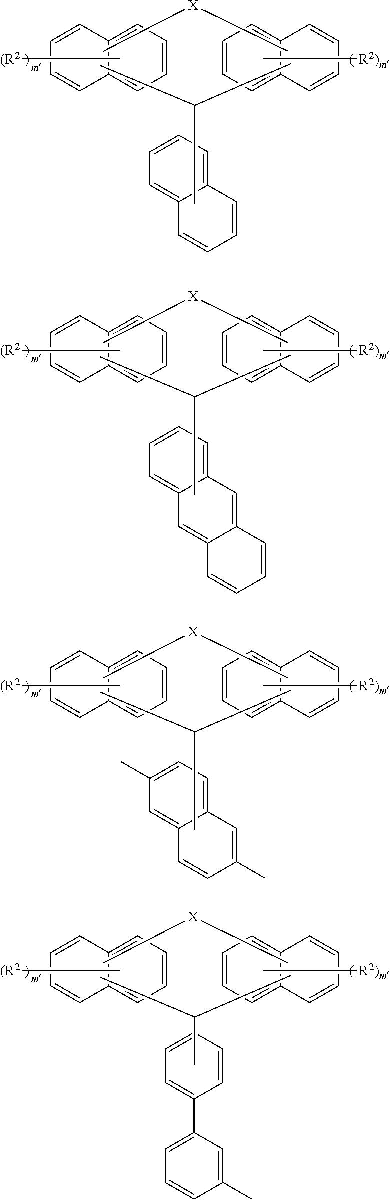

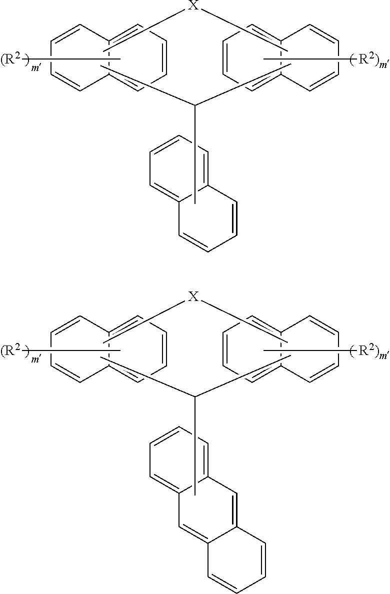

In the formulas, R² and X are as defined in the formula (1). m′ is an integer of 1 to 7. Herein, at least one R² is a hydroxy group.

Specific examples of the aromatic hydroxy compound according to the present embodiment will be further listed below, but are not limited thereto.

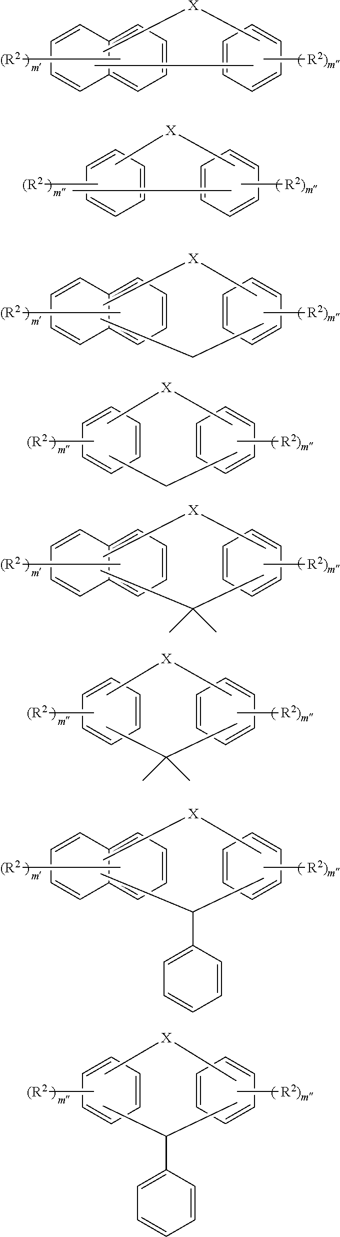

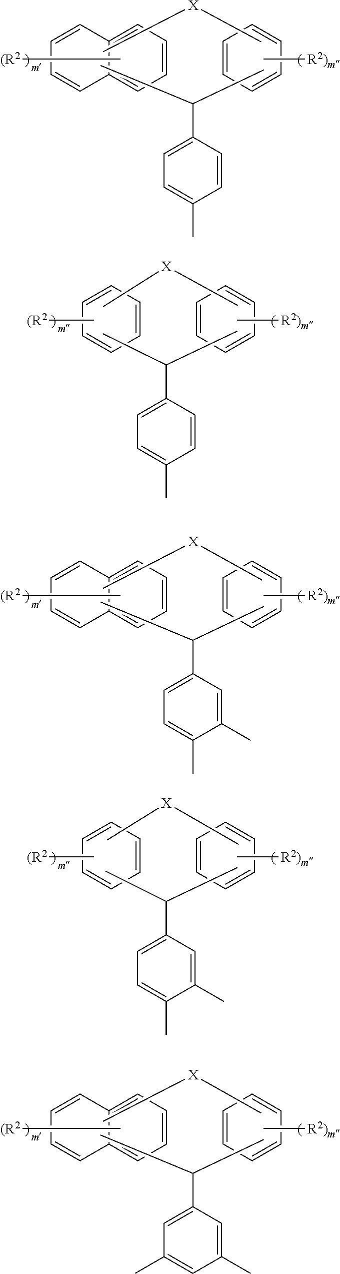

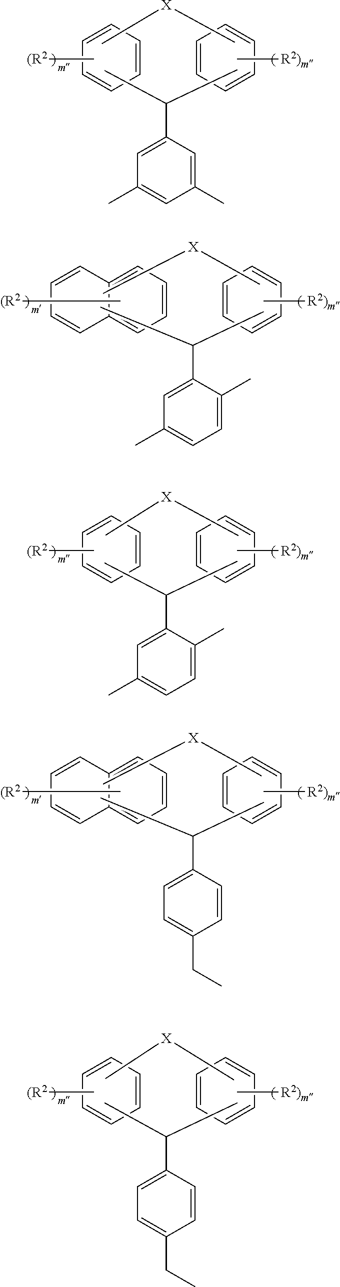

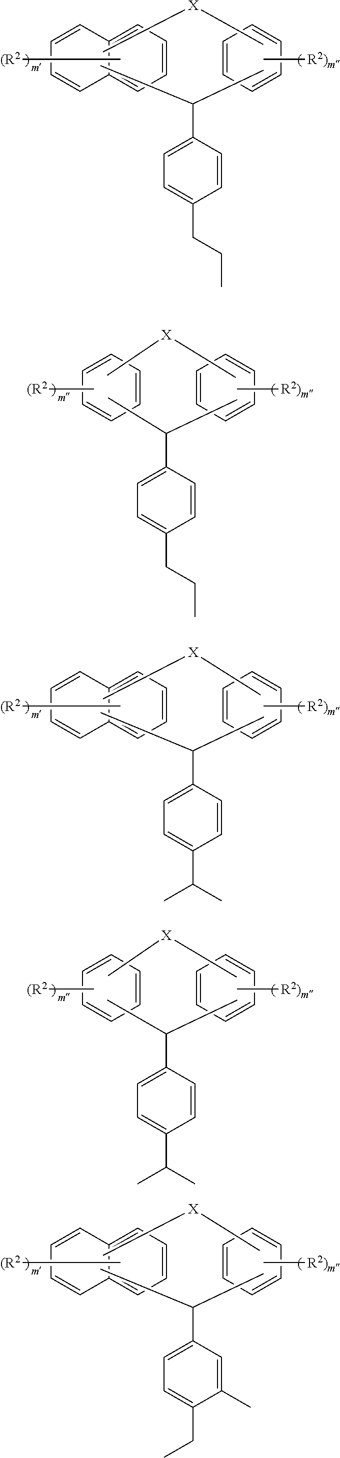

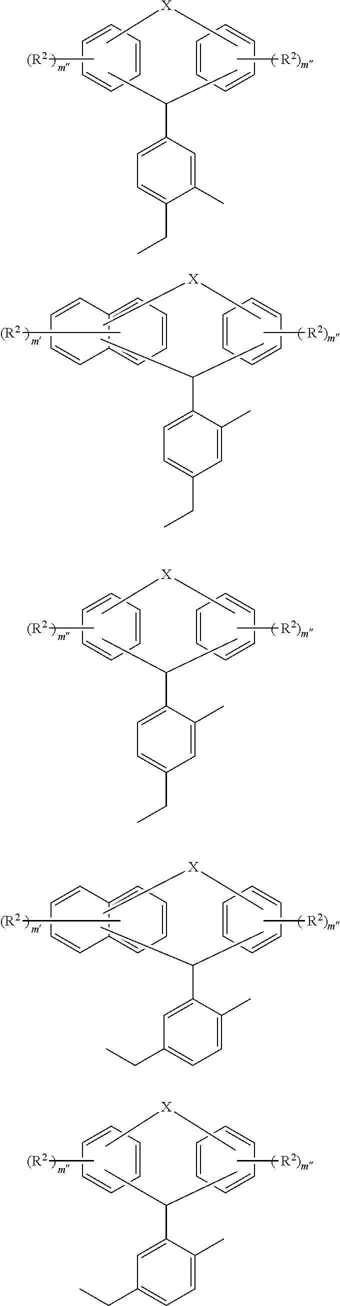

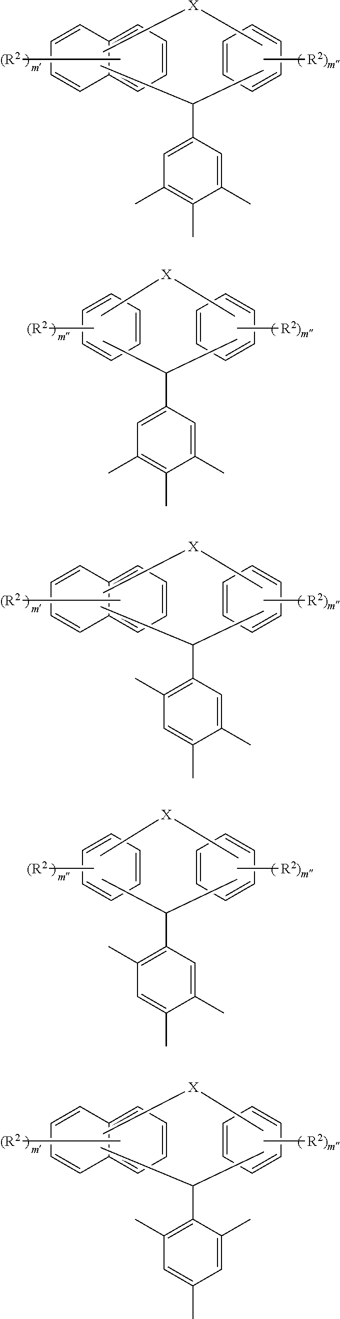

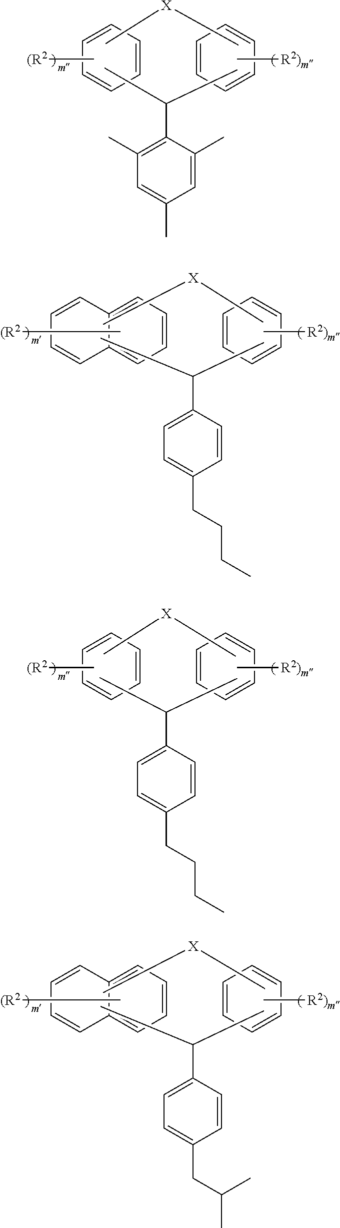

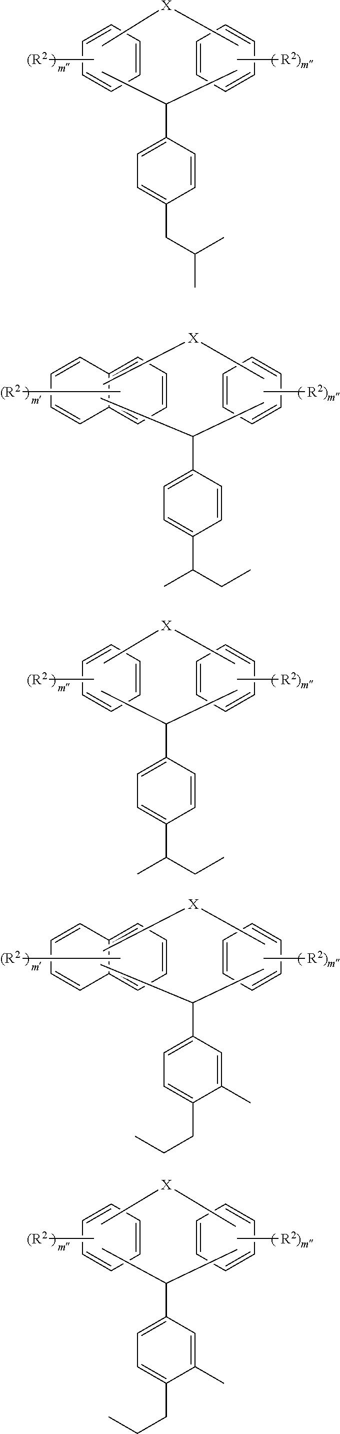

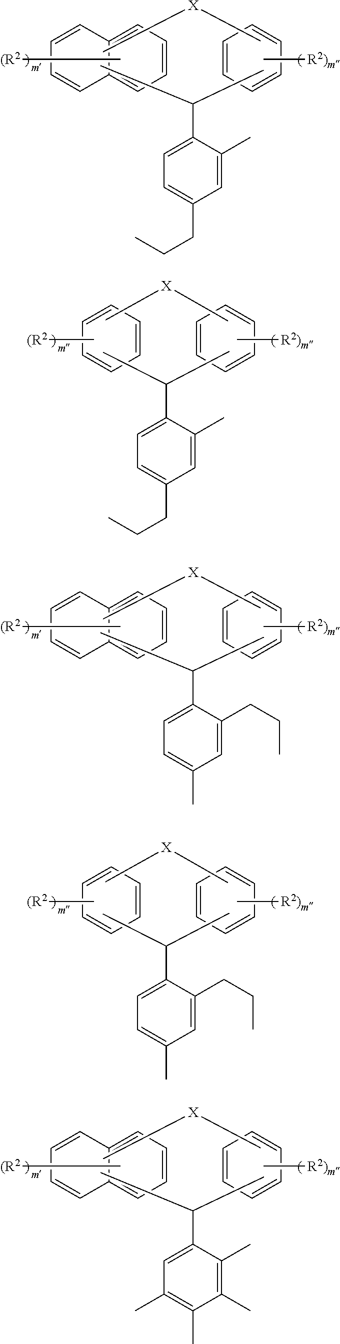

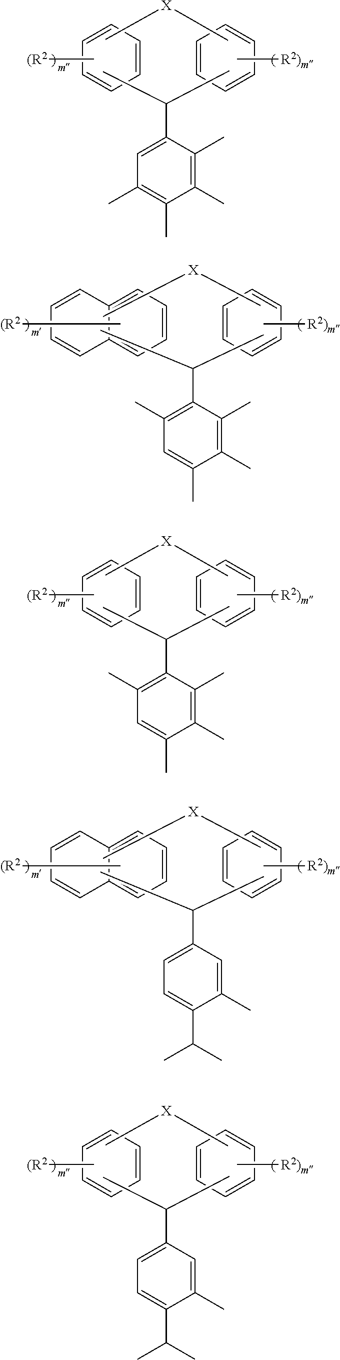

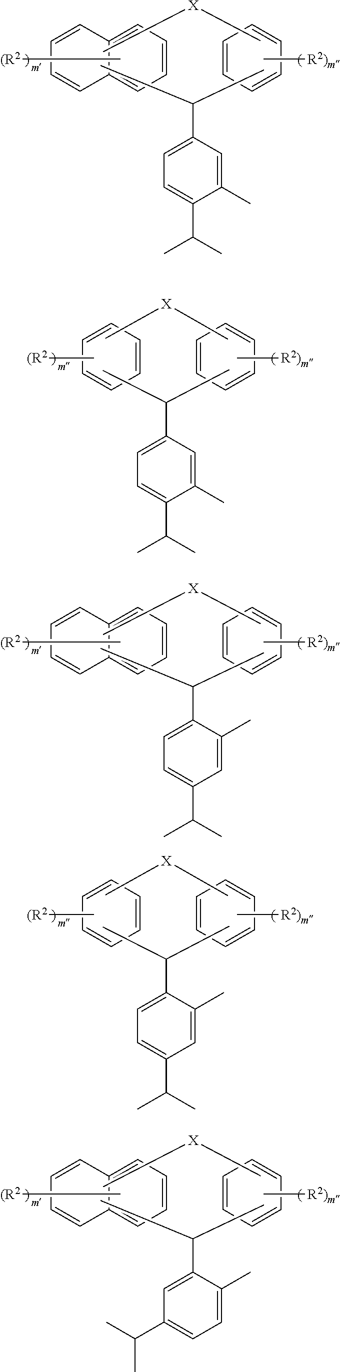

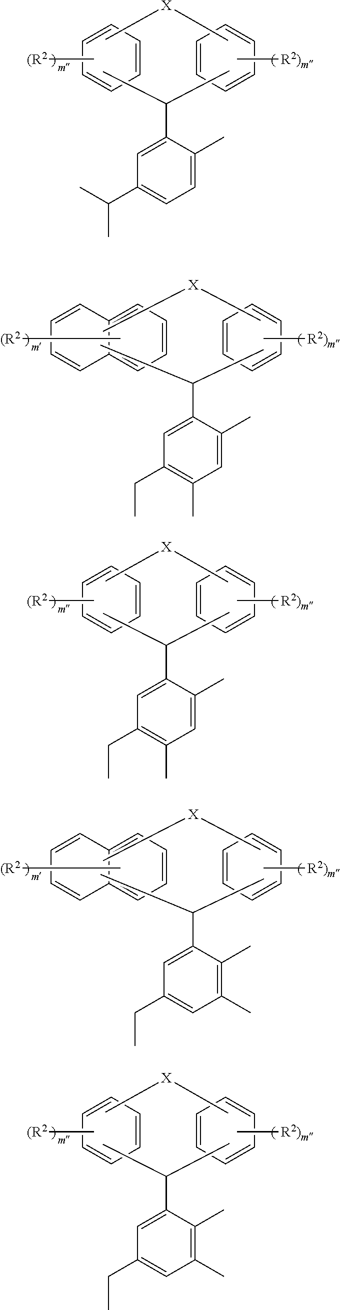

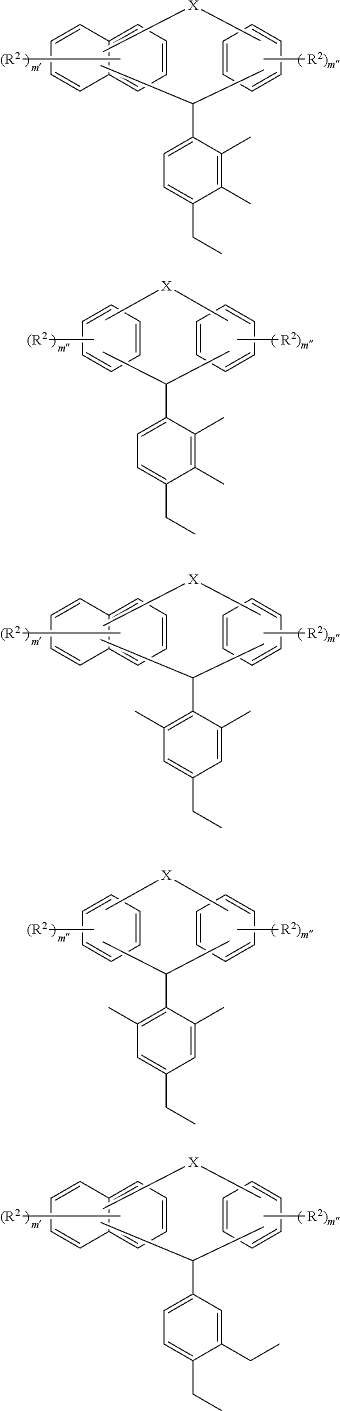

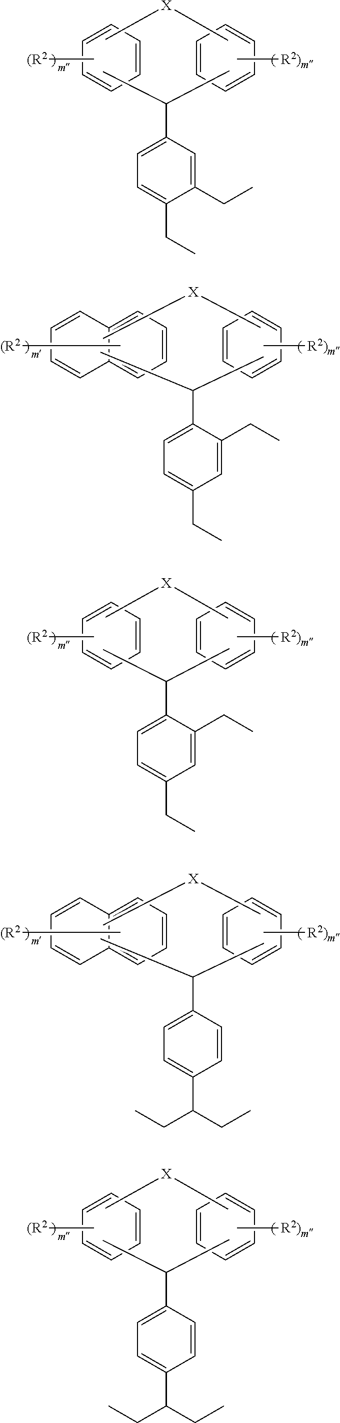

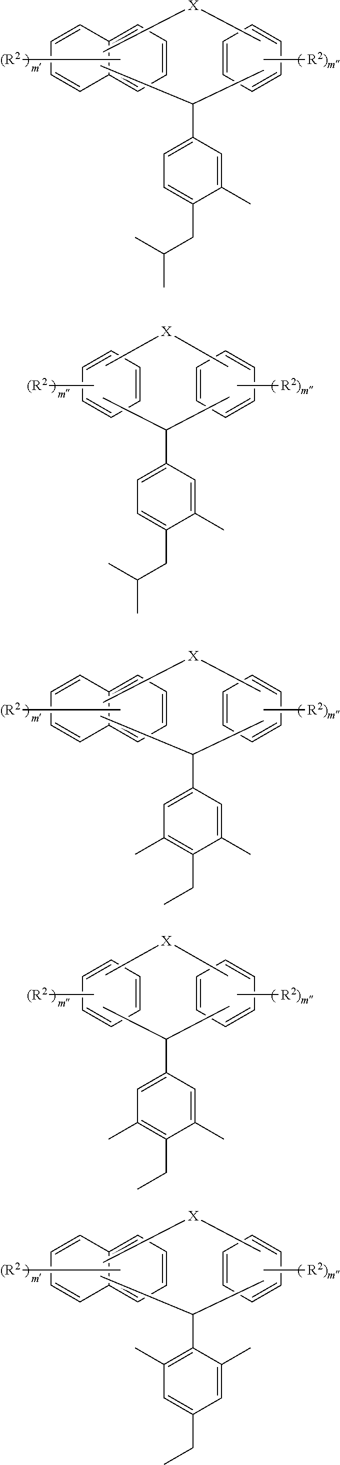

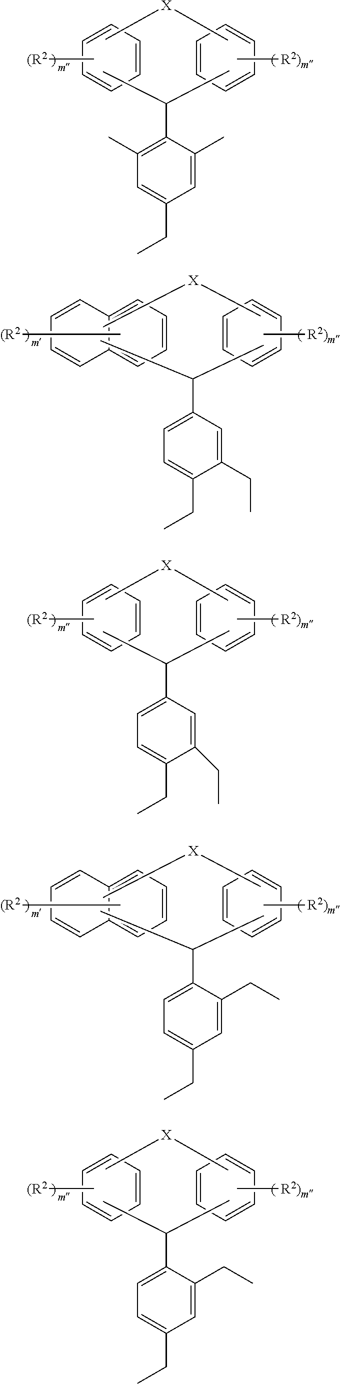

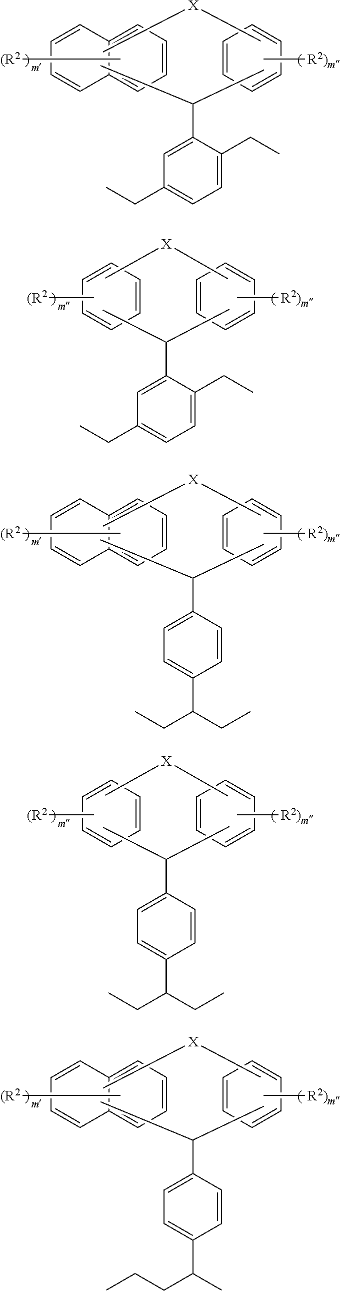

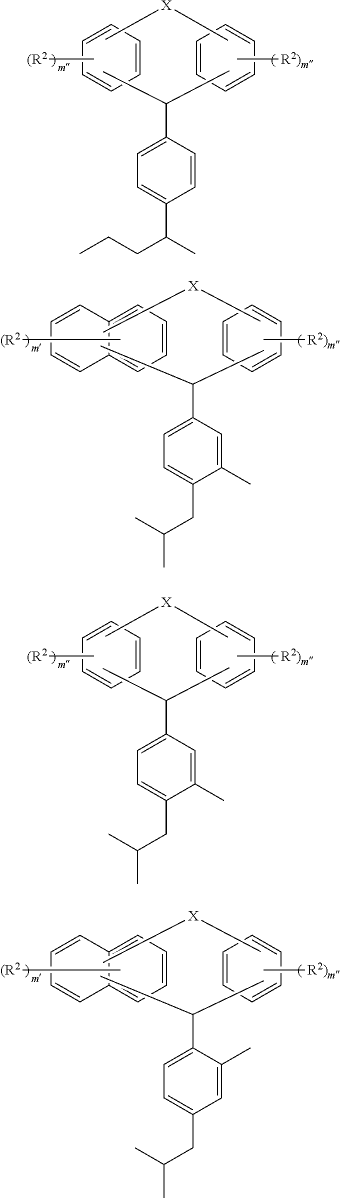

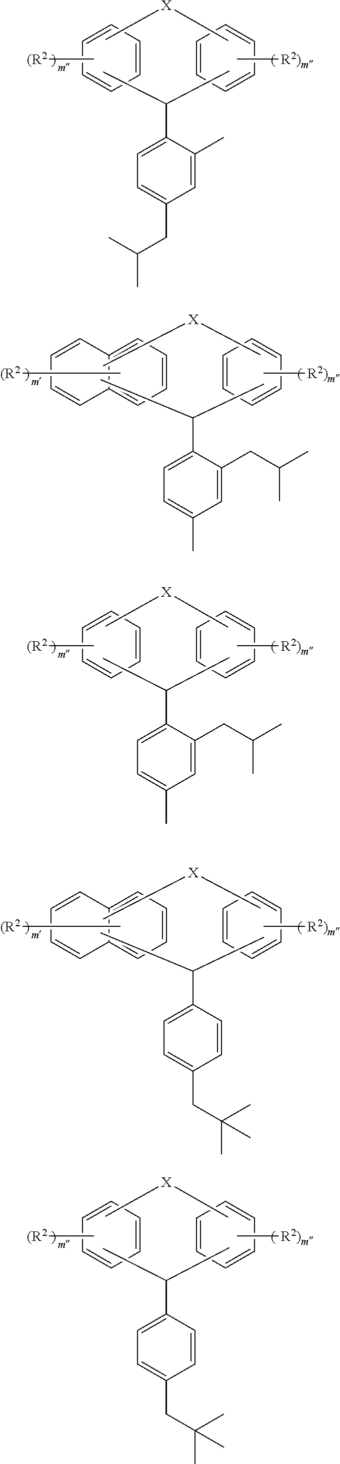

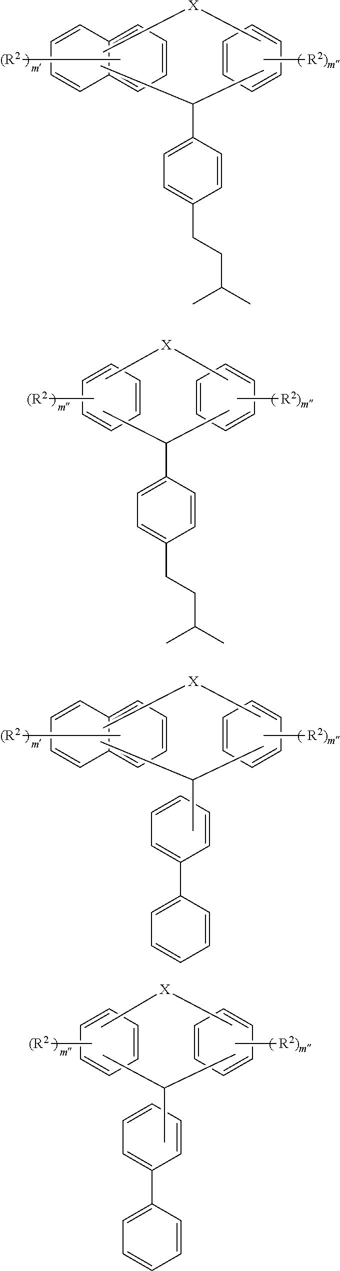

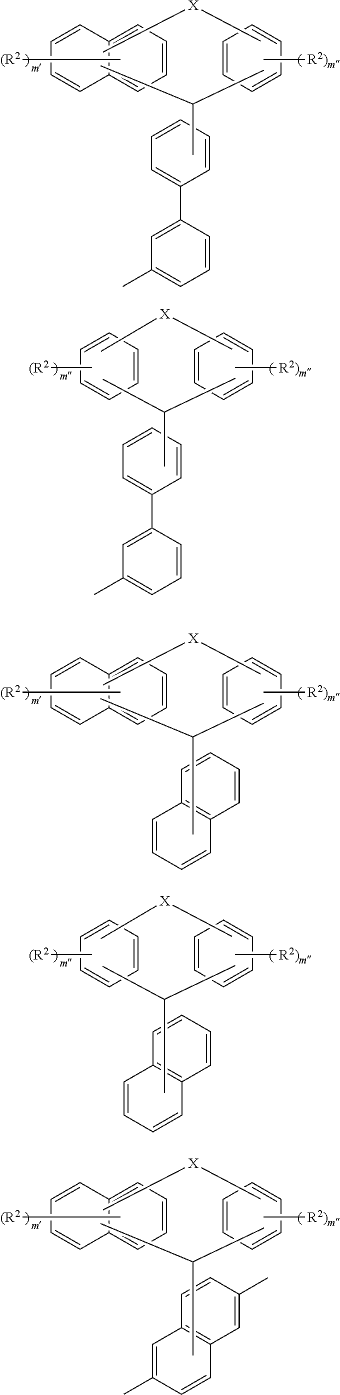

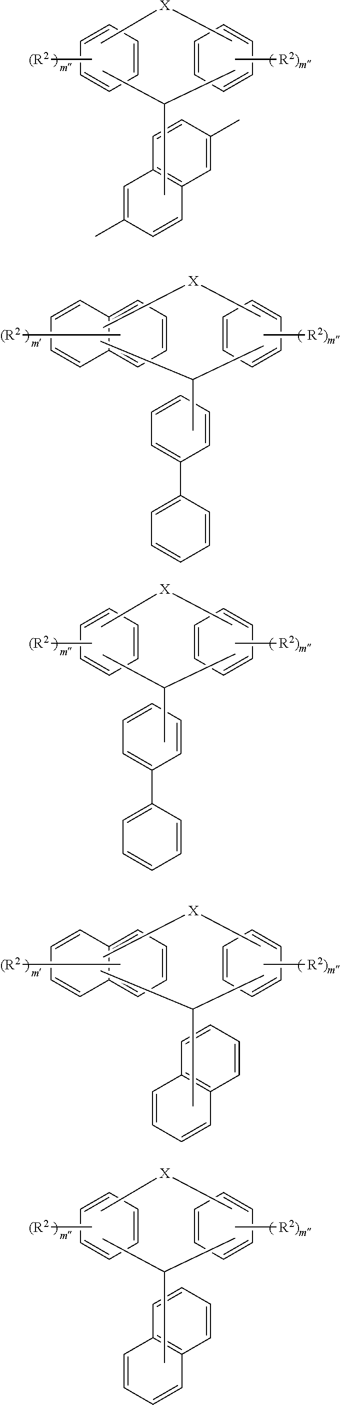

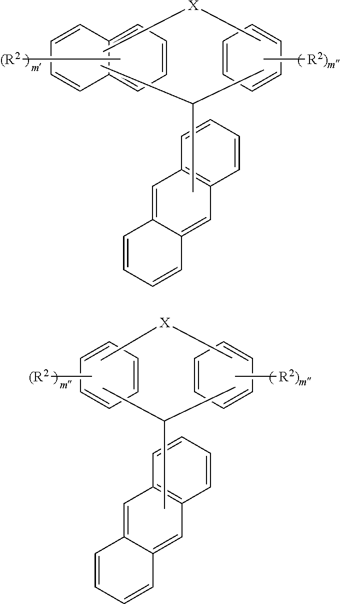

In the formulas, R² and X are as defined in the formula (1).

m′ is an integer of 1 to 7, and m″ is an integer of 1 to 5. Herein, at least one R² is a hydroxy group.

Specific examples of the aromatic hydroxy compound according to the present embodiment will be further listed below, but are not limited thereto.

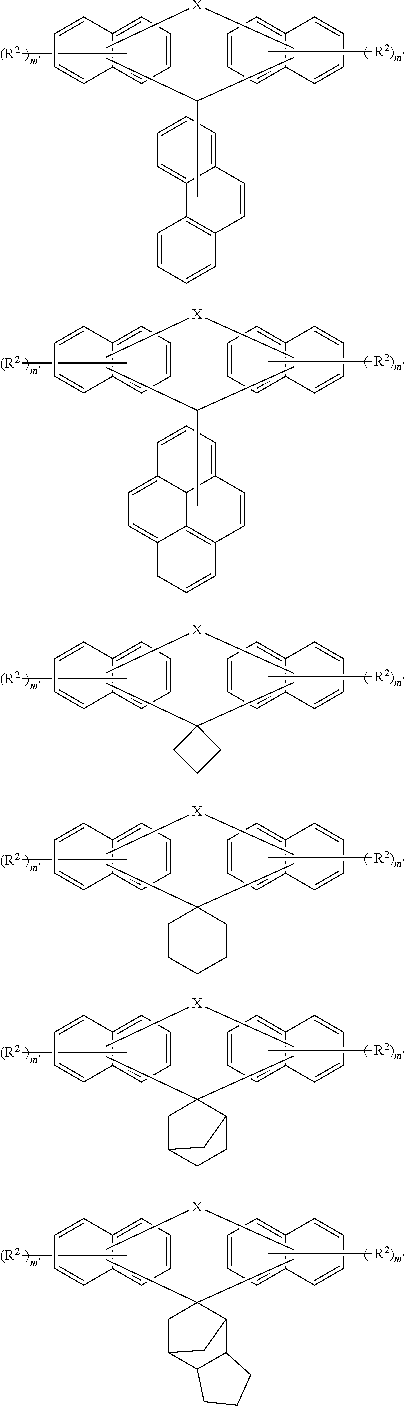

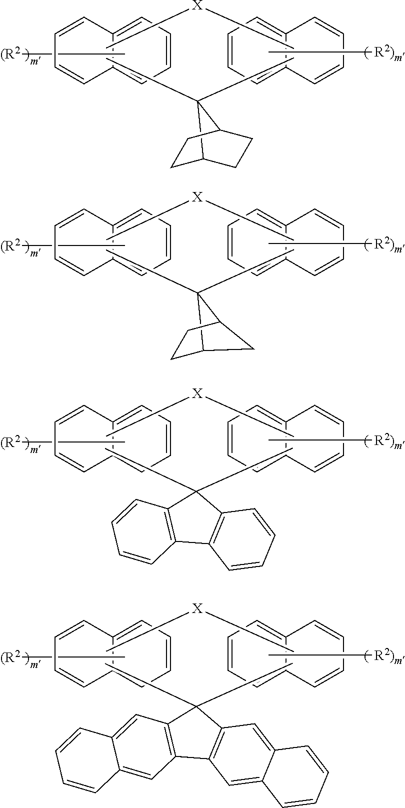

In the formula, R², X, and m′ are as defined in the above. Herein, at least one R² is a hydroxy group.

Specific examples of the aromatic hydroxy compound according to the present embodiment will be further listed below, but are not limited thereto.

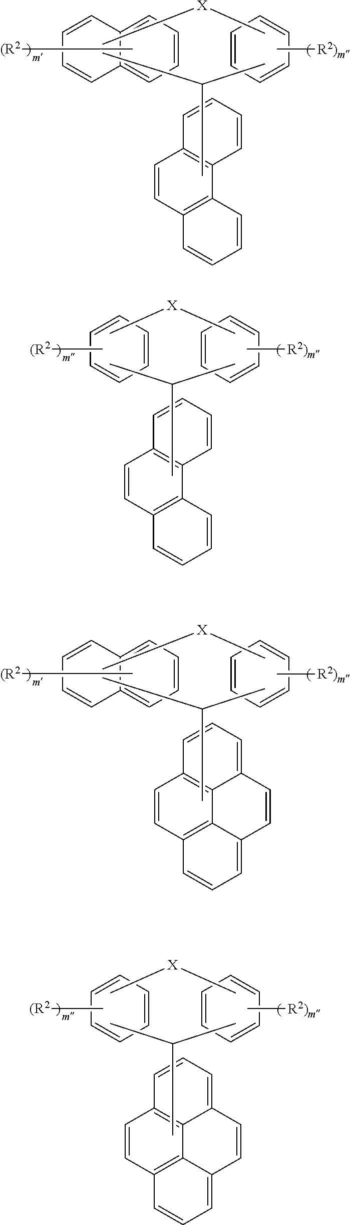

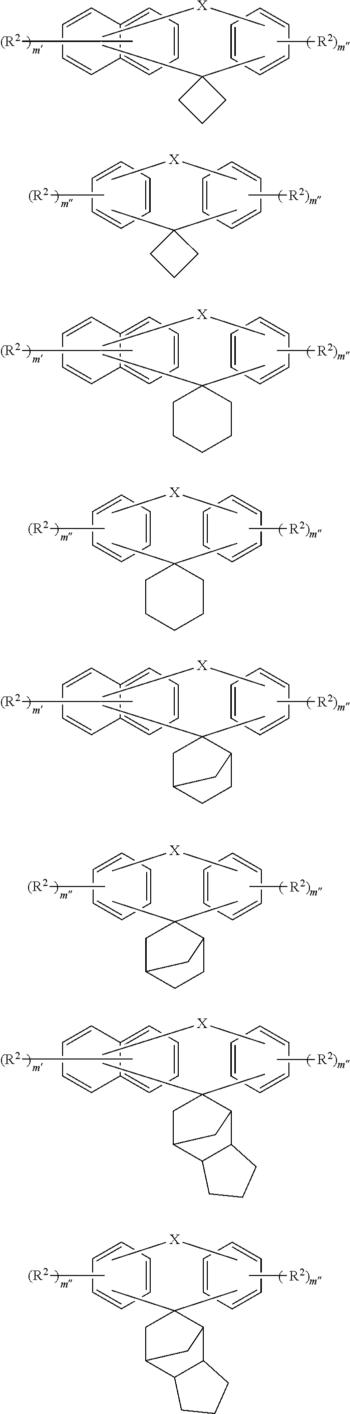

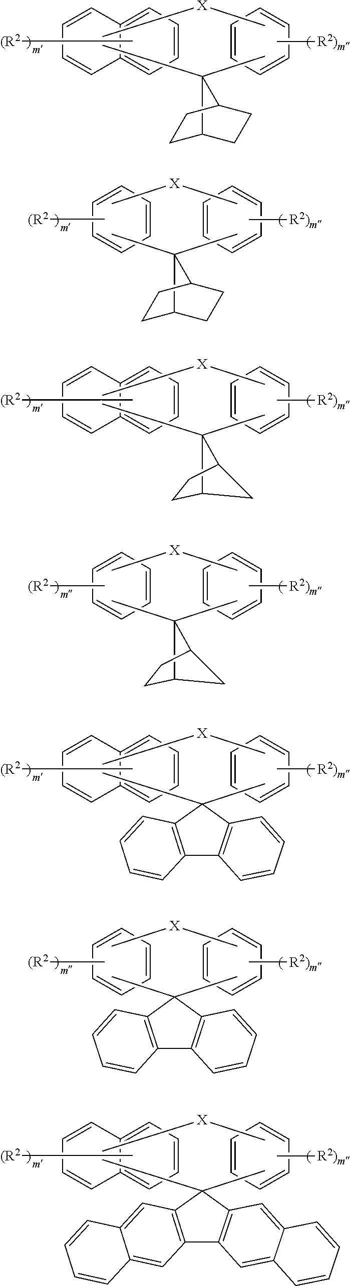

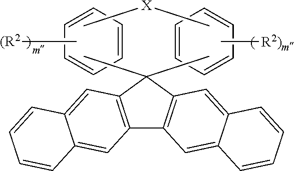

In the formulas, R² and X are as defined in the formula (1). m′ is an integer of 1 to 7. m″ is an integer of 1 to 5. Herein, at least one R² is a hydroxy group.

Specific examples of the aromatic hydroxy compound according to the present embodiment will be further listed below, but are not limited thereto.

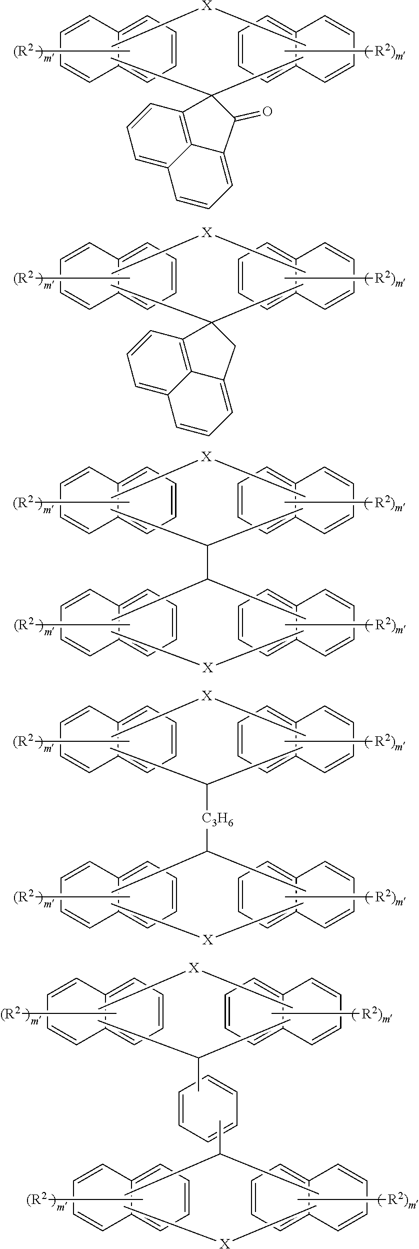

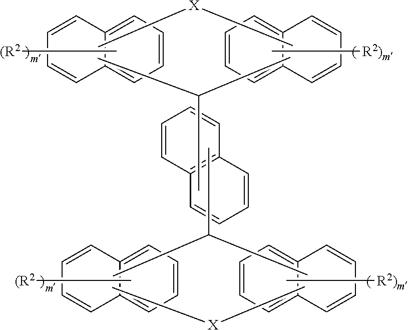

In the formula, R² and X are as defined in the formula (1). m′ is an integer of 1 to 7. Herein, at least one R² is a hydroxy group.

Specific examples of the aromatic hydroxy compound according to the present embodiment will be further listed below, but are not limited thereto.

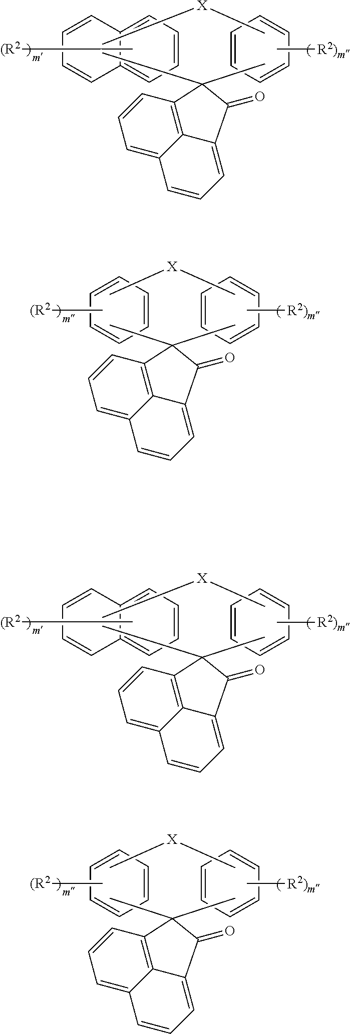

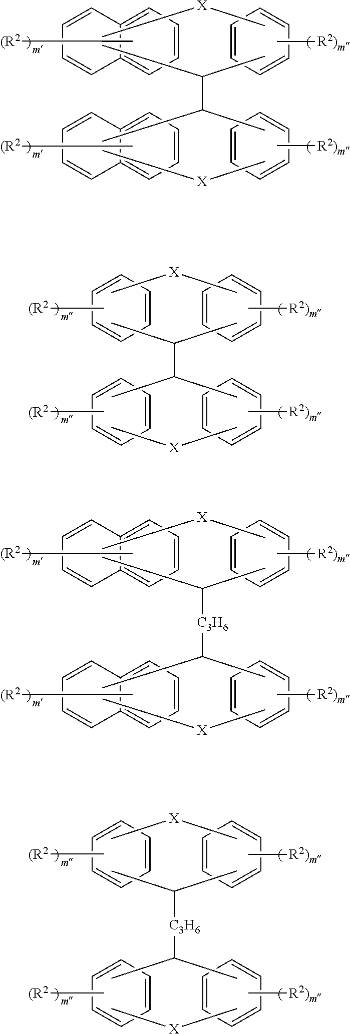

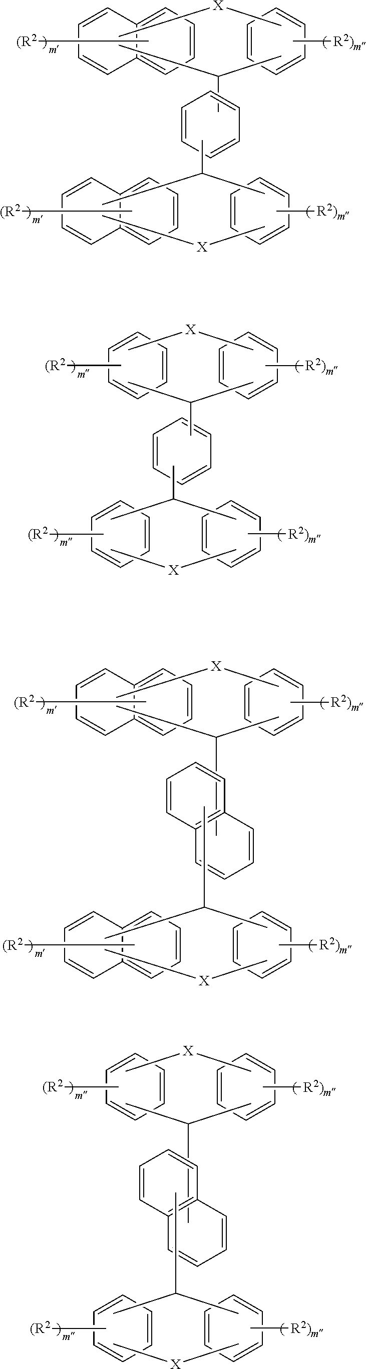

In the formulas, R² and X are as defined in the formula (1). m′ is an integer of 1 to 7. m″ is an integer of 1 to 5. Herein, at least one R² is a hydroxy group.

Specific examples of the aromatic hydroxy compound according to the present embodiment will be further listed below, but are not limited thereto.

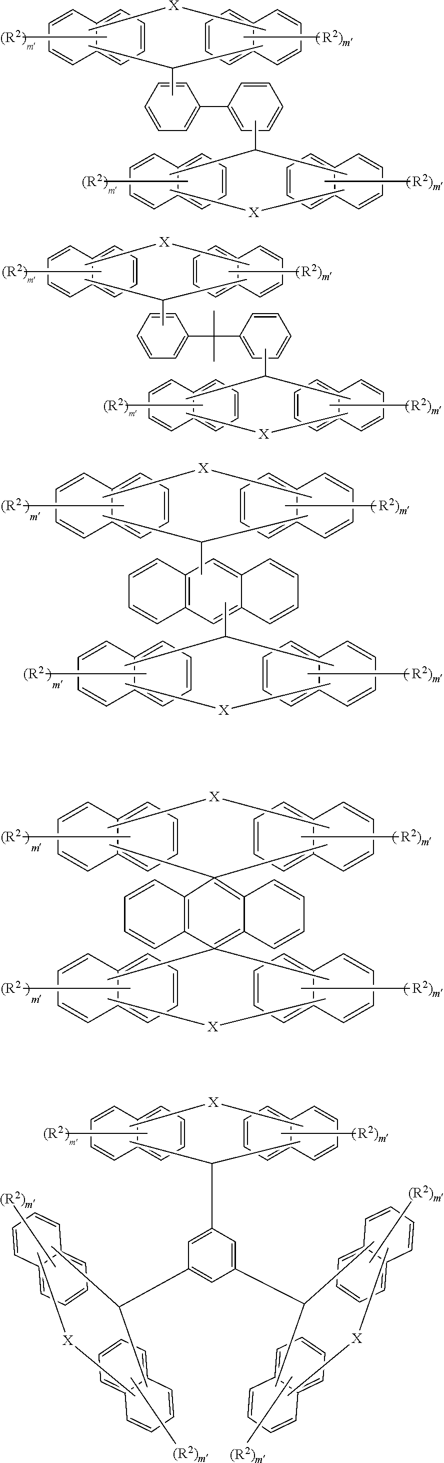

In the formula, R² and X are as defined in the formula (1). m′ is an integer of 1 to 7. Herein, at least one R² is a hydroxy group.

Specific examples of the aromatic hydroxy compound according to the present embodiment will be further listed below, but are not limited thereto.

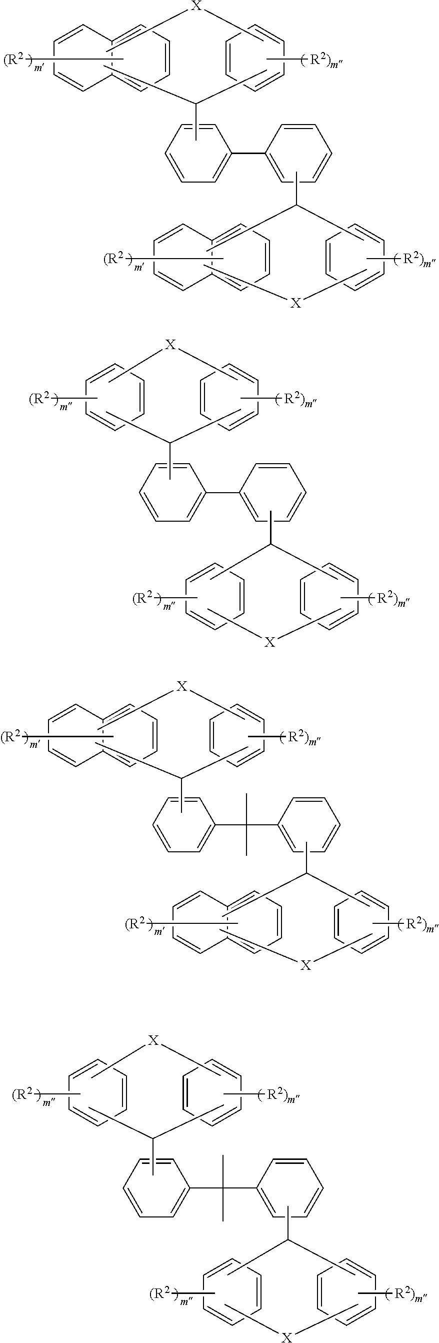

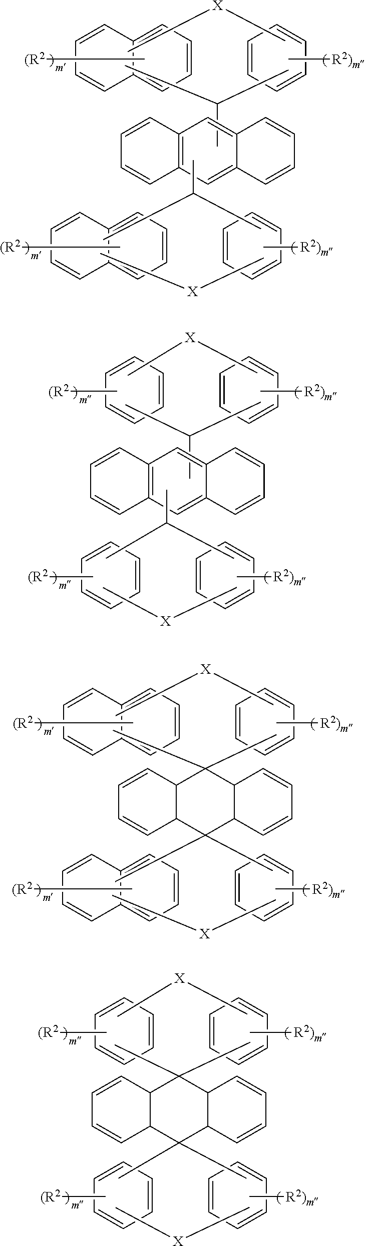

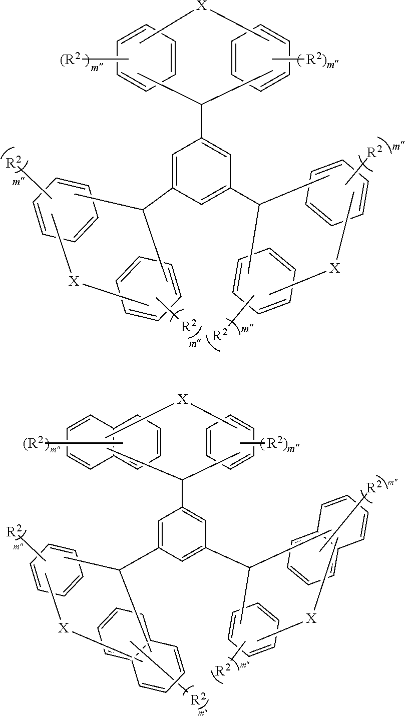

In the formulas, R² and X are as defined in the formula (1). m′ is an integer of 1 to 7. m″ is an integer of 1 to 5. Herein, at least one R² is a hydroxy group.

Specific examples of the compound represented by the formula (2) will be listed below, but are not limited thereto.

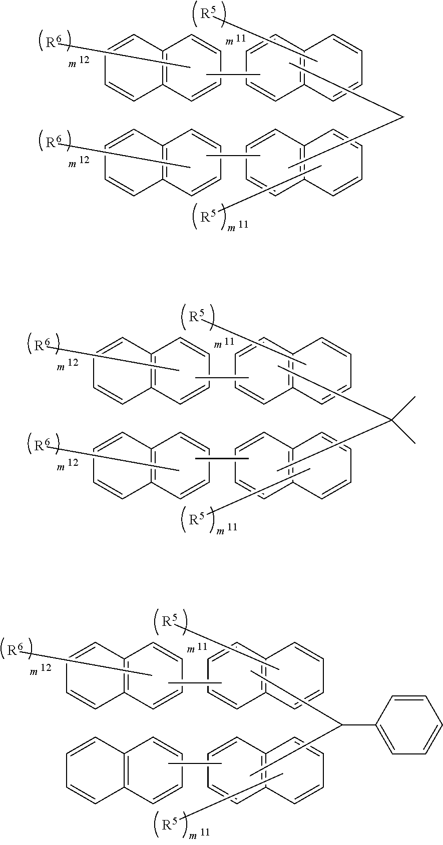

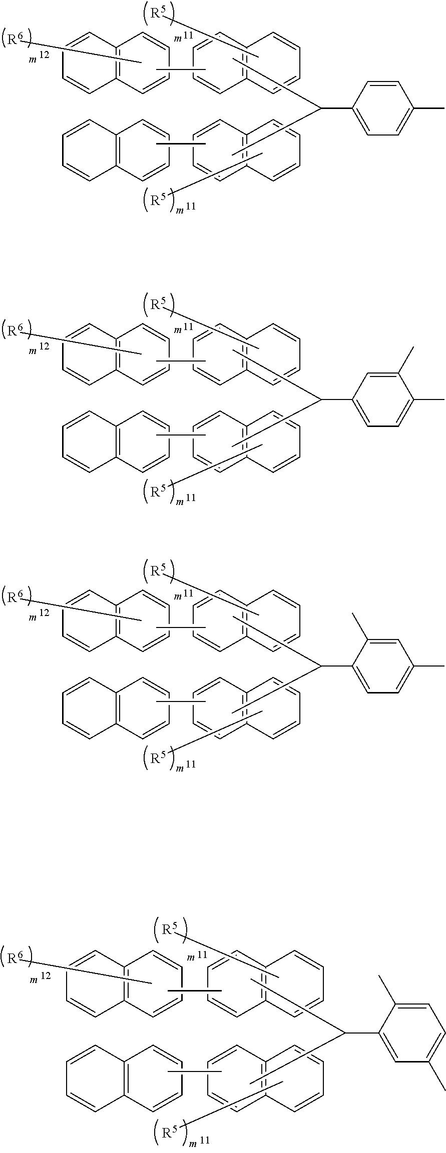

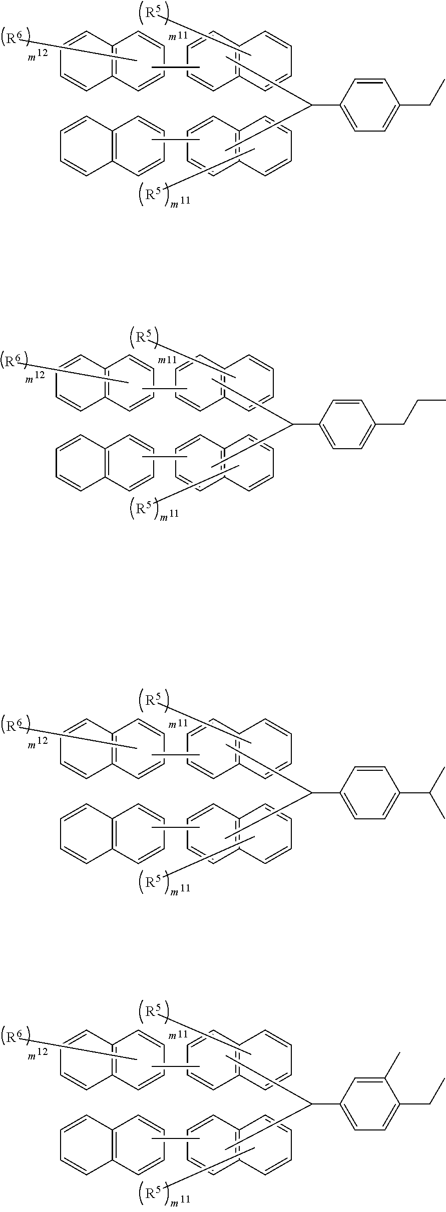

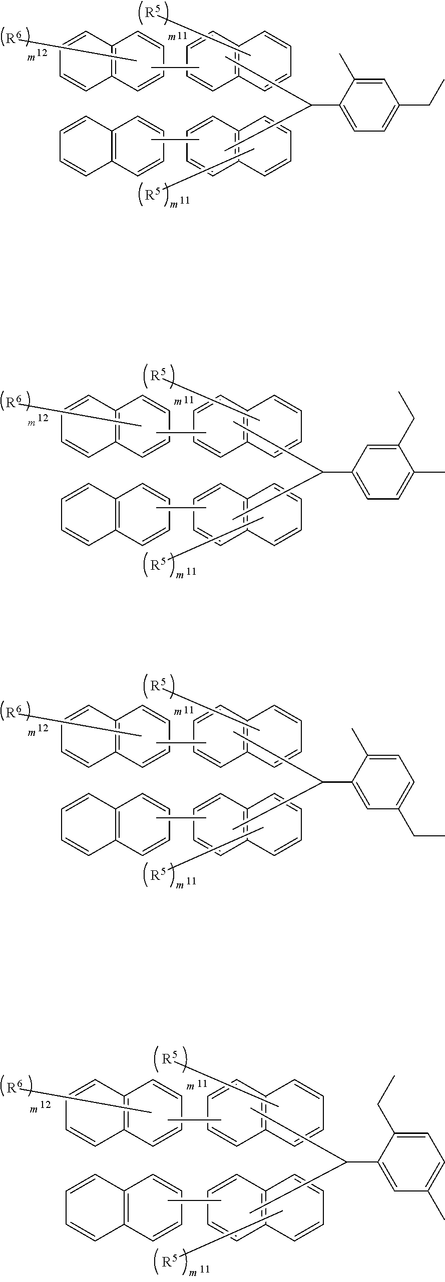

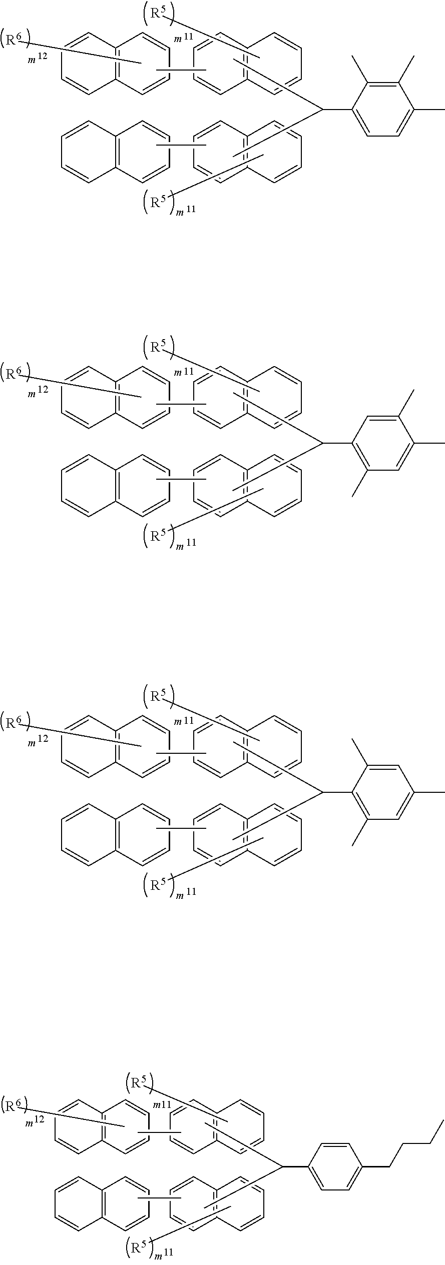

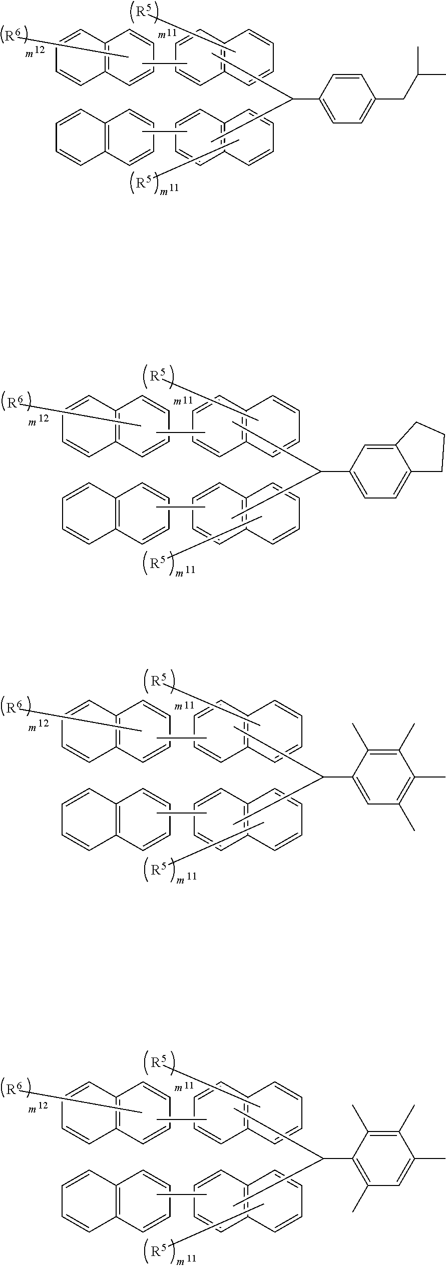

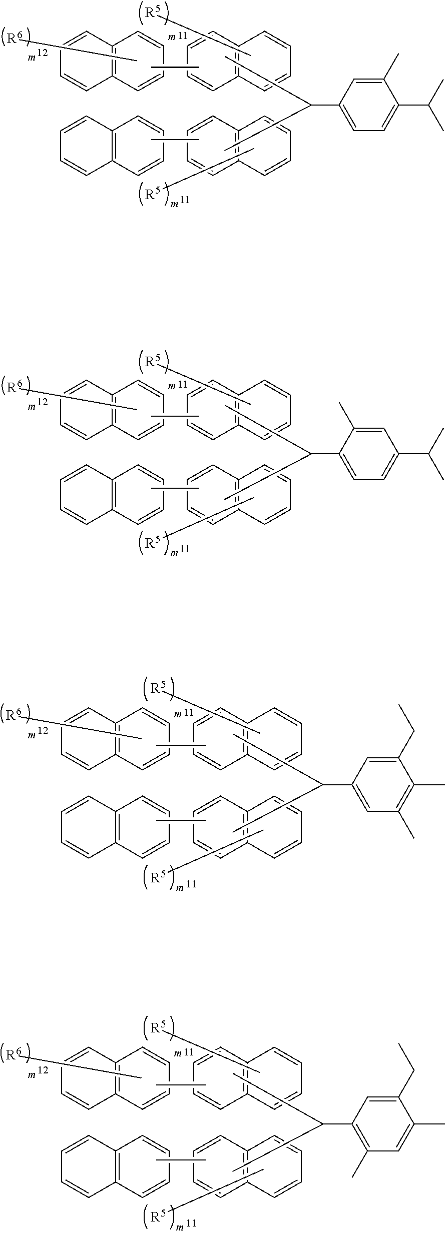

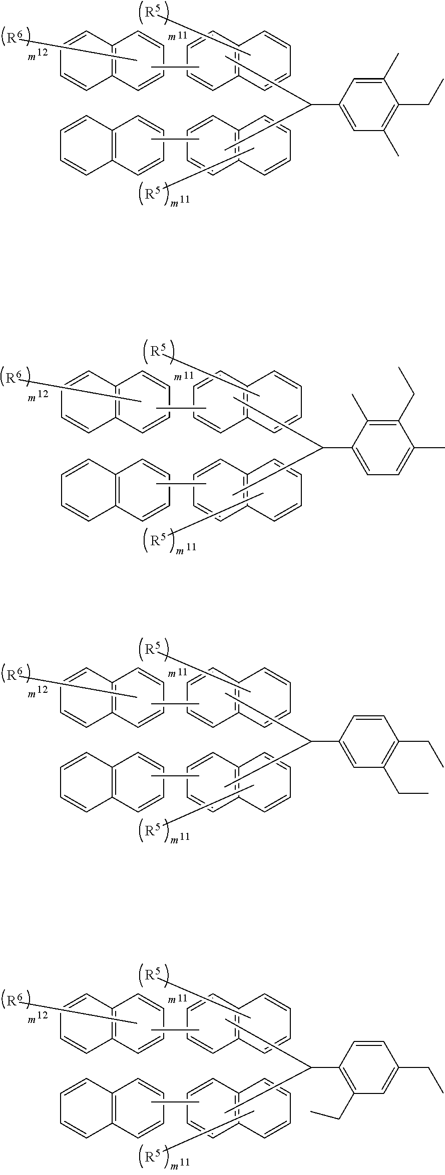

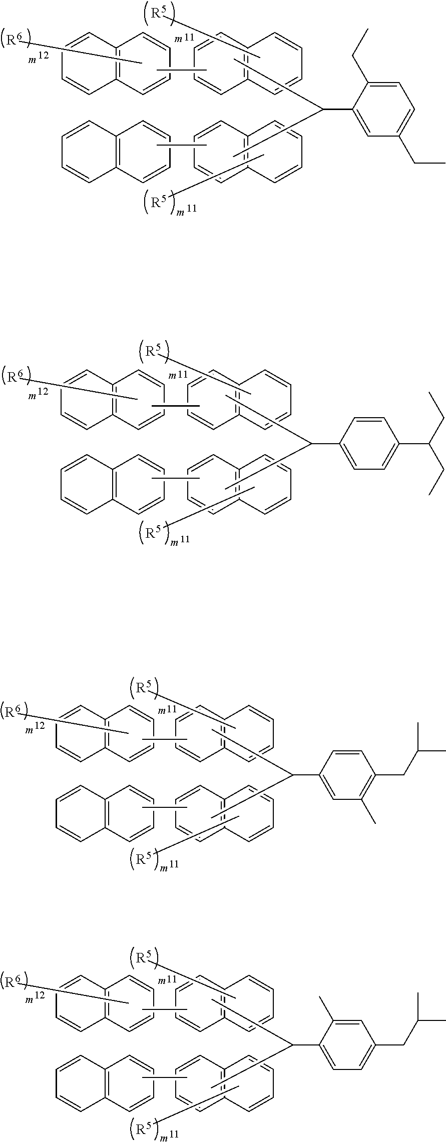

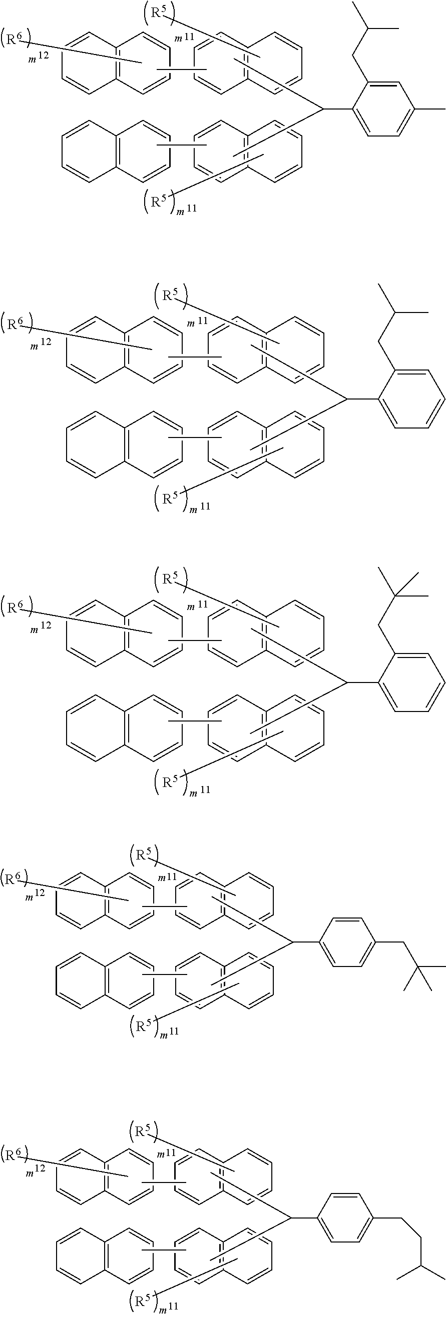

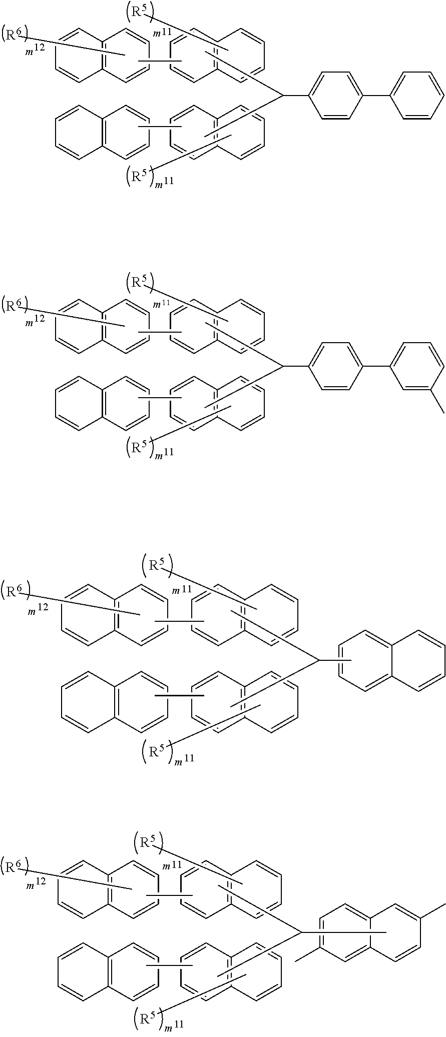

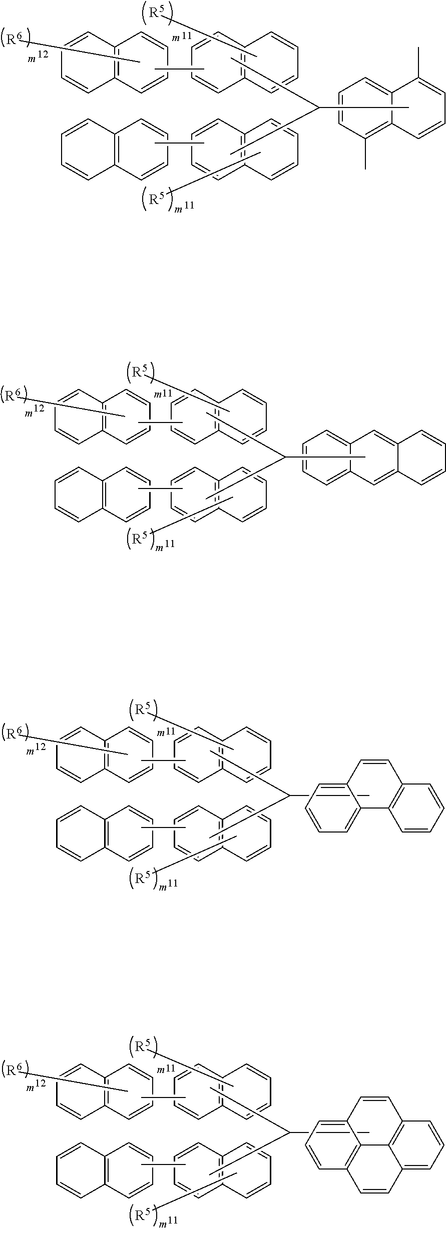

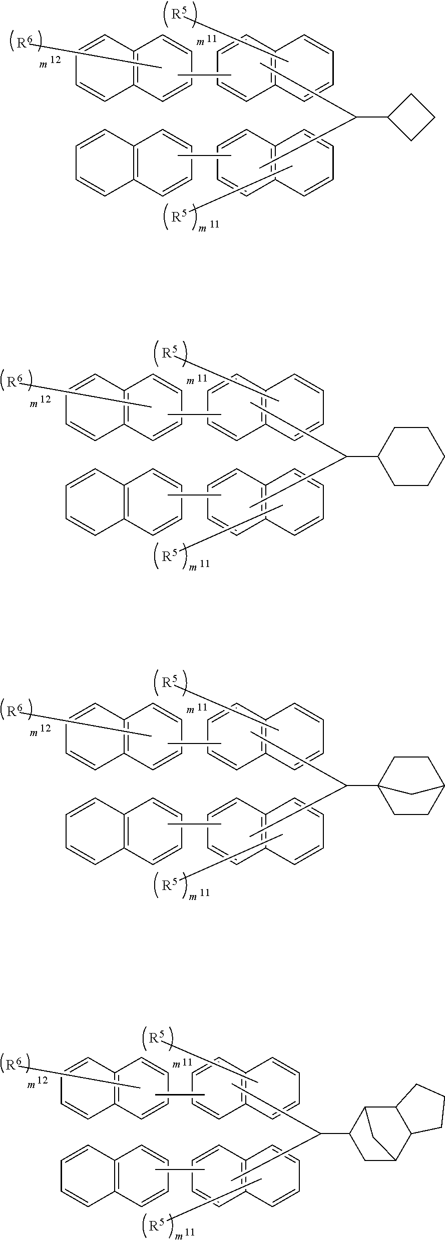

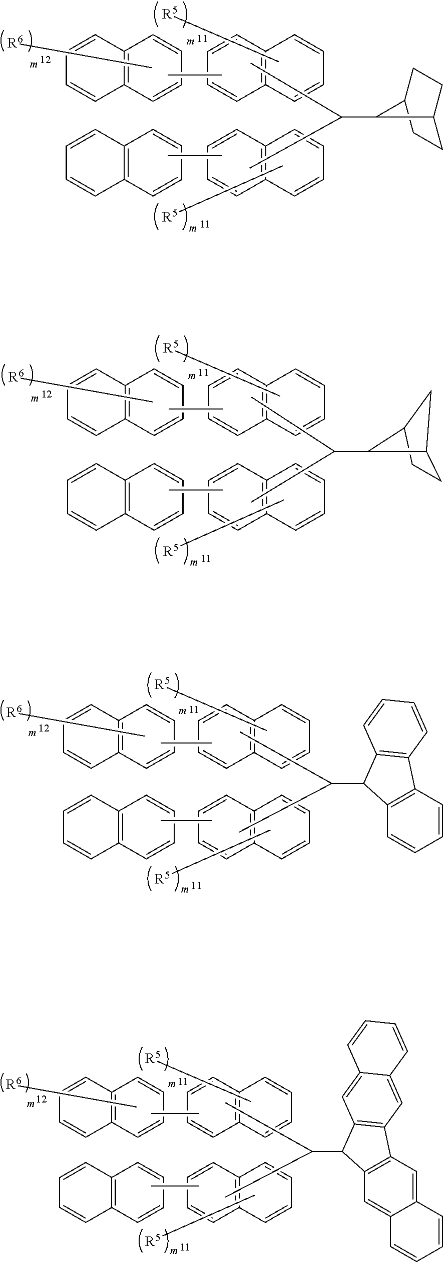

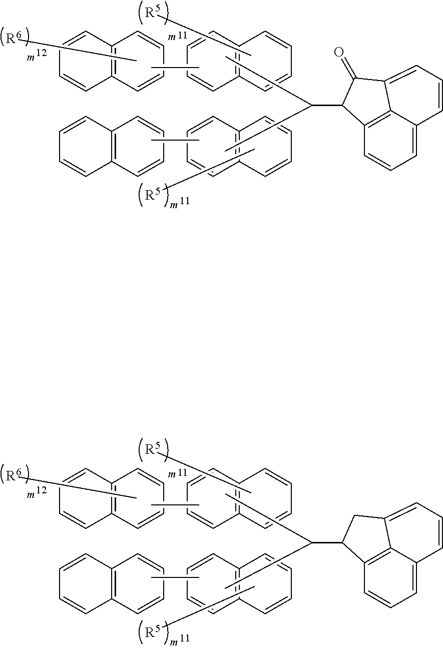

In the aromatic hydroxy compounds, R⁵ and R⁶ are as defined in the formula (3).

m¹¹ is an integer of 0 to 6, m¹² is an integer of 0 to 7, and not all m¹¹ and m¹² are 0 at the same time.

Herein, at least one R⁵ and R⁶ is a hydroxy group.

Specific examples of the aromatic hydroxy compound according to the present embodiment will be further listed below, but are not limited thereto.

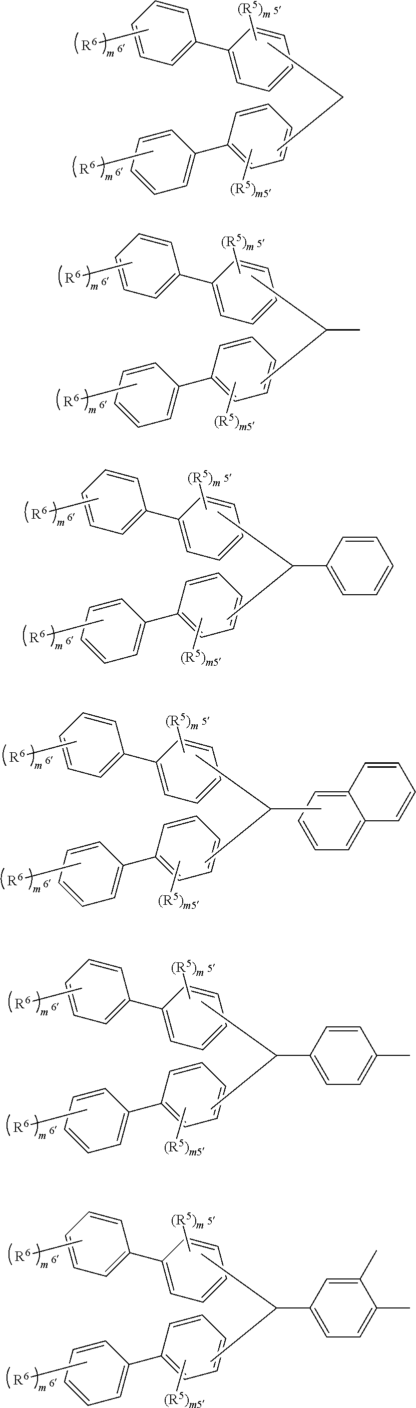

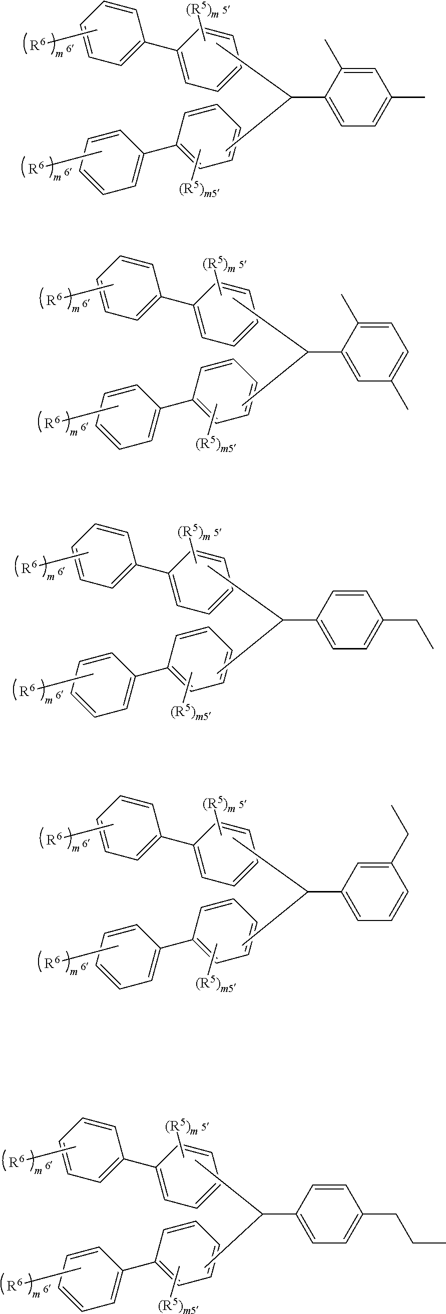

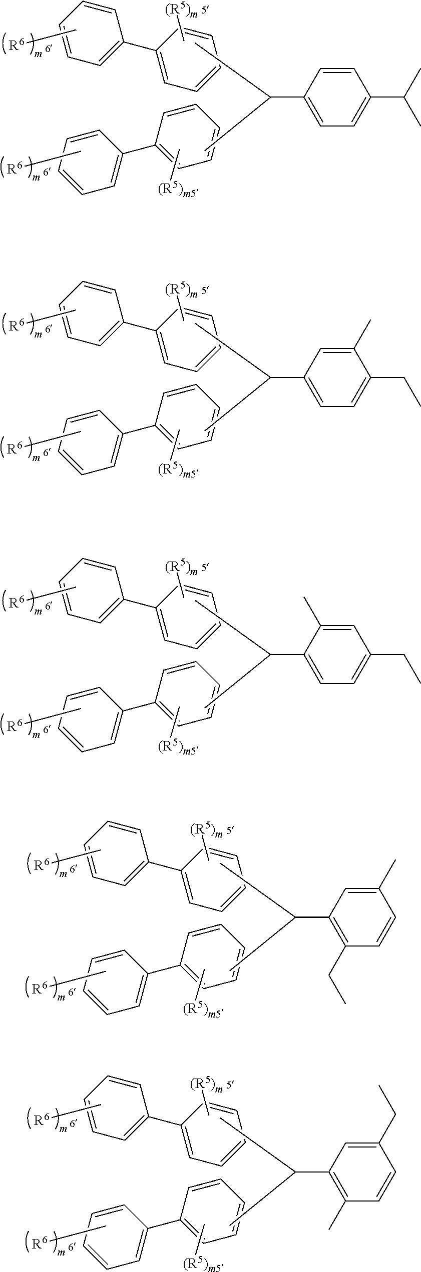

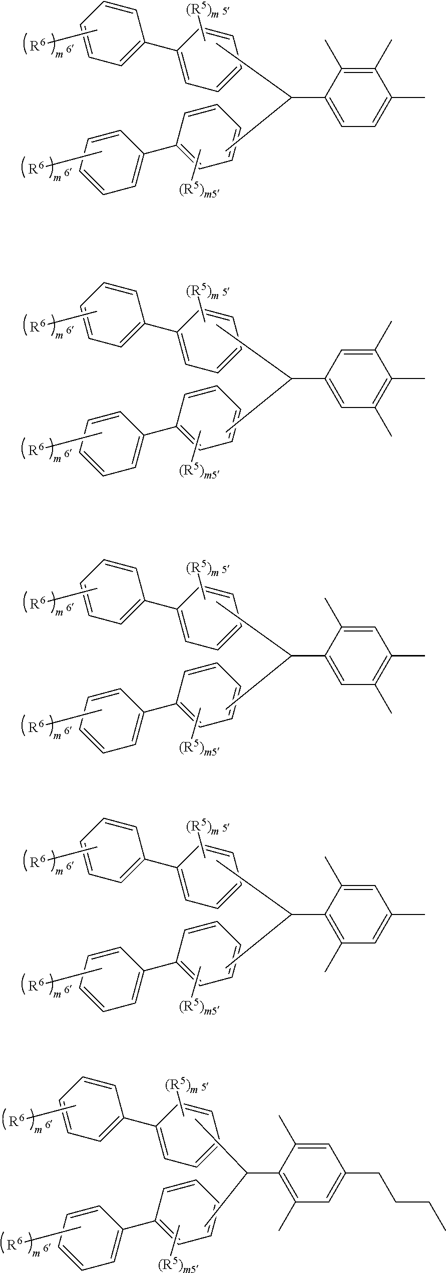

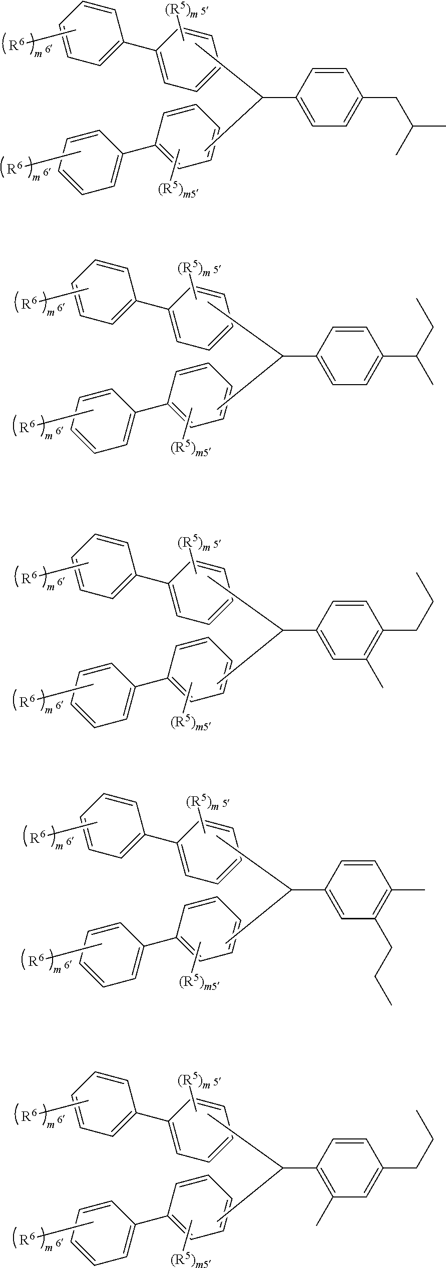

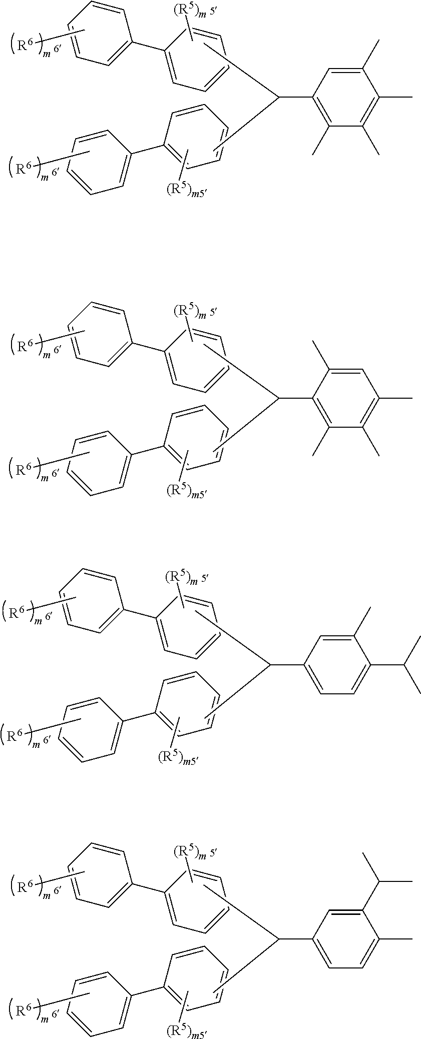

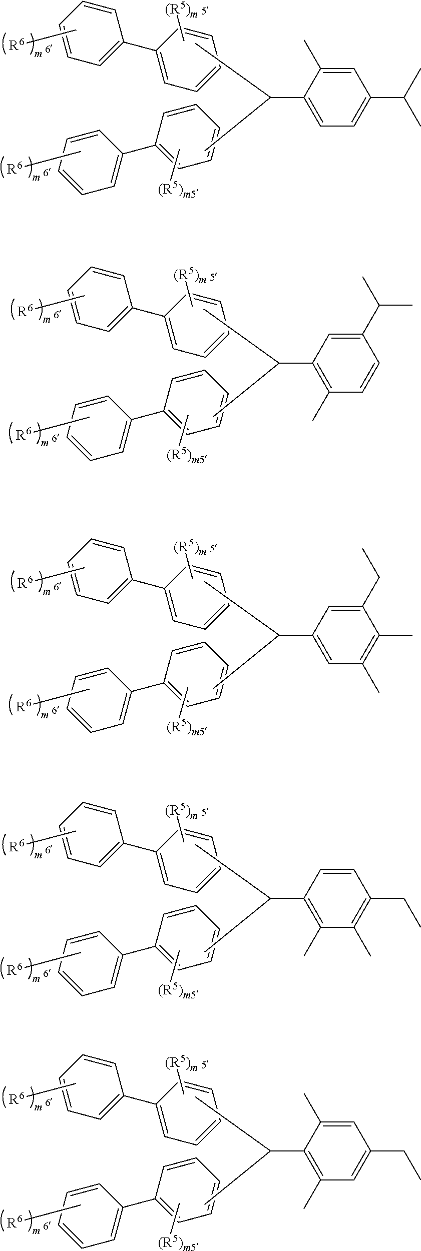

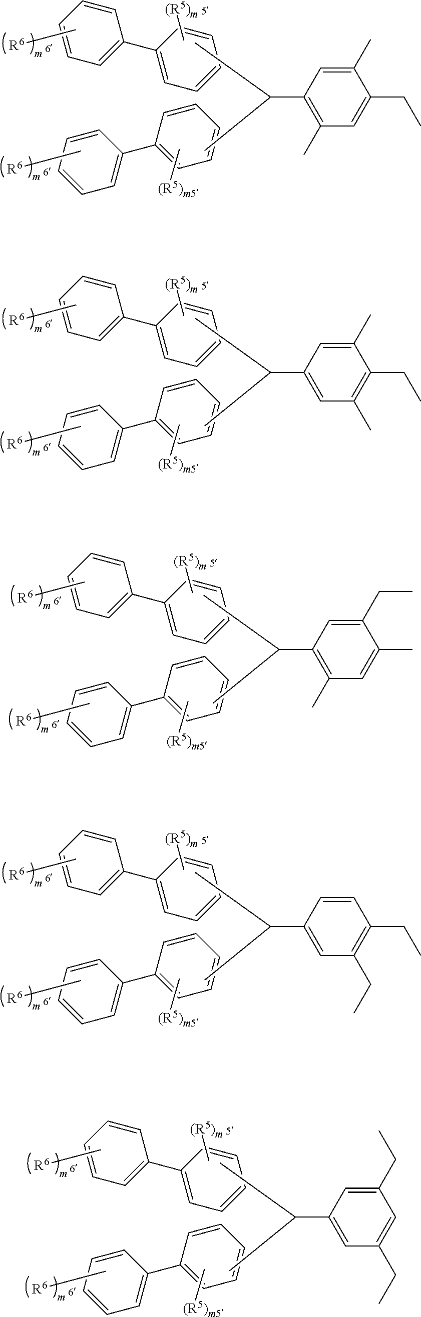

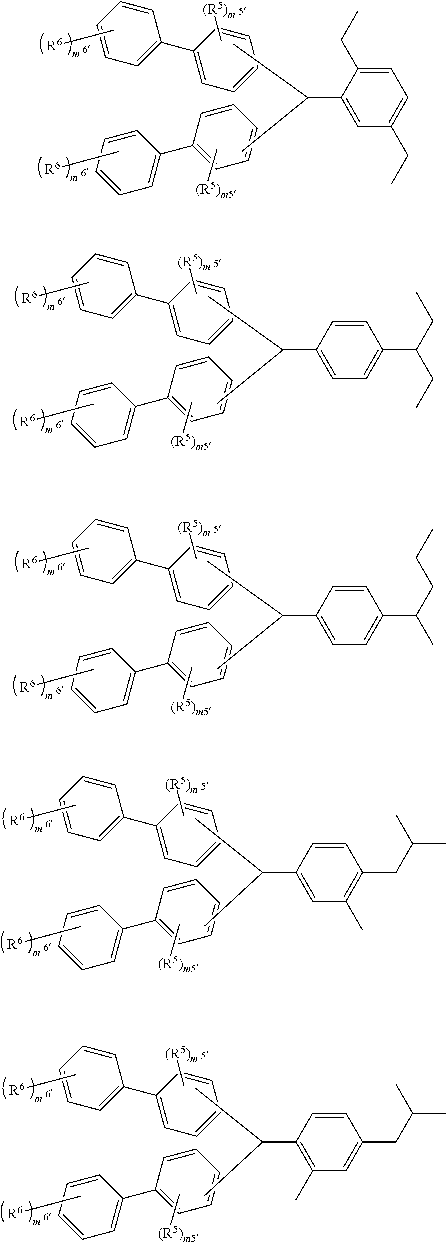

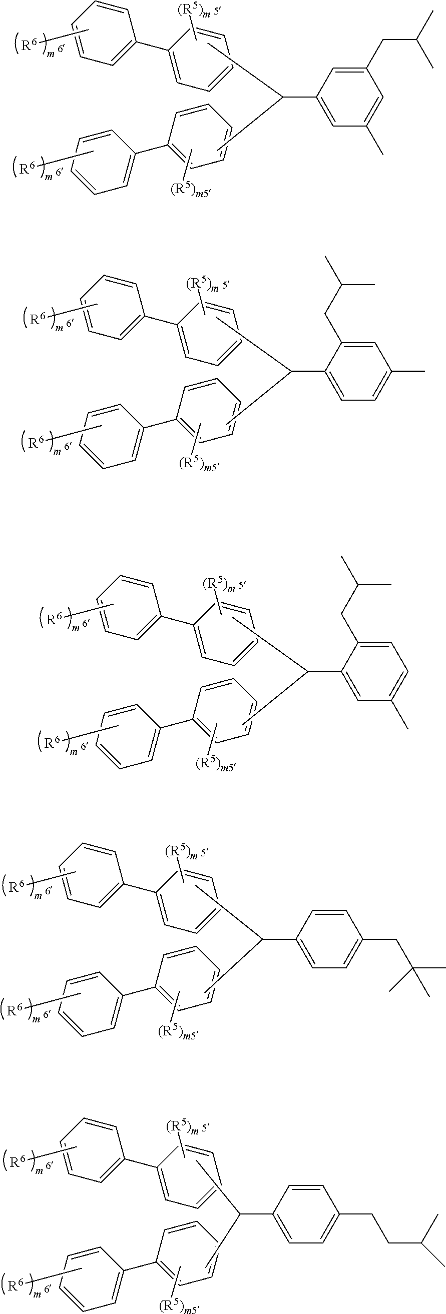

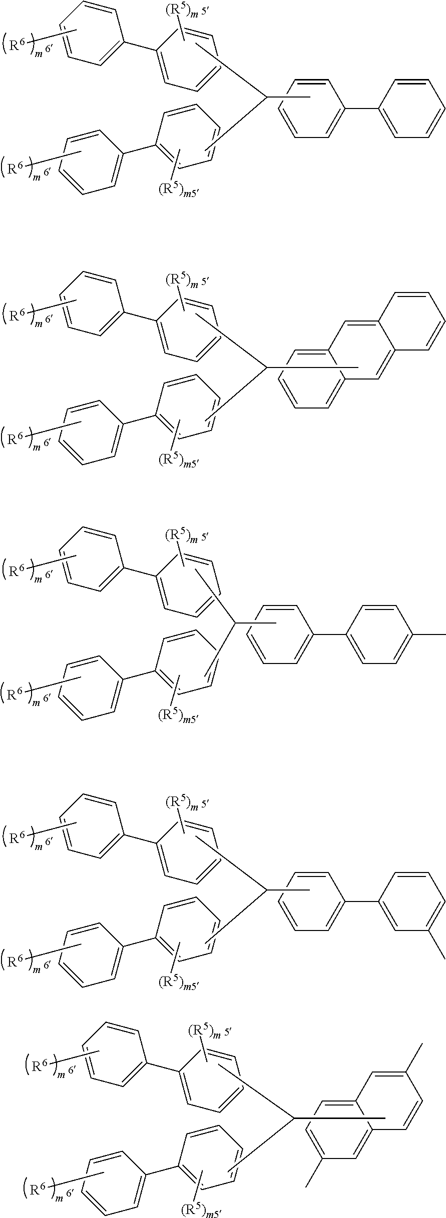

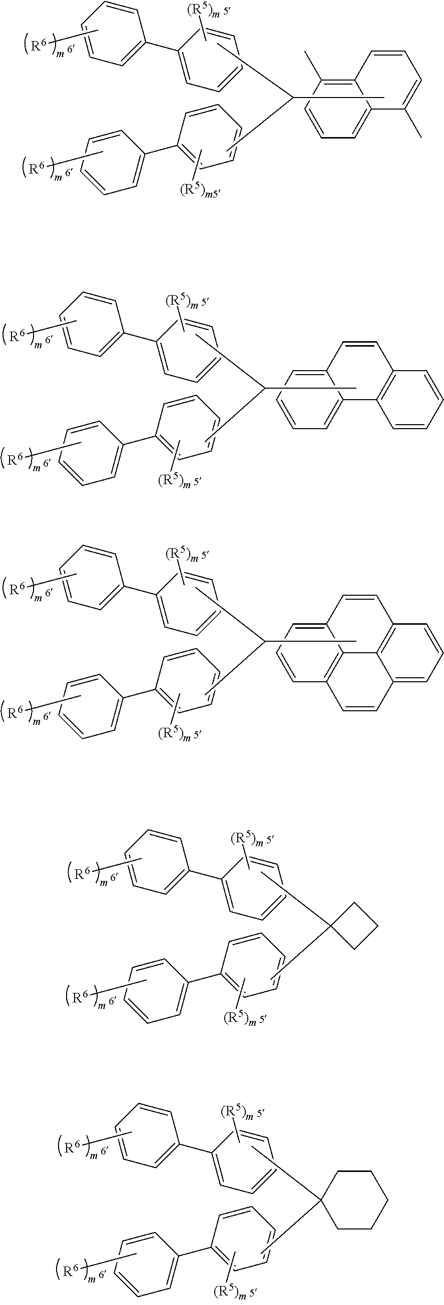

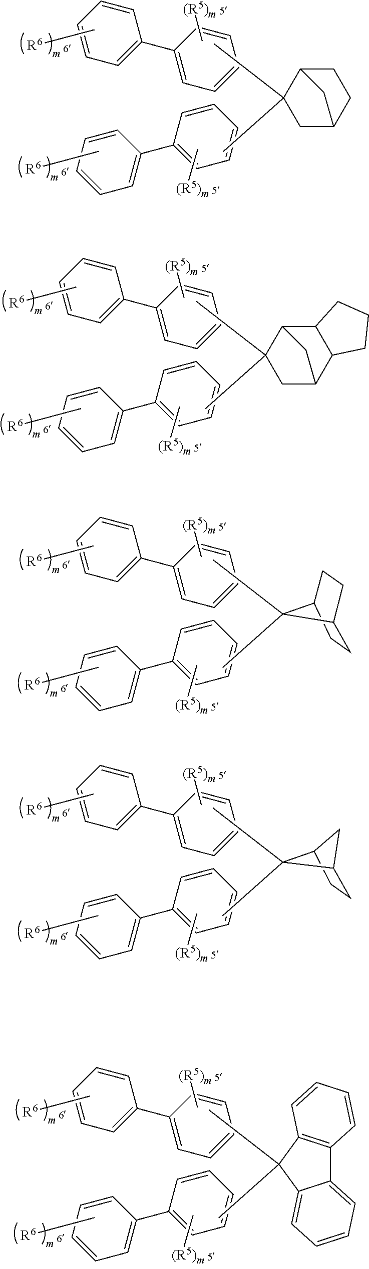

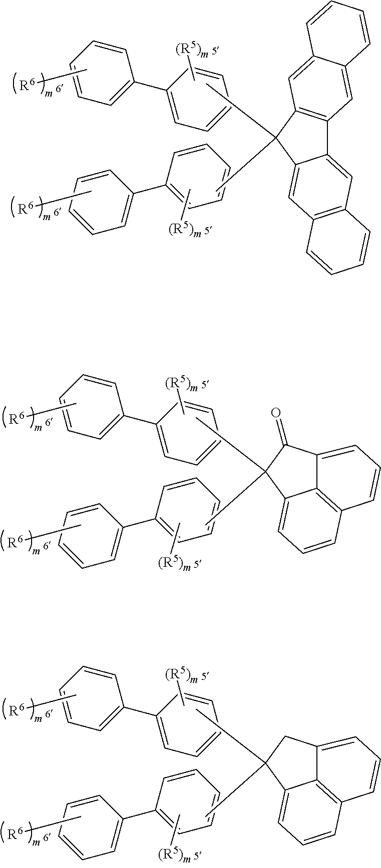

In the aromatic hydroxy compounds, R⁵ and R⁶ are as defined in the formula (3).

Each m⁵′ is independently an integer of 0 to 4, each m⁶′ is independently an integer of 0 to 5, and not all m⁵′ and m⁶′ are 0 at the same time.

Herein, at least one R⁵ and R⁶ is a hydroxy group.

Specific examples of the aromatic hydroxy compound according to the present embodiment will be further listed below, but are not limited thereto.

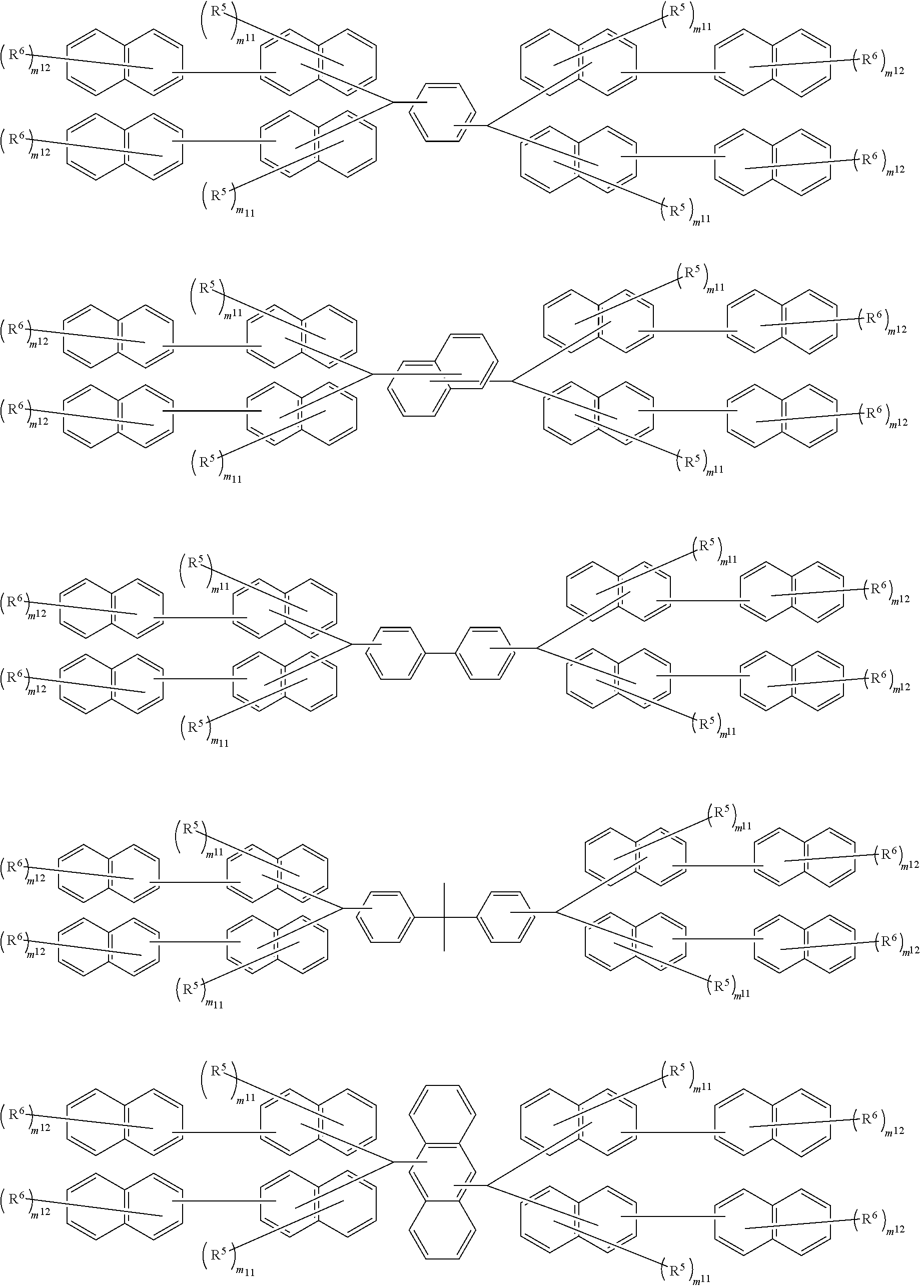

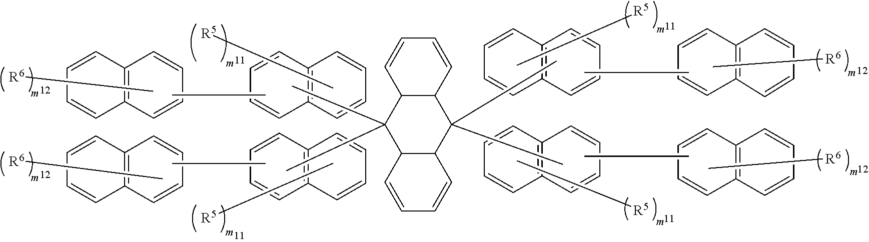

In the aromatic hydroxy compounds, R⁵ and R⁶ are as defined in the formula (3).

m¹¹ is an integer of 0 to 6, m¹² is an integer of 0 to 7, and not all m¹¹ and m¹² are 0 at the same time.

Herein, at least one R⁵ and R⁶ is a hydroxy group.

Specific examples of the aromatic hydroxy compound according to the present embodiment will be further listed below, but are not limited thereto.

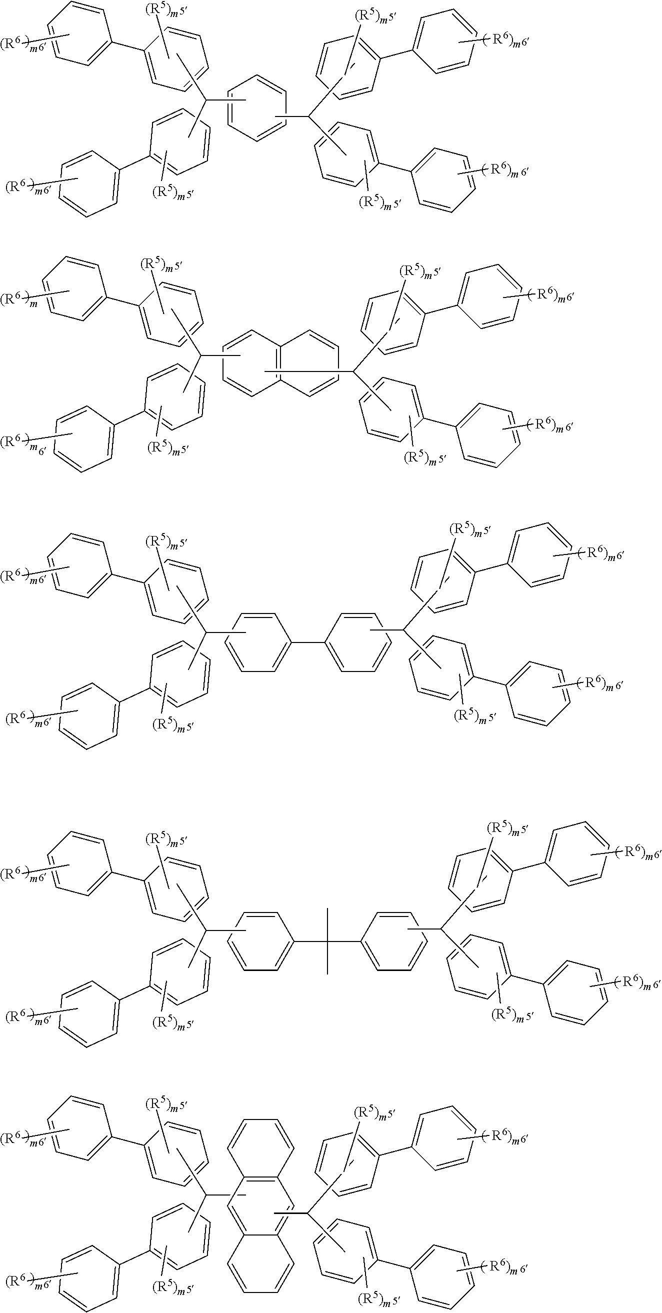

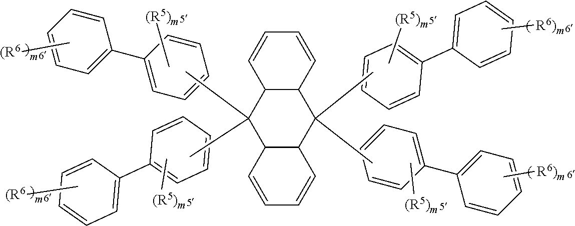

In the aromatic hydroxy compounds, R⁵ and R⁶ are as defined in the formula (3).

m⁵′ is an integer of 0 to 4, m⁶′ is an integer of 0 to 5, and not all m⁵′ and m⁶′ are 0 at the same time.

Herein, at least one R⁵ and R⁶ is a hydroxy group.

From the viewpoint of solution stability and improvement in curability, all R⁵ are preferably hydroxy groups, and from the viewpoint of further improving the dissolution stability and curability, all R⁶ are preferably hydroxy groups.

Further, A in the formula (1B) is not particularly limited, but may be, for example, a benzene ring, or any of various known fused rings such as naphthalene, anthracene, naphthacene, pentacene, benzopyrene, chrysene, pyrene, triphenylene, corannulene, coronene, and ovalene. In the present embodiment, A is preferably any of various fused rings such as naphthalene, anthracene, naphthacene, pentacene, benzopyrene, chrysene, pyrene, triphenylene, cholanthrene, coronene, and ovalene, from the viewpoint of heat resistance. Further, A is preferably naphthalene or anthracene because the n-value and the k-value at wavelengths 193 nm used in ArF exposure are low and pattern transferability tends to be excellent.

Examples of A include, in addition to the aromatic hydrocarbon rings described above, heterocycles such as pyridine, pyrrole, pyridazine, thiophene, imidazole, furan, pyrazole, oxazole, triazole, triazole, and benzo-fused rings thereof.

In the present embodiment, A is preferably an aromatic hydrocarbon ring or a heterocycle, and more preferably an aromatic hydrocarbon ring.

Further, A in the formula (1B) is not particularly limited, but may be, for example, a benzene ring, or various known fused rings such as naphthalene, anthracene, naphthacene, pentacene, benzopyrene, chrysene, pyrene, triphenylene, cholanthrene, coronene, and ovalene. In the present embodiment, preferred examples of the aromatic hydroxy compound represented by the formula (1B) include aromatic hydroxy compounds represented by the following formulas (1B′) and (1B″).

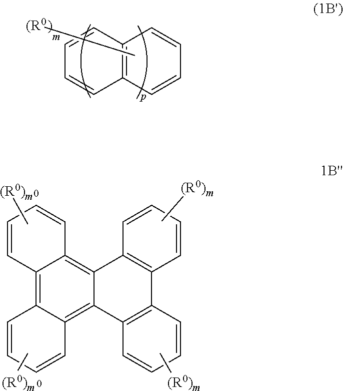

(In the formula (1B′), R⁰, m, and p are as defined in the formula (1A); and further, in the formula (1B″), R⁰ is as defined in the formula (1A), m⁰ is an integer of 0 to 4, and all m⁰ are not 0 at the same time.)

Specific examples of the aromatic hydroxy compound represented by the formula (1B′) will be listed below, but are not limited thereto.

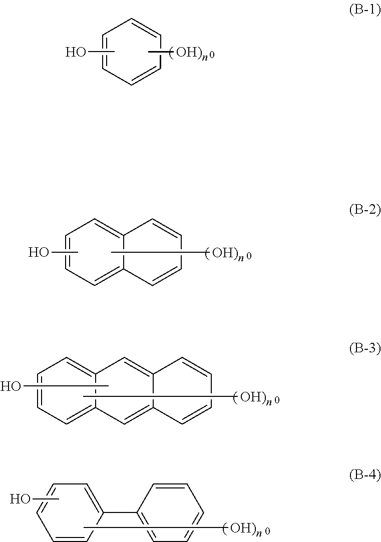

In the formula (B-1), n⁰ is an integer of 0 to 4, in the formula (B-2), n⁰ is an integer of 0 to 6, and in the formulas (B-3) to (B-4), n⁰ is an integer of 0 to 8.

Among the aromatic hydroxy compounds represented by formulas (B-1) to (B-4), those represented by formulas (B-3) to (B-4) are preferred from the viewpoint of improving etching resistance. Further, from the viewpoint of optical characteristics, those represented by (B-2) to (B-3) are preferred. Furthermore, from the viewpoint of flatness, those represented by (B-1) to (B-2) and (B-4) are preferred, and those represented by (B-4) are more preferred.

From the viewpoint of heat resistance, any one carbon atom of the aromatic ring having a phenolic hydroxy group is preferably involved in direct bond between aromatic rings.

Specific examples of the aromatic hydroxy compound represented by the formula (1B″) will be listed below, but are not limited thereto.

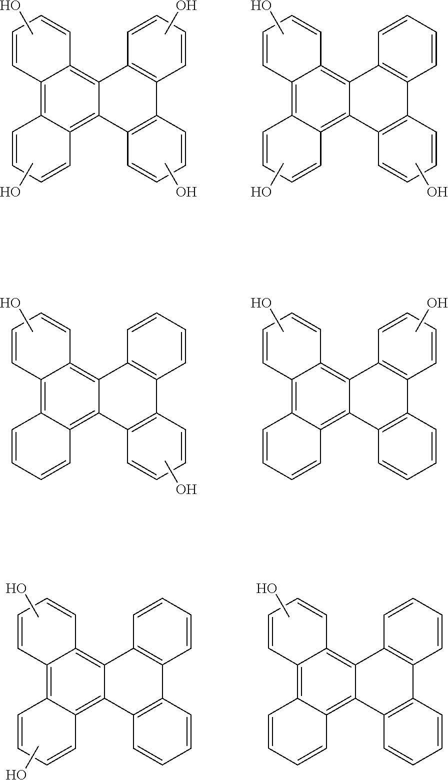

In addition to the above, an aromatic hydroxy compound represented by the following B-5 can also be used as a specific example of the formula (1B) from the viewpoint of further improving the etching resistance.

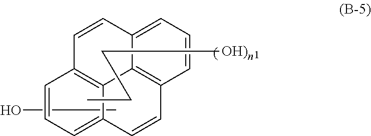

(In the formula (B-5), n¹ is an integer of 0 to 8.)

In the polycyclic polyphenolic resin of the present embodiment, the number and ratio of the respective repeating units are not particularly limited, but are preferably appropriately regulated in consideration of the application and the following values of molecular weight.

The mass average molecular weight of the polycyclic polyphenolic resin of the present embodiment is not particularly limited, but is preferably in the range of 400 to 100,000, more preferably 500 to 15,000, and still more preferably 3,200 to 12,000.

The ratio of the mass average molecular weight (Mw) to the number-average molecular weight (Mn) (Mw/Mn) is not particularly limited because the ratio required varies depending on the application, but as those having a more homogeneous molecular weight, for example, those having a ratio in the range of 3.0 or less are preferable, those having a ratio in the range of 1.05 or more and 3.0 or less are more preferable, those having a ratio in the range of 1.05 or more and less than 2.0 are particularly preferable, and those having a ratio in the range of 1.05 or more and less than 1.5 are yet still further preferable from the viewpoint of heat resistance.

The binding order of the repeating units of the polycyclic polyphenolic resin of the present embodiment in the resin is not particularly limited. For example, two or more of only the unit derived from the aromatic hydroxy compound represented by the formula (1A) may be contained as a repeating unit, two or more of only the unit derived from the aromatic hydroxy compound represented by the formula (1B) may be contained as a repeating unit, or two or more of the unit derived from the aromatic hydroxy compound represented by the formula (1A) and the unit derived from the aromatic hydroxy compound represented by the formula (1B) may be contained as one repeating unit.

The position at which the repeating units are directly bonded to each other in the polycyclic polyphenolic resin of the present embodiment is not particularly limited, and when the repeating unit is represented by the general formula (1A), any one carbon atom to which the phenolic hydroxy group and other substituents are not bonded is involved in direct bond between the monomers.

From the viewpoint of heat resistance, any one carbon atom of the aromatic ring having a phenolic hydroxy group is preferably involved in direct bond between aromatic rings.

The polycyclic polyphenolic resin of the present embodiment may contain a repeating unit having an ether bond formed by condensation of a phenolic hydroxy group within a range not impairing performance according to the application. A ketone structure may also be included.

The polycyclic polyphenolic resin of the present embodiment preferably has high solubility in a solvent from the viewpoint of easier application to a wet process, etc. More specifically, in the case of using 1-methoxy-2-propanol (PGME) and/or propylene glycol monomethyl ether acetate (PGMEA) as a solvent, it is preferable that the polycyclic polyphenolic resin of the present embodiment have a solubility of 1% by mass or more in the solvent at a temperature of 23° C., more preferably 5% by mass or more, and still more preferably 10% by mass or more. Herein, the solubility in PGME and/or PGMEA is defined as “mass of the resin/(mass of the resin+mass of the solvent)×100 (% by mass)”. For example, 10 g of the polycyclic polyphenolic resin is evaluated as being dissolved in 90 g of PGMEA when the solubility of the polycyclic polyphenolic resin is “10% by mass or more”; 10 g of the compound is evaluated as being not dissolved in 90 g of PGMEA when the solubility is “less than 10% by mass”.

### [Method for Producing Polycyclic Polyphenol]

A method for producing the polycyclic polyphenolic resin of the present embodiment is not limited to the following, but may include, for example, a step of polymerizing one or more of the aromatic hydroxy compounds in the presence of an oxidizing agent.

In carrying out such a step, the contents of K. Matsumoto, Y. Shibasaki, S. Ando and M. Ueda, Polymer, 47, 3043 (2006) can be referred to as appropriate. That is, in the oxidative polymerization of the β-naphthol type monomer, the C—C coupling at the α-position selectively is caused by an oxidative coupling reaction in which a radical subjected to one-electron oxidation due to the monomer is coupled, and for example, regioselective polymerization can be performed by using a copper/diamine type catalyst.

The oxidizing agent according to the present embodiment is not particularly limited as long as it causes an oxidative coupling reaction, and examples thereof include metal salts containing copper, manganese, iron, cobalt, ruthenium, lead, nickel, silver, tin, chromium, palladium, or the like; peroxides such as hydrogen peroxide or perchloric acids; and organic peroxides. Among them, metal salts or metal complexes containing copper, manganese, iron or cobalt can be preferably used.

Metals such as copper, manganese, iron, cobalt, ruthenium, lead, nickel, silver, tin, chromium or palladium can also be used as oxidizing agents by reduction in the reaction system. These are included in metal salts.

For example, a desired polycyclic polyphenolic resin can be obtained by dissolving an aromatic hydroxy compound represented by the general formula (1A) in an organic solvent, adding a metal salt containing copper, manganese or cobalt thereto, reacting with, for example, oxygen or an oxygen-containing gas, and carrying out oxidative polymerization.

According to the method for producing a polycyclic polyphenolic resin by oxidative polymerization as described above, it is relatively easy to control the molecular weight, and since a resin having a small molecular weight distribution can be obtained without leaving a raw material monomer or a low molecular component accompanying the increase in the molecular weight, it tends to be advantageous from the viewpoint of high heat resistance and low sublimation.

As the metal salts, halides such as copper, manganese, cobalt, ruthenium, chromium and palladium, carbonates, acetates, nitrates or phosphates can be used.

The metal complex is not particularly limited, and any of known ones can be used. Specific examples thereof include, but not limited to, complex catalysts containing copper described in Japanese Patent Publication No. 36-18692, Japanese Patent Publication No. 40-13423, Japanese Patent Laid-Open No. 49-490; complex catalysts containing manganese described in Japanese Patent Publication No. 40-30354, Japanese Patent Publication No. 47-5111, Japanese Patent Laid-Open No. 56-32523, Japanese Patent Laid-Open No. 57-44625, Japanese Patent Laid-Open No. 58-19329, Japanese Patent Laid-Open No. 60-83185; and complex catalysts containing cobalt described in Japanese Patent Publication No. 45-23555.

Examples of organic peroxides include, but not limited to, t-butyl hydroperoxide, di-t-butyl peroxide, cumene hydroperoxide, dicumyl peroxide, peracetic acid, and perbenzoic acid.

The oxidizing agents may be used alone or in combination. The use amount thereof is not particularly limited, but is preferably 0.002 mol to 10 mol, more preferably 0.003 mol to 3 mol, and still more preferably 0.005 mol to 0.3 mol, based on 1 mol of the aromatic hydroxy compound. That is, the oxidizing agent according to the present embodiment can be used at a low concentration with respect to the monomer.

In the present embodiment, it is preferable to use a base in addition to the oxidizing agent used in the step of oxidative polymerization. The base is not particularly limited, and any of known bases can be used, and specific examples thereof include inorganic bases such as alkali metal hydroxides, alkaline earth metal hydroxides, and alkali metal alkoxides, and organic bases such as primary to tertiary monoamine compounds and diamines. These may be used alone, or may be used in combination.

The oxidation method is not particularly limited, and there is a method of directly using oxygen gas or air, but air oxidation is preferable from the viewpoint of safety and cost. In the case of oxidation using air under atmospheric pressure, a method of introducing air by bubbling into a liquid in a reaction solvent is preferable from the viewpoint of improving the rate of oxidative polymerization and increasing the molecular weight of the resin.

Further, the oxidizing reaction of the present embodiment can also be a reaction under pressure, and 2 kg/cm² to 15 kg/cm² are preferable from the viewpoint of accelerating reaction, and 3 kg/cm² to 10 kg/cm² are more preferable from the viewpoint of safety and controllability.

In the present embodiment, the oxidation reaction of the aromatic hydroxy compound can be carried out even in the absence of a reaction solvent, but it is generally preferable to carry out the reaction in the presence of a solvent. As the solvent, various known solvents can be used as long as they dissolve the catalyst to some extent, as long as there is no problem in obtaining the polycyclic polyphenolic resin of the present embodiment. Generally, alcohols such as methanol, ethanol, propanol, and butanol; ethers such as dioxane, tetrahydrofuran, and ethylene glycol dimethyl ether; solvents such as amides and nitriles; ketones such as acetone, methyl ethyl ketone, methyl isobutyl ketone, cyclohexanone, and cyclopentanone; or mixtures thereof with water are used. Further, the reaction can also be carried out with hydrocarbons such as benzene, toluene or hexane which are not immiscible with water or in a two phase system of those and water.

Further, the reaction conditions may be appropriately adjusted according to the substrate concentration, the type and concentration of the oxidizing agent, but the reaction temperature can be set to a relatively low temperature, preferably 5 to 150° C., and more preferably 20 to 120° C. The reaction time is preferably from 30 minutes to 24 hours, and more preferably from 1 hour to 20 hours. The stirring method during the reaction is not particularly limited, and may be any of shaking and stirring using a rotator or a stirring blade. This step may be carried out in a solvent or in an air stream as long as the stirring conditions satisfy the above conditions.

The polycyclic polyphenolic resin of the present embodiment is preferably obtained as a crude product by the oxidation reaction described above, and then further purified to remove the residual oxidizing agent. That is, from the viewpoint of prevention of deterioration of the resin over time and storage stability, it is preferable to avoid residues of metal salts or metal complexes containing copper, manganese, iron, or cobalt mainly used as metal oxidizing agents derived from the oxidizing agent.

The residual amount of metals derived from the oxidizing agent is preferably less than 10 ppm, more preferably less than 1 ppm, and still more preferably less than 500 ppb. When the content is the 10 ppm or more, there is a tendency that it is possible to prevent a decrease in solubility of the resins in the solutions due to deterioration of the resins, and there is a tendency that it is possible to prevent an increase in turbidity (haze) of the solutions. On the other hand, when the content is less than 500 ppb, there is a tendency that the composition can be used without impairing storage stability even in the form of solutions. Thus, in the present embodiment, it is particularly preferable that the content of the impurity metals is less than 500 ppb for each metallic species.

The purification method includes, but not particularly limited to, the steps of: obtaining a solution (S) by dissolving the polycyclic polyphenolic resin in a solvent; and extracting impurities in the resin by bringing the obtained solution (S) into contact with an acidic aqueous solution (a first extraction step), wherein the solvent used in the step of obtaining the solution (S) contains an organic solvent that does not inadvertently mix with water.

According to the purification method, the contents of various metals that may be contained as impurities in the resin can be reduced.

More specifically, the resin is dissolved in an organic solvent that does not inadvertently mix with water to obtain the solution (S), and further, extraction treatment can be carried out by bringing the solution (S) into contact with an acidic aqueous solution. Thereby, metal components contained in the solution (S) are transferred to the aqueous phase, then the organic phase and the aqueous phase are separated, and thus the resin having a reduced metal content can be obtained.

The solvent that does not inadvertently mix with water used in the purification method is not particularly limited, but is preferably an organic solvent that is safely applicable to semiconductor manufacturing processes, and specifically it is an organic solvent having a solubility in water at room temperature of less than 30%, and more preferably is an organic solvent having a solubility of less than 20% and particularly preferably less than 10%. The amount of the organic solvent used is preferably 1 to 100 times the total mass of the resin to be used.

Specific examples of the solvent that does not inadvertently mix with water include, but not limited to, ethers such as diethyl ether and diisopropyl ether, esters such as ethyl acetate, n-butyl acetate, and isoamyl acetate; ketones such as methyl ethyl ketone, methyl isobutyl ketone, ethyl isobutyl ketone, cyclohexanone, cyclopentanone, 2-heptanone, and 2-pentanone; glycol ether acetates such as ethylene glycol monoethyl ether acetate, ethylene glycol monobutyl ether acetate, propylene glycol monomethyl ether acetate (PGMEA), and propylene glycol monoethyl ether acetate; aliphatic hydrocarbons such as n-hexane and n-heptane; aromatic hydrocarbons such as toluene and xylene; and halogenated hydrocarbons such as methylene chloride and chloroform. Among these, toluene, 2-heptanone, cyclohexanone, cyclopentanone, methyl isobutyl ketone, propylene glycol monomethyl ether acetate, ethyl acetate, and the like are preferable, methyl isobutyl ketone, ethyl acetate, cyclohexanone, and propylene glycol monomethyl ether acetate are more preferable, and methyl isobutyl ketone and ethyl acetate are still more preferable. Methyl isobutyl ketone, ethyl acetate, and the like have relatively high saturation solubility for the polycyclic polyphenolic resin and a relatively low boiling point, and it is thus possible to reduce the load in the case of industrially distilling off the solvent and in the step of removing the solvent by drying. These solvents can be each used alone, or can also be used as a mixture of two or more kinds.

The acidic aqueous solution used in the purification method is arbitrarily selected from among aqueous solutions in which organic compounds or inorganic compounds are dissolved in water, generally known as acidic aqueous solutions. Examples of the acidic aqueous solution include, but not limited to, aqueous mineral acid solutions in which mineral acids such as hydrochloric acid, sulfuric acid, nitric acid, and phosphoric acid are dissolved in water, or aqueous organic acid solutions in which organic acids such as acetic acid, propionic acid, oxalic acid, malonic acid, succinic acid, fumaric acid, maleic acid, tartaric acid, citric acid, methanesulfonic acid, phenolsulfonic acid, p-toluenesulfonic acid, and trifluoroacetic acid are dissolved in water. These acidic aqueous solutions can be each used alone, and can be also used as a combination of two or more kinds. Among these acidic aqueous solutions, aqueous solutions of one or more mineral acids selected from the group consisting of hydrochloric acid, sulfuric acid, nitric acid and phosphoric acid, or aqueous solutions of one or more organic acids selected from the group consisting of acetic acid, propionic acid, oxalic acid, malonic acid, succinic acid, fumaric acid, maleic acid, tartaric acid, citric acid, methanesulfonic acid, phenolsulfonic acid, p-toluenesulfonic acid and trifluoroacetic acid are preferable, aqueous solutions of sulfuric acid, nitric acid, and carboxylic acids such as acetic acid, oxalic acid, tartaric acid and citric acid are more preferable, aqueous solutions of sulfuric acid, oxalic acid, tartaric acid and citric acid are still more preferable, and an aqueous solution of oxalic acid is even more preferable. It is considered that polyvalent carboxylic acids such as oxalic acid, tartaric acid and citric acid coordinate with metal ions and provide a chelating effect, and thus tend to be capable of more effectively removing metals. Also, as for water used herein, it is preferable to use water, the metal content of which is small, such as ion exchanged water, according to the purpose of the purification method according to the present embodiment.

The pH of the acidic aqueous solution used in the purification method is not particularly limited, but it is preferable to regulate the acidity of the aqueous solution in consideration of an influence on the resin. Normally, the pH range is about 0 to 5, and is preferably about pH 0 to 3.

The amount of the acidic aqueous solution used in the purification method is not particularly limited, but it is preferable to regulate the amount from the viewpoint of reducing the number of extraction operations for removing metals and from the viewpoint of ensuring operability in consideration of the overall amount of fluid. From the above viewpoints, the amount of the acidic aqueous solution used is preferably 10 to 200% by mass, and more preferably 20 to 100% by mass, based on 100% by mass of the solution (S).

In the purification method, by bringing the acidic aqueous solution as described above into contact with the solution (S), metal components can be extracted from the resin in the solution (S).

In the purification method, the solution (S) may further contain an organic solvent that inadvertently mixes with water. When the solution (S) contains an organic solvent that inadvertently mixes with water, there is a tendency that the amount of the resin charged can be increased, also the fluid separability is improved, and purification can be carried out at a high reaction vessel efficiency. The method for adding the organic solvent that inadvertently mixes with water is not particularly limited. For example, any of a method involving adding it to the organic solvent-containing solution in advance, a method involving adding it to water or the acidic aqueous solution in advance, and a method involving adding it after bringing the organic solvent-containing solution into contact with water or the acidic aqueous solution may be employed. Among these, the method involving adding it to the organic solvent-containing solution in advance is preferable in terms of the workability of operations and the ease of managing the amount to be charged.

The organic solvent that inadvertently mixes with water used in the purification method is not particularly limited, but is preferably an organic solvent that is safely applicable to semiconductor manufacturing processes. The amount of the organic solvent used that inadvertently mixes with water is not particularly limited as long as the solution phase and the aqueous phase separate, but is preferably 0.1 to 100 times, more preferably 0.1 to 50 times, and further preferably 0.1 to 20 times the total mass of the resin to be used.

Specific examples of the organic solvent used in the purification method that inadvertently mixes with water include, but not limited to, ethers such as tetrahydrofuran and 1,3-dioxolane; alcohols such as methanol, ethanol, and isopropanol; ketones such as acetone and N-methylpyrrolidone; aliphatic hydrocarbons such as glycol ethers such as ethylene glycol monoethyl ether, ethylene glycol monobutyl ether, propylene glycol monomethyl ether (PGME), and propylene glycol monoethyl ether. Among these, N-methylpyrrolidone, propylene glycol monomethyl ether and the like are preferable, and N-methylpyrrolidone and propylene glycol monomethyl ether are more preferable. These solvents can be each used alone, or can also be used as a mixture of two or more kinds.

The temperature when extraction treatment is carried out is generally in the range of 20 to 90° C., and preferably 30 to 80° C. The extraction operation is carried out, for example, by thoroughly mixing the solution (S) and the acidic aqueous solution by stirring or the like and then leaving the obtained mixed solution to stand still. Thereby, metals contained in the solution (S) are transferred to the aqueous phase. Also, by this operation, the acidity of the solution is lowered, and the deterioration of the resin can be suppressed.

By being left to stand still, the mixed solution is separated into an aqueous phase and a solution phase containing the resin and the solvents, and thus the solution phase is recovered by decantation and the like. The time for leaving the mixed solution to stand still is not particularly limited, but it is preferable to regulate the time for leaving the mixed solution to stand still from the viewpoint of attaining good separation of the solution phase containing the solvents and the aqueous phase. Normally, the time for leaving the mixed solution to stand still is 1 minute or longer, preferably 10 minutes or longer, and more preferably 30 minutes or longer. While the extraction treatment may be carried out once, it is effective to repeat mixing, leaving-to-stand-still, and separating operations multiple times.

It is preferable that the purification method includes the step of extracting impurities in the resin by further bringing the solution phase containing the resin into contact with water after the first extraction step (the second extraction step). Specifically, for example, it is preferable that after the above extraction treatment is carried out using an acidic aqueous solution, the solution phase that is extracted and recovered from the aqueous solution and that contains the resin and the solvents is further subjected to extraction treatment with water. The extraction treatment with water is not particularly limited, and can be carried out, for example, by thoroughly mixing the solution phase and water by stirring or the like and then leaving the obtained mixed solution to stand still. The mixed solution after being left to stand still is separated into an aqueous phase and a solution phase containing the resin and the solvents, and thus the solution phase can be recovered by decantation.

Water used herein is preferably water, the metal content of which is small, such as ion exchanged water, according to the purpose of the present embodiment. While the extraction treatment may be carried out once, it is effective to repeat mixing, leaving-to-stand-still, and separating operations multiple times. In addition, the proportions of both used in the extraction treatment, and temperature, time and other conditions are not particularly limited, and may be the same as those of the previous contact treatment with the acidic aqueous solution.

Water that is possibly present in the thus-obtained solution containing the resin and the solvents can be easily removed by performing vacuum distillation or a like operation. Also, if required, the concentration of the resin can be regulated to be any concentration by adding a solvent to the solution.

As the method for purifying the polycyclic polyphenolic resin according to the present embodiment, purification can also be performed by passing a solution obtained by dissolving the resin in a solvent through a filter.

According to the method for purifying the substance according to the present embodiment, the content of various metal components in the resin can be effectively and significantly reduced. The amounts of these metal components can be measured by the method described in Examples below.

Herein, the term “passed through” of the present embodiment means that the above-described solution is passed from the outside of the filter through the inside of the filter and is allowed to move out of the filter again. For example, a mode in which the solution is simply brought into contact with the surface of the filter and a mode in which the solution is brought into contact on the surface while being allowed to move outside an ion exchange resin (that is, a mode in which the solution is simply brought into contact) are excluded.

### [Filter Purification Step (Liquid Passing Step)]

In the step of passing a liquid through a filter according to the present embodiment, a filter commercially available for liquid filtration can usually be used as the filter used for removing the metal component in the solution containing the resin and the solvent. The filtration accuracy of the filter is not particularly limited, but the nominal pore size of the filter is preferably 0.2 μm or less, more preferably less than 0.2 μm, still more preferably 0.1 μm or less, still further preferably less than 0.1 μm, and yet still further preferably 0.05 μm or less. The lower limit value of the nominal pore size of the filter is not particularly limited, but is usually 0.005 μm. The term “nominal pore size” as used herein refers to the pore size nominally used to indicate the separation performance of the filter, which is determined, for example, by any method specified by the filter manufacturer, such as a bubble point test, a mercury intrusion test or a standard particle trapping test. When using a commercially available product, the nominal pore size is a value described in the manufacturer's catalog data. The nominal pore size of 0.2 μm or less makes it possible to effectively reduce the contents of the metal components after passing the solution through the filter once. In the present embodiment, the step of passing a liquid through a filter may be performed twice or more to reduce the content of each metal component in the solution.

Examples of the filter to be used include a hollow fiber membrane filter, a membrane filter, a pleated membrane filter, and a filter filled with a filter medium such as a non-woven fabric, cellulose or diatomaceous earth. Among the above, the filter is preferably one or more selected from the group consisting of a hollow fiber membrane filter, a membrane filter and a pleated membrane filter. Further, it is particularly preferable to use a hollow fiber membrane filter, in particular due to its high precision filtration accuracy and its higher filtration area than other forms.

Examples of a material for the filter include a polyolefin such as polyethylene or polypropylene; a polyethylene-based resin having a functional group having an ion exchange capacity provided by graft polymerization; a polar group-containing resin such as polyamide, polyester or polyacrylonitrile; and a fluorine-containing resin such as fluorinated polyethylene (PTFE). Among the above, the filter is preferably made of one or more filter media selected from the group consisting of a polyamide, a polyolefin resin and a fluororesin. Further, a polyamide medium is particularly preferable from the viewpoint of the reduction effect of heavy metals such as chromium. From the viewpoint of avoiding metal elution from the filter medium, it is preferable to use a filter other than the sintered metal material.

Examples of the polyamide filter include (hereinafter described under the trade name), but not limited to: Polyfix nylon series manufactured by KITZ MICROFILTER CORPORATION; Ultipleat P-Nylon 66 and Ultipor N66 manufactured by Nihon Pall Ltd.; and LifeASSURE PSN series and LifeASSURE EF series manufactured by 3M Company.

Examples of polyolefin-based filter include, but are not limited to: Ultipleat PE Clean and Ion Clean manufactured by Nihon Pall Ltd.; Protego series, Microgard Plus HC10 and Optimizer D manufactured by Entegris Japan Co., Ltd.

Examples of the polyester-based filter include, but are not limited to: Geraflow DFE manufactured by Central Filter Mfg. Co., Ltd.; and a pleated type PMC manufactured by Nihon Filter Co., Ltd.

Examples of the polyacrylonitrile-based filter include, but are not limited to: Ultrafilters AIP-0013D, ACP-0013D and ACP-0053D manufactured by Advantec Toyo Kaisha, Ltd.

Examples of the fluororesin-based filter include, but are not limited to: Emflon HTPFR manufactured by Nihon Pall Ltd.; and LifeASSURE FA series manufactured by 3M Company.

These filters may be each used alone or in combination of two or more thereof.

The filter may also contain an ion exchanger such as a cation exchange resin, or a cation charge controlling agent that causes a zeta potential in an organic solvent solution to be filtered.

Examples of the filter containing an ion exchanger include, but are limited to: Protego series manufactured by Entegris Japan Co., Ltd.; and KURANGRAFT manufactured by Kurashiki Textile Manufacturing Co., Ltd.

Examples of the filter containing a material having a positive zeta potential such as a cationic polyamidepolyamine-epichlorohydrin resin include (hereinafter described under the trade name), but not limited to: Zeta Plus 40QSH and Zeta Plus 020GN and LifeASSURE EF series manufactured by 3M company.

The method for isolating the resin from the obtained solution containing the resin and the solvents is not particularly limited, and publicly known methods can be carried out, such as reduced-pressure removal, separation by reprecipitation, and a combination thereof. Publicly known treatments such as concentration operation, filtration operation, centrifugation operation, and drying operation can be carried out if required.

The polycyclic polyphenolic resin of the present embodiment may further have a modified portion derived from a crosslinking compound. That is, the polycyclic polyphenolic resin of the present embodiment having the structure described above may have a modified portion obtained by reaction with the crosslinking compound. Such a (modified) polycyclic polyphenolic resin is also excellent in heat resistance and etching resistance, and can be used as a coating agent for semiconductors, a material for resists, and a semiconductor underlayer film forming material.

Examples of the crosslinking compound include, but not limited to, aldehydes, ketones, carboxylic acids, carboxylic acid halides, halogen-containing compounds, amino compounds, imino compounds, isocyanate compounds, and unsaturated hydrocarbon group-containing compounds. These can be used alone or in combination as appropriate.

In the present embodiment, the crosslinking compound is preferably an aldehyde or a ketone. More specifically, it is preferably a polycyclic polyphenolic resin obtained by subjecting the polycyclic polyphenolic resin of the present embodiment having the structure described above to a polycondensation reaction with an aldehyde or a ketone in the presence of an acid catalyst. For example, a novolac type polycyclic polyphenolic resin can be obtained by subjecting an aldehyde or a ketone corresponding to a desired structure to a polycondensation reaction under normal pressure and optionally pressurized conditions under an acid catalyst.

Examples of the aldehyde include, but not particularly limited to, methylbenzaldehyde, dimethylbenzaldehyde, trimethylbenzaldehyde, ethylbenzaldehyde, propylbenzaldehyde, butylbenzaldehyde, pentabenzaldehyde, butylmethylbenzaldehyde, hydroxybenzaldehyde, dihydroxybenzaldehyde, and fluoromethylbenzaldehyde. These can be used alone as one kind or can be used in combination of two or more kinds. Among them, methylbenzaldehyde, dimethylbenzaldehyde, trimethylbenzaldehyde, ethylbenzaldehyde, propylbenzaldehyde, butylbenzaldehyde, pentabenzaldehyde, butylmethylbenzaldehyde, or the like is preferably used from the viewpoint of imparting high heat resistance.

Examples of the ketone include, but not particularly limited to, acetylmethylbenzene, acetyldimethylbenzene, acetyltrimethylbenzene, acetylethylbenzene, acetylpropylbenzene, acetylbutylbenzene, acetylpentabenzene, acetylbutylmethylbenzene, acetylhydroxybenzene, acetyldihydroxybenzene, and acetylfluoromethylbenzene. These ketones can be used alone as one kind or can be used in combination of two or more kinds. Among them, acetylmethylbenzene, acetyldimethylbenzene, acetyltrimethylbenzene, acetylethylbenzene, acetylpropylbenzene, acetylbutylbenzene, acetylpentabenzene, or acetylbutylmethylbenzene is preferably used from the viewpoint of imparting high heat resistance.

The acid catalyst used in the above reaction can be arbitrarily selected for use from publicly known acid catalysts and is not particularly limited. Inorganic acids and organic acids are widely known as such acid catalysts. Specific examples of the acid catalyst include, but not particularly limited to, inorganic acids such as hydrochloric acid, sulfuric acid, phosphoric acid, hydrobromic acid, and hydrofluoric acid; organic acids such as oxalic acid, malonic acid, succinic acid, adipic acid, sebacic acid, citric acid, fumaric acid, maleic acid, formic acid, p-toluenesulfonic acid, methanesulfonic acid, trifluoroacetic acid, dichloroacetic acid, trichloroacetic acid, trifluoromethanesulfonic acid, benzenesulfonic acid, naphthalenesulfonic acid, and naphthalenedisulfonic acid; Lewis acids such as zinc chloride, aluminum chloride, iron chloride, and boron trifluoride; and solid acids such as tungstosilicic acid, tungstophosphoric acid, silicomolybdic acid, and phosphomolybdic acid. Among them, organic acids and solid acids are preferable from the viewpoint of production, and hydrochloric acid or sulfuric acid is preferably used from the viewpoint of production such as easy availability and handleability. The acid catalysts can be used alone as one kind or can be used in combination of two or more kinds. Further, the amount of the acid catalyst used can be arbitrarily set according to, for example, the kind of the raw materials used and the catalyst used and moreover the reaction conditions and is not particularly limited, but is preferably 0.01 to 100 parts by mass based on 100 parts by mass of the reaction raw materials.

Upon the above reaction, a reaction solvent may be used. The reaction solvent is not particularly limited as long as the reaction of the aldehyde or the ketone used with the polycyclic polyphenolic resin proceeds, and can be arbitrarily selected and used from publicly known solvents. Examples include water, methanol, ethanol, propanol, butanol, tetrahydrofuran, dioxane, ethylene glycol dimethyl ether, ethylene glycol diethyl ether, and a mixed solvent thereof. The solvents can be used alone as one kind or can be used in combination of two or more kinds. Also, the amount of these solvents used can be arbitrarily set according to, for example, the kind of the raw materials used and the acid catalyst used and moreover the reaction conditions. The amount of the above solvent used is not particularly limited, but is preferably in the range of 0 to 2000 parts by mass based on 100 parts by mass of the reaction raw materials. Furthermore, the reaction temperature in the above reaction can be arbitrarily selected according to the reactivity of the reaction raw materials. The above reaction temperature is not particularly limited, but is usually preferably within the range of 10 to 200° C. The reaction method can be arbitrarily selected and used from publicly known approaches and is not particularly limited, and there are a method of charging the polycyclic polyphenolic resin of the present embodiment, the aldehyde or the ketone, and the acid catalyst in one portion, and a method of dropping the aldehyde or the ketone in the presence of the acid catalyst. After the polycondensation reaction terminates, isolation of the obtained compound can be carried out according to a conventional method, and is not particularly limited. For example, by adopting a commonly used approach in which the temperature of the reaction vessel is elevated to 130 to 230° C. in order to remove unreacted raw materials, catalyst, etc. present in the system, and volatile portions are removed at about 1 to 50 mmHg, the compound that is the target compound can be obtained.

The polycyclic polyphenolic resin of the present embodiment can be used as a composition for various purposes. That is, the composition of the present embodiment contains the polycyclic polyphenolic resin of the present embodiment. The composition of the present embodiment preferably further contains a solvent from the viewpoint of facilitating film formation by the application of a wet process, or the like.

Specific examples of the solvent include, but not particularly limited to: ketone-based solvents such as acetone, methyl ethyl ketone, methyl isobutyl ketone, and cyclohexanone; cellosolve-based solvents such as propylene glycol monomethyl ether and propylene glycol monomethyl ether acetate; ester-based solvents such as ethyl lactate, methyl acetate, ethyl acetate, butyl acetate, isoamyl acetate, ethyl lactate, methyl methoxypropionate, and methyl hydroxyisobutyrate; alcohol-based solvents such as methanol, ethanol, isopropanol, and 1-ethoxy-2-propanol; and aromatic hydrocarbons such as toluene, xylene, and anisole. These solvents can be used alone as one kind or used in combination of two or more kinds.

Among the above solvents, propylene glycol monomethyl ether, propylene glycol monomethyl ether acetate, cyclohexanone, cyclopentanone, ethyl lactate, or methyl hydroxyisobutyrate is particularly preferable from the viewpoint of safety.

The content of the solvent is not particularly limited and is preferably 100 to 10,000 parts by mass based on 100 parts by mass of the polycyclic polyphenolic resin of the present embodiment, more preferably 200 to 5,000 parts by mass, and still more preferably 200 to 1,000 parts by mass, from the viewpoint of solubility and film formation.

### EXAMPLES

Hereinafter, the present embodiment will be described in more detail based on Examples, and Comparative Examples, but the present embodiment is not limited thereto.

¹H-NMR measurement was carried out under the following conditions by using “Advance 600II spectrometer” manufactured by Bruker Corp.

Frequency: 400 MHz

Solvent: d6-DMSO

Internal standard: TMS

Measurement temperature: 23° C.

### (Molecular Weight)

The molecular weight of a compound was measured by LC-MS analysis using Acquity UPLC/MALDI-Synapt HDMS manufactured by Waters Corp.

### (Molecular Weight in Terms of Polystyrene)

The weight average molecular weight (Mw) and the number average molecular weight (Mn) in terms of polystyrene were determined by gel permeation chromatography (GPC) analysis, and the dispersibility (Mw/Mn) was determined.

Apparatus: Shodex GPC-101 model (manufactured by Showa Denko K.K.)

Column: KF-80M×3

Eluent: 1 mL/min THF

Temperature: 40° C.

### (Synthesis Example 1) Synthesis of R-DHN

To a container (internal capacity: 500 mL) equipped with a stirrer, a condenser tube, and a burette, 16.8 g (105 mmol) of 2,6-dihydroxynaphthalene (reagent manufactured by Kanto Chemical Co., Inc.) and 10.1 g (20 mmol) of monobutylcopper phthalate were added, and 30 mL of 1-butanol was added as a solvent. The reaction solution was stirred at 110° C. for 6 hours and reacted. After cooling, the precipitate was filtered and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 200 mL of methanol was added to precipitate the reaction product. After cooling to room temperature, the precipitates were separated by filtration. The obtained solid matter was dried to obtain 27.3 g of the objective resin (R-DHN) having a structure represented by the following formula.

As a result of measuring the molecular weight in terms of polystyrene of the obtained resin by the above method, the molecular weight was Mn: 3578, Mw: 4793, and Mw/Mn: 1.34.

The following peaks were found by NMR measurement performed on the obtained resin under the above measurement conditions, and the resin was confirmed to have a chemical structure of the following formula.

δ (ppm) 9.7-9.8 (2H, O—H), 7.0-7.9 (4H, Ph-H)

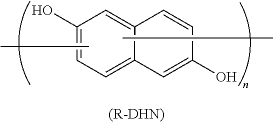

### (Synthesis Example 1-2) Synthesis of R-2,7DHN

To a container (internal capacity: 500 mL) equipped with a stirrer, a condenser tube, and a burette, 16.8 g (105 mmol) of 2,7-dihydroxynaphthalene (reagent manufactured by Kanto Chemical Co., Inc.) and 15.2 g (30 mmol) of monobutylcopper phthalate were added, and 40 mL of 1-butanol was added as a solvent. The reaction solution was stirred at 110° C. for 6 hours and reacted. After cooling, the precipitate was filtered and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 200 mL of methanol was added to precipitate the reaction product. After cooling to room temperature, the precipitates were separated by filtration. The obtained solid matter was dried to obtain 24.7 g of the objective resin (R-2,7DHN) having a structure represented by the following formula.

As a result of measuring the molecular weight in terms of polystyrene of the obtained resin by the above method, the molecular weight was Mn: 2832, Mw: 3476, and Mw/Mn: 1.23.

The following peaks were found by NMR measurement performed on the obtained resin under the above measurement conditions, and the resin was confirmed to have a chemical structure of the following formula.

δ (ppm) 9.7-9.8 (2H, O—H), 7.0-7.9 (4H, Ph-H)

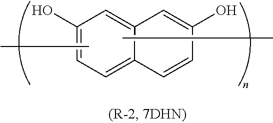

### (Synthesis Example 1-3) Synthesis of R-2,3DHN

In the same manner as in Synthesis Example 1-2 except that 2,7-dihydroxynaphthalene (reagent manufactured by Kanto Chemical Co., Inc.) in Synthesis Example 1-2 was changed to 2,3-dihydroxynaphthalene (reagent manufactured by Kanto Chemical Co., Inc.), 29.2 g of the objective resin (R-2,3DHN) having a structure represented by the following formula was obtained.

As a result of measuring the molecular weight in terms of polystyrene of the obtained resin by the above method, the molecular weight was Mn: 3124, Mw: 4433, and Mw/Mn: 1.42.

The following peaks were found by NMR measurement performed on the obtained resin under the above measurement conditions, and the resin was confirmed to have a chemical structure of the following formula.

δ (ppm) 9.5-9.6 (2H, O—H), 7.0-7.9 (4H, Ph-H)

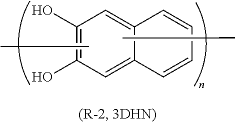

### (Synthesis Example 1-4) Synthesis of R-1,5DHN

In the same manner as in Synthesis Example 1-2 except that 2,7-dihydroxynaphthalene (reagent manufactured by Kanto Chemical Co., Inc.) in Synthesis Example 1-2 was changed to 1,5-dihydroxynaphthalene (reagent manufactured by Kanto Chemical Co., Inc.), 25.8 g of the objective resin (R-1,5DHN) having a structure represented by the following formula was obtained.

As a result of measuring the molecular weight in terms of polystyrene of the obtained resin by the above method, the molecular weight was Mn: 2988, Mw: 3773, and Mw/Mn: 1.26.

The following peaks were found by NMR measurement performed on the obtained resin under the above measurement conditions, and the resin was confirmed to have a chemical structure of the following formula.

δ (ppm) 9.8-9.9 (2H, O—H), 7.1-8.0 (4H, Ph-H)

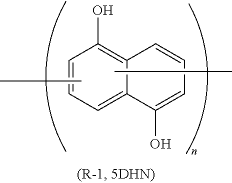

### (Synthesis Example 1-5) Synthesis of R-1,6DHN

In the same manner as in Synthesis Example 1-2 except that 2,7-dihydroxynaphthalene (reagent manufactured by Kanto Chemical Co., Inc.) in Synthesis Example 1-2 was changed to 1,6-dihydroxynaphthalene (reagent manufactured by Kanto Chemical Co., Inc.), 23.2 g of the objective resin (R-1,6DHN) having a structure represented by the following formula was obtained.

As a result of measuring the molecular weight in terms of polystyrene of the obtained resin by the above method, the molecular weight was Mn: 2687, Mw: 3693, and Mw/Mn: 1.37.

The following peaks were found by NMR measurement performed on the obtained resin under the above measurement conditions, and the resin was confirmed to have a chemical structure of the following formula.

δ (ppm) 9.8-9.9 (2H, O—H), 6.8-7.9 (4H, Ph-H)

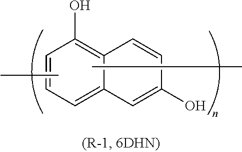

### (Synthesis Example 1-6) Synthesis of R-FLBNDHN

To a container (internal capacity: 500 mL) equipped with a stirrer, a condenser tube, and a burette, 47.3 g (105 mmol) of 6,6′-(9H-fluorene-9,9-diyl)bis(2-naphthol) (manufactured by Kanto Chemical Co., Inc.), 16.8 g (105 mmol) of 2,6-dihydroxynaphthalene (manufactured by Kanto Chemical Co., Inc.) and 10.1 g (20 mmol) of monobutylcopper phthalate were added, and 120 mL of 4-butyrolactone was added as a solvent. The reaction solution was stirred at 120° C. for 8 hours and reacted. After cooling, the precipitate was filtered and the resulting crude was dissolved in 150 mL of ethyl acetate. Next, 5 mL of hydrochloric acid was added, and the mixture was stirred at room temperature, and neutralized with sodium hydrogen carbonate. The ethyl acetate solution was concentrated and 300 mL of distilled water was added to precipitate the reaction product. After cooling to room temperature, the precipitates were separated by filtration. The obtained solid matter was dried to obtain 51.6 g of the objective resin (R-FLBNDHN) having a structure represented by the following formula.

As a result of measuring the molecular weight in terms of polystyrene of the obtained resin by the above method, the molecular weight was Mn: 4128, Mw: 5493, and Mw/Mn: 1.33.

The following peaks were found by NMR measurement performed on the obtained resin under the above measurement conditions, and the resin was confirmed to have a chemical structure of the following formula.

δ (ppm) 9.7-9.9 (2H, O—H), 9.1-9.3 (2H, O—H), 7.1-8.0 (22H, Ph-H)

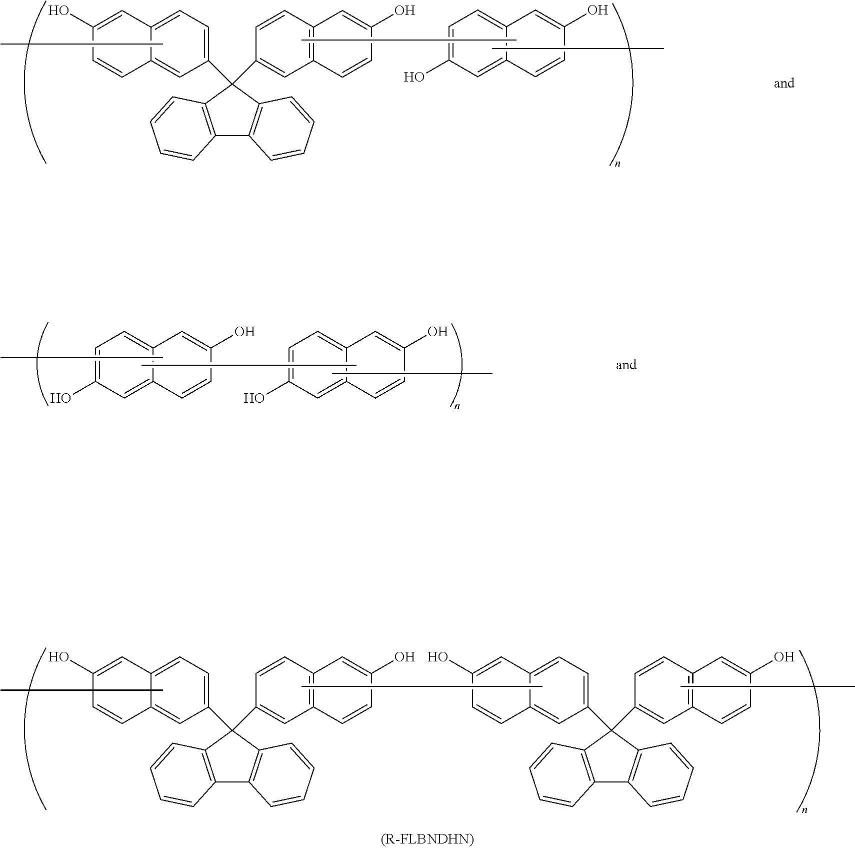

That is, R-FLBNDHN was a mixture containing a homopolymer of 6,6′-(9H-fluorene-9,9-diyl)bis(2-naphthol), a homopolymer of 2,6-dihydroxynaphthalene, and a copolymer of 6,6′-(9H-fluorene-9,9-diyl)bis(2-naphthol) and 2,6-dihydroxynaphthalene.

### (Synthesis Example 2) Synthesis of R-BiF

To a container (internal capacity: 500 mL) equipped with a stirrer, a condenser tube, and a burette, 19.2 g (105 mmol) of 4,4-biphenol (reagent manufactured by Kanto Chemical Co., Inc.) and 10.1 g (20 mmol) of monobutylcopper phthalate were added, and 80 mL of 4-butyrolactone was added as a solvent. The reaction solution was stirred at 120° C. for 6 hours and reacted. After cooling, the precipitate was filtered and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 200 mL of methanol was added to precipitate the reaction product. After cooling to room temperature, the precipitates were separated by filtration. The obtained solid matter was dried to obtain 21.2 g of the objective resin (R-BiF) having a structure represented by the following formula.

As a result of measuring the molecular weight in terms of polystyrene of the obtained resin by the above method, the molecular weight was Mn: 4128, Mw: 5493, and Mw/Mn: 1.33.

The following peaks were found by NMR measurement performed on the obtained resin under the above measurement conditions, and the resin was confirmed to have a chemical structure of the following formula.

δ (ppm) 9.1-9.3 (2H, O—H), 7.1-8.2 (6H, Ph-H)

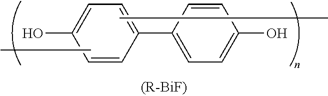

### (Synthesis Example 3) Synthesis of BisN-1

To a container (internal capacity: 500 mL) equipped with a stirrer, a condenser tube, and a burette, 20.0 g (200 mmol) of 1,4-dihydroxybenzene (reagent manufactured by Kanto Chemical Co., Inc.), 18.2 g (100 mmol) of 4-biphenylaldehyde (manufactured by Mitsubishi Gas Chemical Company, Inc.), and 100 mL of 1,4-dioxane were added, and 5 mL of 95% sulfuric acid was added. The reaction solution was stirred at 100° C. for 6 hours and reacted. Next, the reaction liquid was neutralized with 24% aqueous sodium hydroxide solution. The reaction product was precipitated by the addition of 50 g of pure water. After cooling to room temperature, the precipitates were separated by filtration. The obtained solid matter was dried and then separated and purified by column chromatography to obtain 20.6 g of the objective compound (BisN-1) represented by the following formula.

The following peaks were found by 400 MHz-¹H-NMR, and the compound was confirmed to have a chemical structure of the following formula.

¹H-NMR: (d-DMSO, Internal standard TMS)

δ (ppm) 9.4 (2H, O—H), 7.2-8.1 (13H, Ph-H), 6.5 (1H, C—H)

LC-MS analysis confirmed that the molecular weight was 366.1 corresponding to the following chemical structure.

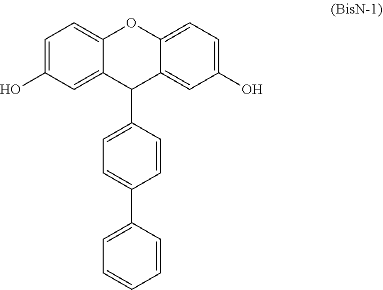 [SMILES: Oc1ccc2c(c1)C(c1ccc(-c3ccccc3)cc1)c1cc(O)ccc1O2]

### (Synthesis Example 3-1) Synthesis of RBisN-1

To a container (internal capacity: 500 mL) equipped with a stirrer, a condenser tube, and a burette, 38.0 g (105 mmol) of BisN-1 and 10.1 g (20 mmol) of monobutylcopper phthalate were added, and 100 mL of 1-butanol was added as a solvent. The reaction solution was stirred at 100° C. for 6 hours and reacted. After cooling, the precipitate was filtered and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 200 mL of methanol was added to precipitate the reaction product. After cooling to room temperature, the precipitates were separated by filtration. The obtained solid matter was dried to obtain 28.2 g of the objective resin (RBisN-1) having a structure represented by the following formula.

As a result of measuring the molecular weight in terms of polystyrene of the obtained resin by the above method, the molecular weight was Mn: 3762, Mw: 4905, and Mw/Mn: 1.30.

The following peaks were found by NMR measurement performed on the obtained resin under the above measurement conditions, and the resin was confirmed to have a chemical structure of the following formula.

δ (ppm) 9.3-9.6 (2H, O—H), 7.2-8.7 (17H, Ph-H), 6.8 (1H, C—H)

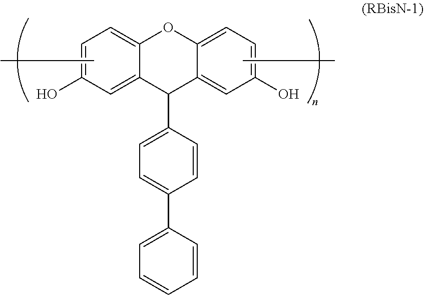

### (Synthesis Example 4) Synthesis of BisN-2

To a container (internal capacity: 500 mL) equipped with a stirrer, a condenser tube, and a burette, 32.0 g (20 mmol) of 2,6-naphthalenediol (reagent manufactured by Sigma-Aldrich), 18.2 g (100 mmol) of 4-biphenylaldehyde (manufactured by Mitsubishi Gas Chemical Company, Inc.), and 200 mL of 1,4-dioxane were added, and 10 mL of 95% sulfuric acid was added. The reaction solution was stirred at 100° C. for 6 hours and reacted. Next, the reaction liquid was neutralized with 24% aqueous sodium hydroxide solution. The reaction product was precipitated by the addition of 100 g of pure water. After cooling to room temperature, the precipitates were separated by filtration. The obtained solid matter was dried and then separated and purified by column chromatography to obtain 25.5 g of the objective compound (BisN-2) represented by the following formula.

The following peaks were found by 400 MHz-¹H-NMR, and the compound was confirmed to have a chemical structure of the following formula. From the doublets of proton signals at positions 3 and 4, it was confirmed that the substitution position of 2,6-dihydroxynaphthol was position 1.

¹H-NMR: (d-DMSO, Internal standard TMS)

δ (ppm) 9.7 (2H, O—H), 7.2-8.5 (19H, Ph-H), 6.6 (1H, C—H)

LC-MS analysis confirmed that the molecular weight was 466.5 corresponding to the following chemical structure.

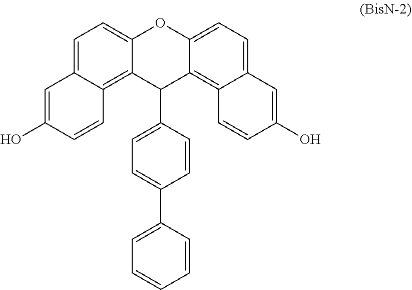 [SMILES: Oc1ccc2c3c(ccc2c1)Oc1ccc2cc(O)ccc2c1C3c1ccc(-c2ccccc2)cc1]

### (Synthesis Example 4-1) Synthesis of RBisN-2

To a container (internal capacity: 500 mL) equipped with a stirrer, a condenser tube, and a burette, 50 g (105 mmol) of BisN-2 and 10.1 g (20 mmol) of monobutylcopper phthalate were added, and 100 mL of 1-butanol was added as a solvent. The reaction solution was stirred at 100° C. for 6 hours and reacted. After cooling, the precipitate was filtered and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 200 mL of methanol was added to precipitate the reaction product. After cooling to room temperature, the precipitates were separated by filtration. The obtained solid matter was dried to obtain 38.2 g of the objective resin (RBisN-2) having a structure represented by the following formula.

As a result of measuring the molecular weight in terms of polystyrene of the obtained resin by the above method, the molecular weight was Mn: 4232, Mw: 5502, and Mw/Mn: 1.30.

The following peaks were found by NMR measurement performed on the obtained resin under the above measurement conditions, and the resin was confirmed to have a chemical structure of the following formula.

δ (ppm) 9.3-9.7 (2H, O—H), 7.2-8.5 (17H, Ph-H), 6.7-6.9 (1H, C—H)

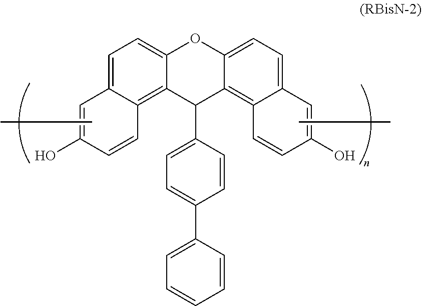

### (Synthesis Example 4-2) Synthesis of RBisN-3

To a container (internal capacity: 500 mL) equipped with a stirrer, a condenser and a burette equipped with an internal pressure control valve, and a gas injection nozzle capable of injecting gas while bubbling the gas into the bottom surface, 50 g (105 mmol) of BisN-2 and 1.8 g (10 mmol) of copper acetate were added, and 100 mL of 1-butanol was added as a solvent, and then a gas diluted with N2 gas to have an oxygen concentration of 5% was injected in a bubbling state at a rate of 500 mL/min while being stirred by a stirrer, and the reaction solution was stirred at 100° C. for 6 hours while controlling the internal pressure to be 0.2 MPa. After cooling, the precipitate was collected by filtration, and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 200 mL of methanol was added to precipitate the reaction product. After cooling to room temperature, the precipitates were separated by filtration. The obtained solid matter was dried to obtain 36.5 g of the objective resin (RBisN-3) having a structure represented by the following formula.

As a result of measuring the molecular weight in terms of polystyrene of the obtained resin by the above method, the molecular weight was Mn: 8795, Mw: 10444, and Mw/Mn: 1.19.

The following peaks were found by NMR measurement performed on the obtained resin under the above measurement conditions, and the resin was confirmed to have a chemical structure of the following formula.

δ (ppm) 9.3-9.7 (2H, O—H), 7.2-8.5 (17H, Ph-H), 6.7-6.9 (1H, C—H)

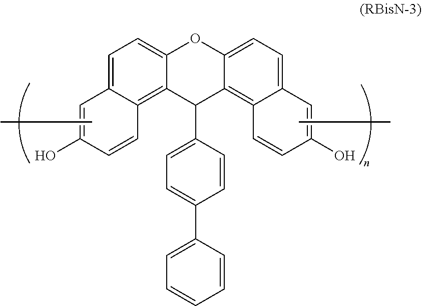

### (Synthesis Example 4-3) Synthesis of RBisN-4

To a container (internal capacity: 500 mL) equipped with a stirrer, a condenser and a burette equipped with an internal pressure control valve, and a gas injection nozzle capable of injecting gas while bubbling the gas into the bottom surface, 50 g (105 mmol) of BisN-2 and 1.1 g (2 mmol) of monobutylcopper phthalate were added, and 100 mL of 1-butanol was added as a solvent, and then a gas diluted with N2 gas to have an oxygen concentration of 5% was injected in a bubbling state at a rate of 50 mL/min while being stirred by a stirrer, and the reaction solution was stirred at 100° C. for 6 hours while controlling the internal pressure control valve so that the internal pressure was 0.5 MPa. After cooling, the precipitate was collected by filtration, and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 200 mL of methanol was added to precipitate the reaction product. After cooling to room temperature, the precipitates were separated by filtration. The obtained solid matter was dried to obtain 37.1 g of the objective resin (RBisN-4) having a structure represented by the following formula.

As a result of measuring the molecular weight in terms of polystyrene of the obtained resin by the above method, the molecular weight was Mn: 9354, Mw: 11298, and Mw/Mn: 1.21.

The following peaks were found by NMR measurement performed on the obtained resin under the above measurement conditions, and the resin was confirmed to have a chemical structure of the following formula.

δ (ppm) 9.3-9.7 (2H, O—H), 7.2-8.5 (17H, Ph-H), 6.7-6.9 (1H, C—H)

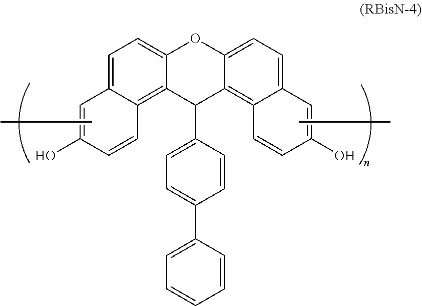

### (Synthesis Example 4A) Synthesis of BisN-5

The same procedure as in Synthesis Example 4 was carried out except that 18.2 g (100 mmol) of 4-biphenylaldehyde (manufactured by Mitsubishi Gas Chemical Company, Inc.) of Synthesis Example 4 was changed to 9.1 g (100 mmol) of 4-tolualdehyde (manufactured by Mitsubishi Gas Chemical Company, Inc.), whereby 23.2 g of the objective compound (BisN-3) represented by the following formula was obtained.

The following peaks were found by 400 MHz-¹H-NMR, and the compound was confirmed to have a chemical structure of the following formula. From the doublets of proton signals at positions 3 and 4, it was confirmed that the substitution position of 2,6-dihydroxynaphthol was position 1.

¹H-NMR: (d-DMSO, Internal standard TMS)

δ (ppm) 9.7 (2H, O—H), 7.2-8.4 (14H, Ph-H), 6.6 (1H, C—H), 1.9 (3H, C—H3)

LC-MS analysis confirmed that the molecular weight was 404.1 corresponding to the following chemical structure.

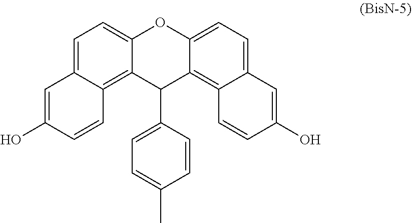 [SMILES: Cc1ccc(C2c3c(ccc4cc(O)ccc34)Oc3ccc4cc(O)ccc4c32)cc1]

### (Synthesis Example 4A-1) Synthesis of RBisN-5

In the same manner as in Synthesis Example 4-1 except that BisN-2 of Synthesis Example 4-1 was changed to BisN-5 obtained in Synthesis Example 4A, 32.1 g of the objective resin (RBisN-5) having a structure represented by the following formula was obtained.

As a result of measuring the molecular weight in terms of polystyrene of the obtained resin by the above method, the molecular weight was Mn: 3452, Mw: 4802, and Mw/Mn: 1.39.

The following peaks were found by NMR measurement performed on the obtained resin under the above measurement conditions, and the resin was confirmed to have a chemical structure of the following formula.

δ (ppm) 9.3-9.7 (2H, O—H), 7.2-8.5 (12H, Ph-H), 6.7-6.9 (1H, C—H), 1.9 (3H, C—H3)

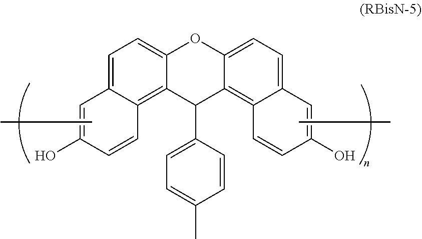

### (Synthesis Example 4B) Synthesis of BisN-6

The same procedure as in Synthesis Example 4 was carried out except that 18.2 g (100 mmol) of 4-biphenylaldehyde (manufactured by Mitsubishi Gas Chemical Company, Inc.) of Synthesis Example 4 was changed to 18.8 g (100 mmol) of 4-cyclohexylbenzaldehyde (manufactured by Mitsubishi Gas Chemical Company, Inc.), whereby 33.5 g of the objective compound (BisN-6) represented by the following formula was obtained.

The following peaks were found by 400 MHz-¹H-NMR, and the compound was confirmed to have a chemical structure of the following formula. From the doublets of proton signals at positions 3 and 4, it was confirmed that the substitution position of 2,6-dihydroxynaphthol was position 1.

¹H-NMR: (d-DMSO, Internal standard TMS)

δ (ppm) 9.7 (2H, O—H), 7.2-8.4 (14H, Ph-H), 6.6 (1H, C—H), 2.5-2.6 (6H, C6-H5)

LC-MS analysis confirmed that the molecular weight was 472.2 corresponding to the following chemical structure.

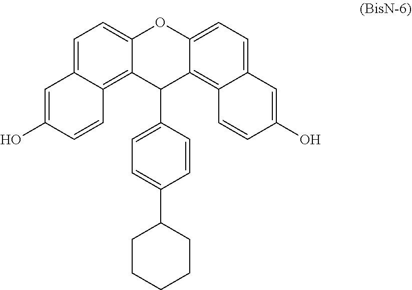 [SMILES: Oc1ccc2c3c(ccc2c1)Oc1ccc2cc(O)ccc2c1C3c1ccc(C2CCCCC2)cc1]

### (Synthesis Example 4B-1) Synthesis of RBisN-6

In the same manner as in Synthesis Example 4-1 except that BisN-2 of Synthesis Example 4-1 was changed to BisN-6 obtained in Synthesis Example 4B, 40.4 g of the objective resin (RBisN-6) having a structure represented by the following formula was obtained.

As a result of measuring the molecular weight in terms of polystyrene of the obtained resin by the above method, the molecular weight was Mn: 3672, Mw: 5080, and Mw/Mn: 1.38.

The following peaks were found by NMR measurement performed on the obtained resin under the above measurement conditions, and the resin was confirmed to have a chemical structure of the following formula.

δ (ppm) 9.3-9.7 (2H, O—H), 7.2-8.5 (12H, Ph-H), 6.7 (1H, C—H), 2.5-2.7 (6H, C6-H5)

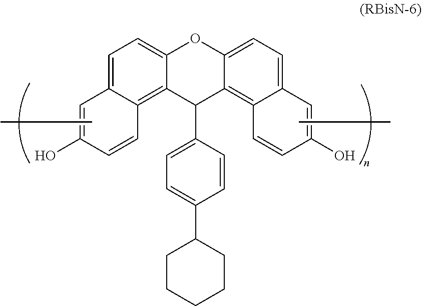

### (Synthesis Example 4C) Synthesis of BisN-7

The same procedure as in Synthesis Example 4 was carried out except that 18.2 g (100 mmol) of 4-biphenylaldehyde (manufactured by Mitsubishi Gas Chemical Company, Inc.) of Synthesis Example 4 was changed to g (100 mmol) of 2-naphthaldehyde (manufactured by Kanto Chemical Co., Ltd.) to synthesize the aromatic hydroxy compound of Synthesis Example 4C. In the same manner as in Synthesis Example 4-1 except that the aromatic hydroxy compound was used, 33.5 g of the objective resin (RBisN-7) represented by the following formula was obtained.

As a result of measuring the molecular weight in terms of polystyrene of the obtained resin by the above method, the molecular weight was Mn: 4174, Mw: 5280, and Mw/Mn: 1.26.

The following peaks were found by 400 MHz-¹H-NMR, and the compound was confirmed to have a chemical structure of the following formula. From the doublets of proton signals at positions 3 and 4, it was confirmed that the substitution position of 2,6-dihydroxynaphthol was position 1.

¹H-NMR: (d-DMSO, Internal standard TMS)

δ (ppm) 9.6 (2H, O—H), 7.0-8.5 (19H, Ph-H), 6.6 (1H, C—H), 2.5H, Ph-H), 6.7 (1H, C—H)

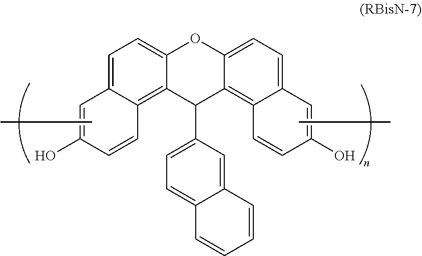

### (Synthesis Example 5) Synthesis of BiF-1

A container (internal capacity: 1 L) equipped with a stirrer, a condenser tube, and a burette was prepared. To this container, 150 g (800 mmol) of 4,4-biphenol (a reagent manufactured by Tokyo Chemical Industry Co., Ltd.), 75 g (410 mmol) of 4-biphenylaldehyde (manufactured by Mitsubishi Gas Chemical Company, Inc.), and 300 mL of propylene glycol monomethyl ether were added, and 19.5 g (105 mmol) of p-toluenesulfonic acid (a reagent manufactured by Kanto Chemical Co., Inc.) was added to prepare a reaction liquid. This reaction liquid was stirred at 90° C. for 3 hours and reacted. Next, the reaction liquid was neutralized with 24% aqueous sodium hydroxide solution. The reaction product was precipitated by the addition of 100 g of distilled water. After cooling to 5° C., the precipitates were separated by filtration. The obtained solid matter by filtration was dried and then separated and purified by column chromatography to obtain 25.8 g of the objective compound (BiF-1) represented by the following formula.

The following peaks were found by 400 MHz-¹H-NMR, and the compound was confirmed to have a chemical structure of the following formula.

¹H-NMR: (d-DMSO, Internal standard TMS)

δ (ppm) 9.4 (4H, O—H), 6.8-7.8 (22H, Ph-H), 6.2 (1H, C—H)

LC-MS analysis confirmed that the molecular weight was 536.2 corresponding to the following chemical structure.

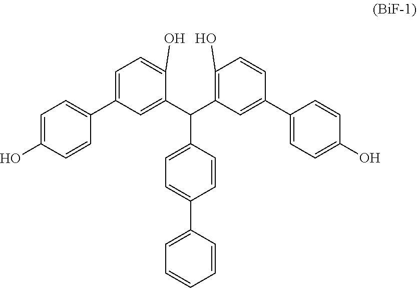 [SMILES: Oc1ccc(-c2ccc(O)c(C(c3ccc(-c4ccccc4)cc3)c3cc(-c4ccc(O)cc4)ccc3O)c2)cc1]

### (Synthesis Example 5-1) Synthesis of RBiF-1

To a container (internal capacity: 500 mL) equipped with a stirrer, a condenser tube, and a burette, 55.0 g (105 mmol) of BiF-1 and 10.1 g (20 mmol) of monobutylcopper phthalate were added, and 100 mL of 1-butanol was added as a solvent. The reaction solution was stirred at 100° C. for 6 hours and reacted. After cooling, the precipitate was filtered and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 200 mL of methanol was added to precipitate the reaction product. After cooling to room temperature, the precipitates were separated by filtration. The obtained solid matter was dried to obtain 34.3 g of the objective resin (RBiF-1) having a structure represented by the following formula.

As a result of measuring the molecular weight in terms of polystyrene of the obtained resin by the above method, the molecular weight was Mn: 4532, Mw: 5698, and Mw/Mn: 1.26.

The following peaks were found by NMR measurement performed on the obtained resin under the above measurement conditions, and the resin was confirmed to have a chemical structure of the following formula.

δ (ppm) 9.4-9.7 (4H, O—H), 6.8-8.1 (20H, Ph-H), 6.3-6.5 (1H, C—H)

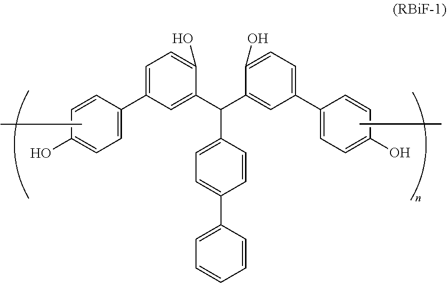

### (Synthesis Example 5-2) Synthesis of RBiF-2

To a container (internal capacity: 500 mL) equipped with a stirrer, a condenser and a burette equipped with an internal pressure control valve, and a gas injection nozzle capable of injecting gas while bubbling the gas into the bottom surface, 55.0 g (105 mmol) of BiF-1 and 1.01 g (2 mmol) of monobutylcopper phthalate were added, and 100 mL of 1-butanol was added as a solvent, and then a gas diluted with N2 gas to have an oxygen concentration of 5% was injected in a bubbling state at a rate of 500 mL/min while being stirred by a stirrer, and the reaction solution was stirred at 100° C. for 6 hours. After cooling, the precipitate was collected by filtration, and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 200 mL of methanol was added to precipitate the reaction product. After cooling to room temperature, the precipitates were separated by filtration. The obtained solid matter was dried to obtain 35.3 g of the objective resin (RBiF-2) having a structure represented by the following formula.

As a result of measuring the molecular weight in terms of polystyrene of the obtained resin by the above method, the molecular weight was Mn: 9249, Mw: 11286, and Mw/Mn: 1.26.

The following peaks were found by NMR measurement performed on the obtained resin under the above measurement conditions, and the resin was confirmed to have a chemical structure of the following formula.

δ (ppm) 9.4-9.7 (4H, O—H), 6.8-8.1 (20H, Ph-H), 6.3-6.5 (1H, C—H)

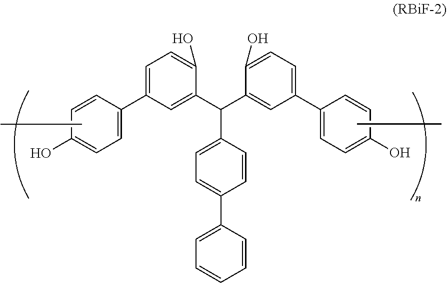

### (Synthesis Example 5A) Synthesis of BiF-3

In the same manner as in Synthesis Example 5 except that 75 g (410 mmol) of 4-biphenylaldehyde (manufactured by Mitsubishi Gas Chemical Company, Inc.) of Synthesis Example 5 was changed to 4-tolualdehyde (manufactured by Mitsubishi Gas Chemical Company, Inc.), 26.3 g of the objective compound (BiF-3) represented by the following formula was obtained.

The following peaks were found by 400 MHz-¹H-NMR, and the compound was confirmed to have a chemical structure of the following formula.

¹H-NMR: (d-DMSO, Internal standard TMS)

δ (ppm) 9.4 (4H, O—H), 6.8-7.8 (18H, Ph-H), 6.2 (1H, C—H), 1.8 (3H, C—H3)

LC-MS analysis confirmed that the molecular weight was 474.5 corresponding to the following chemical structure.

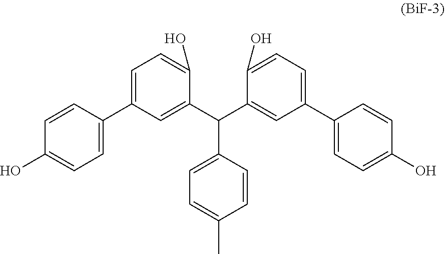 [SMILES: Cc1ccc(C(c2cc(-c3ccc(O)cc3)ccc2O)c2cc(-c3ccc(O)cc3)ccc2O)cc1]

### (Synthesis Example 5A-1) Synthesis of RBiF-3

In the same manner as in Synthesis Example 5-1 except that BiF-1 of Synthesis Example 5-1 was changed to BiF-3 obtained in Synthesis Example 5A, 31.2 g of the objective resin (RBiF-3) having a structure represented by the following formula was obtained.

As a result of measuring the molecular weight in terms of polystyrene of the obtained resin by the above method, the molecular weight was Mn: 4232, Mw: 5288, and Mw/Mn: 1.25.

The following peaks were found by NMR measurement performed on the obtained resin under the above measurement conditions, and the resin was confirmed to have a chemical structure of the following formula.

δ (ppm) 9.4-9.7 (4H, O—H), 6.8-8.1 (16H, Ph-H), 6.3-6.5 (1H, C—H), 1.8-1.9 (3H, C—H3)

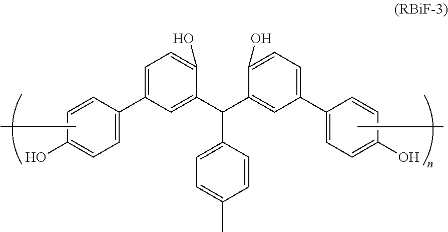

### (Synthesis Example 5B) Synthesis of BiF-4

In the same manner as in Synthesis Example 5 except that 75 g (410 mmol) of 4-biphenylaldehyde (manufactured by Mitsubishi Gas Chemical Company, Inc.) of Synthesis Example 5 was changed to 4-cyclohexylbenzaldehyde (manufactured by Mitsubishi Gas Chemical Company, Inc.), 32.1 g of the objective compound (BiF-4) represented by the following formula was obtained.

The following peaks were found by 400 MHz-¹H-NMR, and the compound was confirmed to have a chemical structure of the following formula.

¹H-NMR: (d-DMSO, Internal standard TMS)

δ (ppm) 9.4 (4H, O—H), 6.8-7.8 (18H, Ph-H), 6.2 (1H, C—H), 2.4-2.6 (10H, C6H10)

LC-MS analysis confirmed that the molecular weight was 542.7 corresponding to the following chemical structure.

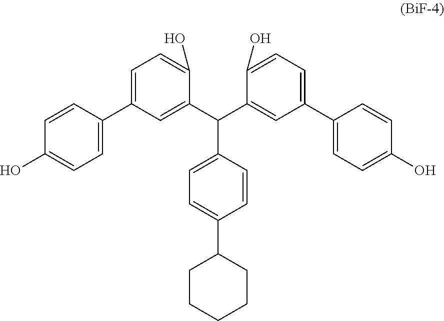 [SMILES: Oc1ccc(-c2ccc(O)c(C(c3ccc(C4CCCCC4)cc3)c3cc(-c4ccc(O)cc4)ccc3O)c2)cc1]

### (Synthesis Example 5B-1) Synthesis of RBiF-4

In the same manner as in Synthesis Example 5-1 except that BiF-1 of Synthesis Example 5-1 was changed to BiF-4 obtained in Synthesis Example 5B, 29.5 g of the objective resin (RBiF-4) having a structure represented by the following formula was obtained.

As a result of measuring the molecular weight in terms of polystyrene of the obtained resin by the above method, the molecular weight was Mn: 4431, Mw: 5568, and Mw/Mn: 1.26.

The following peaks were found by NMR measurement performed on the obtained resin under the above measurement conditions, and the resin was confirmed to have a chemical structure of the following formula.

δ (ppm) 9.4-9.7 (4H, O—H), 6.8-8.1 (16H, Ph-H), 6.3-6.5 (1H, C—H), 2.4-2.9 (10H, C6H10)

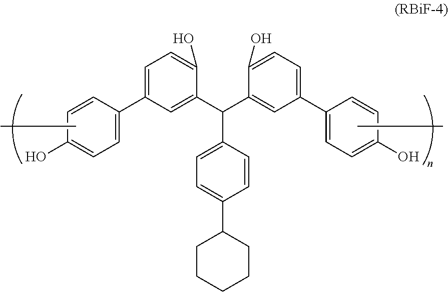

### (Synthesis Example 5C) Synthesis of BiF-5

In the same manner as in Synthesis Example 5, except that 75 g (410 mmol) of 4-biphenylaldehyde (manufactured by Mitsubishi Gas Chemical Company, Inc.) of Synthesis Example 5 was changed to 2-naphthaldehyde (manufactured by Mitsubishi Gas Chemical Company, Inc.), 33.5 g of the objective compound (BiF-5) represented by the following formula was obtained.

The following peaks were found by 400 MHz-¹H-NMR, and the compound was confirmed to have a chemical structure of the following formula.

¹H-NMR: (d-DMSO, Internal standard TMS)

δ (ppm) 9.4 (4H, O—H), 6.8-7.8 (21H, Ph-H), 6.2 (1H, C—H)

LC-MS analysis confirmed that the molecular weight was 510.6 corresponding to the following chemical structure.

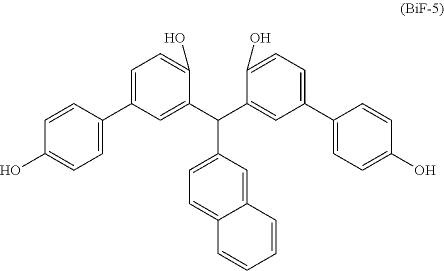 [SMILES: Oc1ccc(-c2ccc(O)c(C(c3ccc4ccccc4c3)c3cc(-c4ccc(O)cc4)ccc3O)c2)cc1]

### (Synthesis Example 5C-1) Synthesis of RBiF-5

In the same manner as in Synthesis Example 5-1 except that BiF-1 of Synthesis Example 5-1 was changed to BiF-5 obtained in Synthesis Example 5C, 29.5 g of the objective resin (RBiF-4) having a structure represented by the following formula was obtained.

As a result of measuring the molecular weight in terms of polystyrene of the obtained resin by the above method, the molecular weight was Mn: 4133, Mw: 5462, and Mw/Mn: 1.32.

The following peaks were found by NMR measurement performed on the obtained resin under the above measurement conditions, and the resin was confirmed to have a chemical structure of the following formula.

δ (ppm) 9.4-9.7 (4H, O—H), 6.8-8.1 (19H, Ph-H), 6.3-6.5 (1H, C—H)

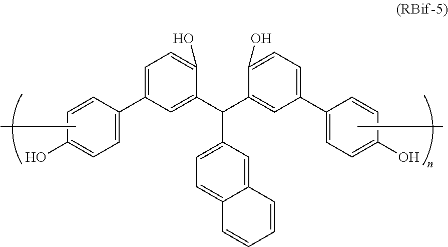

### (Synthesis Example 6) Synthesis of DB-1

### (a) Production of Calcium Dibenzochrysene Sulfonate

Into a four-necked flask (capacity: 1 L) equipped with a mechanical stirrer, 20 g of dibenzo[g, p]chrysene (0.06 mol, HPLC purity: 99.8%) and 200 g (1.94 mol) of 95% sulfuric acid (manufactured by Wako Pure Chemical Industries, Ltd.) were added. The reaction was carried out with stirring at an internal temperature of 80° C. for 2 hours while keeping the temperature in a hot water bath. As a result, the content became a uniform gray viscous liquid.

While cooling the flask containing the contents obtained above in an ice bath, 400 g of distilled water was added. At the time of the addition, the addition was carried out while maintaining an internal temperature of 40° C. or lower while measuring the temperature so that the internal temperature does not exceed 40° C. due to heat generation. Then, 154.4 g (2.08 mol) of powdered calcium hydroxide (manufactured by Wako Pure Chemical Industries, Ltd.) was added to the flask to which the distilled water was added. At the time of the addition, the addition was carried out while maintaining an internal temperature of 45° C. or lower while measuring the temperature so that the internal temperature does not exceed 45° C. due to heat generation. By this addition, calcium sulfate was precipitated as a white solid, and the content became a slurry. Moreover, the liquid property was alkaline.

The slurry thus obtained was subjected to suction filtration using a stainless buchner funnel and No. 2 filter paper, and the resulting filtrate (pale yellow liquid) was collected. Further, the solid content residue (mainly calcium sulfate) was washed with 350 g of distilled water, and the washing liquid was also collected and concentrated under reduced pressure using a rotary evaporator together with the above filtrate. As a result, 36.5 g of calcium dibenzochrysene sulfonate was obtained as a pale yellow powdery solid (yield: 82.7%). The calcium dibenzochrysene sulfonate is considered to be a mixture in which 98% is a 4-substituted dibenzochrysene sulfonate and the balance is a 3-substituted dibenzochrysene sulfonate from the result of LC/MS analysis of hydroxydibenzochrysene described later.

### (b) Production of Hydroxydibenzochrysene

Into a cylindrical container made of nickel having a volume of 100 mL, 14.0 g (0.212 mol) of 85% potassium hydroxide granules (manufactured by Wako Pure Chemical Industries, Ltd.) was put, and hot-melted on a hot plate (400° C.). Subsequently, 4.0 g (0.0055 mol) of the calcium dibenzochrysene sulfonate obtained above (mixture 8) was added. At the time of this addition, the calcium dibenzochrysene sulfonate was charged into the above nickel cylindrical container over 30 minutes, and the reaction was promoted by stirring with a stainless steel spoon at the time of charging. Further, stirring was continued for 30 minutes after the addition of the calcium dibenzochrysene sulfonate was completed. As a result, a reddish-brown viscous liquid was obtained.

The reddish-brown viscous liquid obtained above (the contents of the nickel cylindrical container) was poured into a stainless steel cup having a volume of 200 mL while hot and allowed to cool and solidify. Subsequently, 40 g of distilled water was added to the stainless steel cup to dissolve the solid matter in water to obtain a reddish-brown, slightly cloudy liquid.

Then, the reddish-brown liquid was transferred to a glass beaker having a volume of 200 mL, and while stirring using a magnetic stirrer, 35% hydrochloric acid (Wako Pure Chemical Industries, Ltd.) was added to obtain contents containing brown solid. At the time of this addition, the addition was continued until the pH of the contents reached pH 3 while measuring the pH with a pH meter. The above brown solid was confirmed to be precipitated at the time of neutralization.

Then, 30 g of ethyl acetate (Wako Pure Chemical Industries, Ltd.) was added to the contents obtained so far and stirred to dissolve the brown solid. Then, the obtained liquid was allowed to stand still to be separated into an organic phase and an aqueous phase, and then the organic phase was separated. The separated organic layer was filtered through a glass funnel and No. 2 filter paper to remove insoluble matter, and then concentrated under reduced pressure using a rotary evaporator to obtain 1.6 g of a brown powdery solid (yield: 73.9%). As a result of subjecting the brown powdery solid obtained by the above operation to LC/MS analysis, the brown powdery solid was 4-substituted hydroxydibenzochrysene having a purity of 98%.

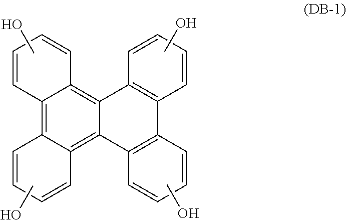

### (Synthesis Example 6-1) Synthesis of RDB-1

To a container (internal capacity: 500 mL) equipped with a stirrer, a condenser tube, and a burette, 80.0 g of DB-1 and 10.1 g (20 mmol) of monobutylcopper phthalate were added, and 100 mL of 1-butanol was added as a solvent. The reaction solution was stirred at 100° C. for 6 hours and reacted. After cooling, the precipitate was filtered and the resulting crude was dissolved in 100 mL of ethyl acetate. Next, 5 mL of hydrochloric acid was added, and the mixture was stirred at room temperature, and neutralized with sodium hydrogen carbonate. The ethyl acetate solution was concentrated and 300 mL of heptane was added to precipitate the reaction product. After cooling to room temperature, the precipitates were separated by filtration. The obtained solid matter was dried to obtain 64.5 g of the objective resin (RDB-1) having a structure represented by the group represented by the following formula.

As a result of measuring the molecular weight in terms of polystyrene of the obtained resin by the above method, the molecular weight was Mn: 2512, Mw: 3298, and Mw/Mn: 1.31.

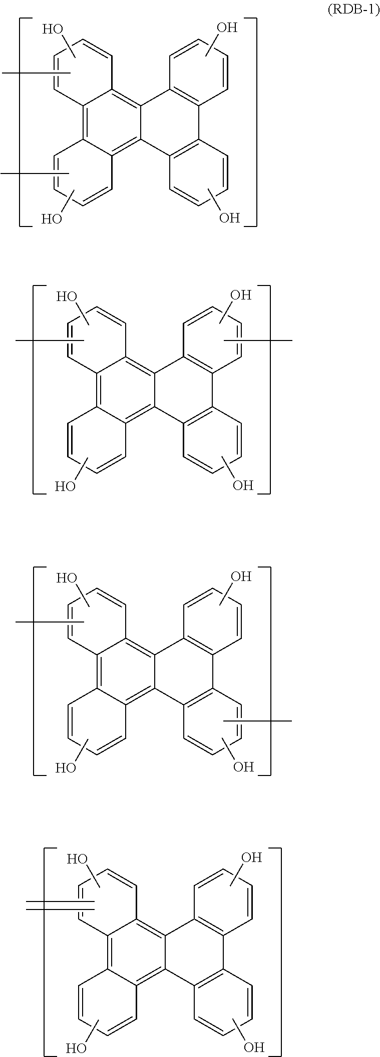

### (Synthesis Example 1-A1) Synthesis of R-DHN-A1

Except that instead of 2,6-dihydroxynaphthalene, 15.1 g (105 mmol) of 2-hydroxynaphthalene (reagents manufactured by Kanto Chemical Co., Inc.) was used in the method for synthesizing R-DHN in Synthesis Example 1, 21.5 g of the objective resin (R-DHN-A1) having a structure represented by the following formula was obtained by the same method as in Synthesis Example 1.

As a result of measuring the molecular weight in terms of polystyrene of the obtained resin by the above method, the molecular weight was Mn: 4567, Mw: 5612, and Mw/Mn: 1.23.

The following peaks were found by NMR measurement performed on the obtained resin under the above measurement conditions, and the resin was confirmed to have a chemical structure of the following formula.

δ (ppm) 9.7-9.8 (2H, O—H), 7.0-7.9 (4H, Ph-H)

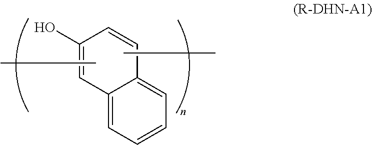

### (Synthesis Example 1-A2) Synthesis of R-DHN-A2

Except that instead of 2,6-dihydroxynaphthalene, 15.1 g (105 mmol) of 1-hydroxynaphthalene (reagents manufactured by Kanto Chemical Co., Inc.) was used in the method for synthesizing R-DHN in Synthesis Example 1, 21.5 g of the objective resin (R-DHN-A2) having a structure represented by the following formula was obtained by the same method as in Synthesis Example 1.

As a result of measuring the molecular weight in terms of polystyrene of the obtained resin by the above method, the molecular weight was Mn: 6137, Mw: 7622, and Mw/Mn: 1.24.

The following peaks were found by NMR measurement performed on the obtained resin under the above measurement conditions, and the resin was confirmed to have a chemical structure of the following formula.

δ (ppm) 9.7-9.8 (2H, O—H), 7.0-7.9 (4H, Ph-H)

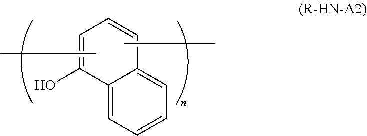

### (Synthesis Example 1-B1) Synthesis of R-DHN-B1

Except that instead of 2,6-dihydroxynaphthalene, 5.6 g (35 mmol) of 2,3-dihydroxynaphthalene (reagent manufactured by Kanto Chemical Co., Inc.), 5.6 g (35 mmol) of 2,6-dihydroxynaphthalene (reagent manufactured by Kanto Chemical Co., Inc.), and 5.6 g (35 mmol) of 1,5-dihydroxynaphthalene (reagent manufactured by Kanto Chemical Co., Inc.) were used in the method for synthesizing R-DHN in Synthesis Example 1, 20.4 g of the objective resin (R-DHN-B1) having a structure represented by the following formula was obtained in the same manner as in Synthesis Example 1.

As a result of measuring the molecular weight in terms of polystyrene of the obtained resin by the above method, the molecular weight was Mn: 7179, Mw: 9541, and Mw/Mn: 1.34. Further, the obtained resin was subjected to C13-NMR measurement, and it was confirmed that the composition ratio was a:b:c=1:1:1.

The following peaks were found by NMR measurement performed on the obtained resin under the above measurement conditions, and the resin was confirmed to have a chemical structure of the following formula.

δ (ppm) 9.7-9.8 (2H, O—H), 7.0-7.9 (4H, Ph-H)

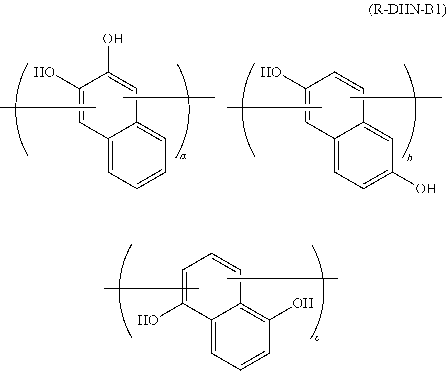

### (Synthesis Example 1-B2) Synthesis of R-DHN-B2

Except that instead of 2,6-dihydroxynaphthalene, 5.6 g (35 mmol) of 2,3-dihydroxynaphthalene (reagent manufactured by Kanto Chemical Co., Inc.), 5.6 g (35 mmol) of 2,6-dihydroxynaphthalene (reagent manufactured by Kanto Chemical Co., Inc.), and 5.1 g (35 mmol) of 2-hydroxynaphthalene (reagent manufactured by Kanto Chemical Co., Inc.) were used in the method for synthesizing R-DHN in Synthesis Example 1, 18.8 g of the objective resin (R-DHN-B2) having a structure represented by the following formula was obtained in the same manner as in Synthesis Example 1.

As a result of measuring the molecular weight in terms of polystyrene of the obtained resin by the above method, the molecular weight was Mn: 6912, Mw: 8533, and Mw/Mn: 1.23.

Further, the obtained resin was subjected to C13-NMR measurement, and it was confirmed that the composition ratio was a:b:c=1:1:1.

The following peaks were found by NMR measurement performed on the obtained resin under the above measurement conditions, and the resin was confirmed to have a chemical structure of the following formula.

δ (ppm) 9.7-9.8 (2H, O—H), 7.0-7.9 (4H, Ph-H)

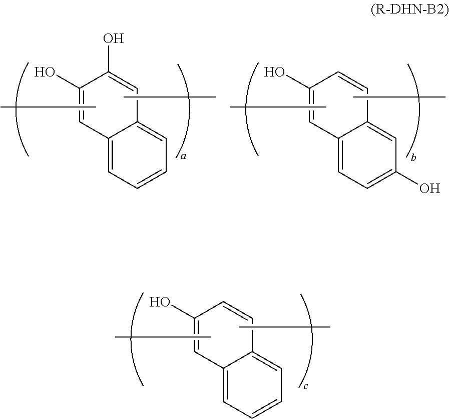

### Comparative Synthesis Example 1

To a container (internal capacity: 100 ml) equipped with a stirrer, a condenser tube, and a burette, 10 g (21 mmol) of BisN-2, 0.7 g (42 mmol) of paraformaldehyde, 50 mL of glacial acetic acid, and 50 mL of PGME were added, and 8 mL of 95% sulfuric acid was added thereto. The reaction solution was stirred at 100° C. for 6 hours and reacted. Next, the reaction solution was concentrated and 1000 mL of methanol was added to precipitate the reaction product. After cooling to room temperature, the precipitates were separated by filtration. The obtained solid material was filtered and dried to obtain 7.2 g of the objective resin (NBisN-2) having a structure represented by the following formula.

As a result of measuring the molecular weight in terms of polystyrene of the obtained resin by the above method, the molecular weight was Mn: 778, Mw: 1793, and Mw/Mn: 2.30.

The following peaks were found by NMR measurement performed on the obtained resin under the above measurement conditions, and the resin was confirmed to have a chemical structure of the following formula.

δ (ppm) 9.7 (2H, O—H), 7.2-8.5 (17H, Ph-H), 6.6 (1H, C—H), 4.1 (2H, —CH2)

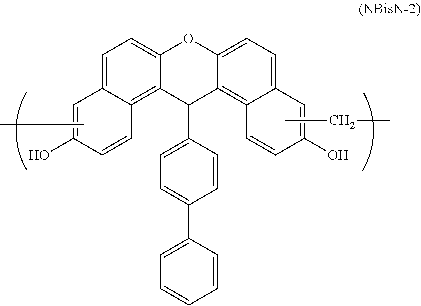

### Examples 1 to 6

Table 1 shows the results of evaluating the heat resistance by the evaluation methods shown below using the resins obtained in Synthesis Examples 1 to 6-1 and Comparative Synthesis Example 1.

### <Measurement of Thermal Decomposition Temperature>

EXSTAR 6000 TG/DTA apparatus manufactured by SII NanoTechnology Inc. was used. About 5 mg of a sample was placed in an unsealed container made of aluminum, and the temperature was raised to 700° C. at a temperature increase rate of 10° C./min in a nitrogen gas stream (30 mL/min). The temperature at which a heat loss of 5% by weight was observed was defined as the thermal decomposition temperature (Tg), and the heat resistance was evaluated according to the following criteria.

Evaluation A: The thermal decomposition temperature was 450° C. or higher

Evaluation B: The thermal decomposition temperature was 300° C. or higher

Evaluation C: The thermal decomposition temperature was lower than 300° C.

TABLE 1

| | | | Heat resistance | |
|---|---|---|---|---|
| | Resin | | evaluation | |
| Example 1 | Synthesis Example | R-DHN | A | 460° C. |
| | 1 | | | |
| Example 1-2 | Synthesis Example | R-2,7DHN | A | 450° C. |
| | 1-2 | | | |
| Example 1-3 | Synthesis Example | R-2,3DHN | A | 455° C. |
| | 1-3 | | | |
| Example 1-4 | Synthesis Example | R-1,5DHN | A | 455° C. |
| | 1-4 | | | |
| Example 1-5 | Synthesis Example | R-1,6DHN | A | 450° C. |
| | 1-5 | | | |
| Example 1-6 | Synthesis Example | R-FLBNDHN | A | 460° C. |
| | 1-6 | | | |
| Example 1-7 | Synthesis Example | R-DHN-A1 | A | 460° C. |
| | 1-A1 | | | |
| Example 1-8 | Synthesis Example | R-DHN-A2 | A | 460° C. |
| | 1-A2 | | | |
| Example 1-9 | Synthesis Example | R-DHN-B1 | A | 455° C. |
| | 1-B1 | | | |
| Example 1-10 | Synthesis Example | R-DHN-B2 | A | 450° C. |
| | 1-B2 | | | |
| Example 2 | Synthesis Example | R-BiF | A | 490° C. |
| | 2 | | | |
| Example 3 | Synthesis Example | RBisN-1 | A | 490° C. |
| | 3-1 | | | |
| Example 4-1 | Synthesis Example | RBisN-2 | A | 490° C. |
| | 4-1 | | | |
| Example 4-2 | Synthesis Example | RBisN-3 | A | 490° C. |
| | 4-2 | | | |
| Example 4-3 | Synthesis Example | RBisN-4 | A | 490° C. |
| | 4-3 | | | |
| Example 4-4 | Synthesis Example | RBisN-5 | A | 490° C. |
| | 4A-1 | | | |
| Example 4-5 | Synthesis Example | RBisN-6 | A | 490° C. |
| | 4B-1 | | | |
| Example 4-6 | Synthesis Example | RBisN-7 | A | 500° C. |
| | 4C-1 | | | |
| Example 5-1 | Synthesis Example | RBiF-1 | A | 480° C. |
| | 5-1 | | | |
| Example 5-2 | Synthesis Example | RBiF-2 | A | 490° C. |
| | 5-2 | | | |
| Example 5-3 | Synthesis Example | RBiF-3 | A | 490° C. |
| | 5A-1 | | | |
| Example 5-4 | Synthesis Example | RBiF-4 | A | 480° C. |
| | 5B-1 | | | |
| Example 5-5 | Synthesis Example | RBiF-5 | A | 500° C. |
| | 5C-1 | | | |
| Example 6 | Synthesis Example | RDB-1 | A | 480° C. |
| | 6-6 | | | |
| Comparative | Comparative | NBisN-2 | B | 310° C. |
| Example 1-1 | Synthesis Example | | | |
| | 1 | | | |

As is evident from Table 1, it was able to be confirmed that the resins used in Examples 1 to 6 have good heat resistance whereas the resin used in Comparative Example 1 is inferior in heat resistance. In particular, it was confirmed that the resins used in Examples 2 to 6 exhibited remarkably good heat resistance.

### Examples 7 to 12 and Comparative Example 2

### (Preparation of Composition for Underlayer Film Formation for Lithography)

Compositions for underlayer film formation for lithography were prepared according to the composition shown in Table 2. Next, a silicon substrate was spin coated with each of these compositions for underlayer film formation for lithography, and then baked at 240° C. for 60 seconds and further at 400° C. for 120 seconds under a nitrogen atmosphere to prepare each underlayer film with a film thickness of 200 to 250 nm.

Next, etching test was conducted under conditions shown below to evaluate etching resistance. The evaluation results are shown in Table 2.

### [Etching Test]

Etching apparatus: RIE-10NR manufactured by Samco International, Inc.

Output: 50 W

Pressure: 20 Pa

Time: 2 min

Etching gas

Ar gas flow rate:CF₄ gas flow rate:O₂ gas flow rate=50:5:5 (sccm)

### (Evaluation of Etching Resistance)

The evaluation of etching resistance was conducted by the following procedures. First, an underlayer film of novolac was prepared under the same conditions as described above except that novolac (PSM4357 manufactured by Gunei Chemical Industry Co., Ltd.) was used. This underlayer film of novolac was subjected to the above etching test, and the etching rate was measured.

Next, underlayer films of Examples 7 to 12 and Comparative Example 2 were prepared under the same conditions as the novolac underlayer films and subjected to the etching test described above in the same way as above, and the etching rate was measured. The etching resistance was evaluated according to the following evaluation criteria on the basis of the etching rate of the underlayer film of novolac.

[Evaluation Criteria]

A: The etching rate was less than −20% as compared with the underlayer film of novolac.

B: The etching rate was −20% to 0% as compared with the underlayer film of novolac.

C: The etching rate was more than +0% as compared with the underlayer film of novolac.

TABLE 2

| | | | Solvent | | |
|---|---|---|---|---|---|
| | Resin (parts | | (parts | Etching | Etching |
| | by mass) | | by mass) | evaluation | rate |
| Example 7 | Synthesis | R-DHN | Cyclo- | A | 0.78 |
| | Example | (10) | hexanone | | |
| | 1 | | (90) | | |
| Example 8 | Synthesis | R-BiF | PGMEA | A | 0.79 |
| | Example | (10) | (90) | | |
| | 2 | | | | |
| Example 9 | Synthesis | RBisN-1 | PGMEA | A | 0.75 |
| | Example | (10) | (90) | | |
| | 3-1 | | | | |
| Example 10 | Synthesis | RBisN-2 | PGMEA | A | 0.74 |
| | Example | (10) | (90) | | |
| | 4-1 | | | | |
| Example 11 | Synthesis | RBiF-1 | PGMEA | A | 0.75 |
| | Example | (10) | (90) | | |
| | 5-1 | | | | |
| Example 12 | Synthesis | RDB-1 | PGMEA | A | 0.74 |
| | Example | (10) | (90) | | |
| | 6-1 | | | | |
| Comparative | Comparative | NBisN-2 | PGMEA | B | 0.98 |
| Example 2 | Synthesis | (10) | (90) | | |
| | Example | | | | |
| | 1 | | | | |

It was found that an excellent etching rate is exerted in Examples 7 to 12 as compared with the underlayer film of novolac and the resin of Comparative Example 2. On the other hand, it was found that an etching rate is poor in the resin of Comparative Example 2 as compared with the underlayer film of novolac.

The metal content before and after purification of polycyclic polyphenolic resin (composition containing the polycyclic polyphenolic resin) and the storage stability of the solution were evaluated by the following method.

### (Measurement of Various Metal Contents)

The metal contents of the propylene glycol monomethyl ether acetate (PGMEA) solutions of various resins obtained in the following Examples and Comparative Examples were measured using ICP-MS under the following measurement conditions.

Apparatus: AG8900 manufactured by Agilent Technologies

Temperature: 25° C.

Environment: Class 100 clean room

### (Evaluation of Storage Stability)

The PGMEA solutions obtained in the following Examples and Comparative Examples were retained at 23° C. for 240 hours, and then the turbidity (HAZE) of the solutions was measured using a color difference/turbidity meter to evaluate the storage stability of the solutions according to the following criteria.

Apparatus: Color difference/turbidity meter COH400 (manufactured by Nippon Denshoku Industries Co., Ltd.)

Optical path length: 1 cm

Quartz cell use

### [Evaluation Criteria]

0≤HAZE≤1.0: Good

1.0<HAZE≤2.0: Fair

2.0<HAZE: Poor

### (Example 13) Purification of R-DHN with Acid

In a four necked flask (capacity: 1000 mL, with a detachable bottom), 150 g of a solution (10% by mass) formed by dissolving R-DHN obtained in Synthesis Example 1 in PGMEA was charged, and was heated to 80° C. with stirring. Then, 37.5 g of an aqueous oxalic acid solution (pH 1.3) was added thereto, and the resultant mixture was stirred for 5 minutes and then left to stand still for 30 minutes. This separated the mixture into an oil phase and an aqueous phase, and the aqueous phase was thus removed. After repeating this operation once, 37.5 g of ultrapure water was charged to the obtained oil phase, and after stirring for 5 minutes, the mixture was left to stand still for 30 minutes and the aqueous phase was removed. After repeating this operation three times, the residual water and PGMEA were concentrated and removed by heating to 80° C. and reducing the pressure in the flask to 200 hPa or less. Thereafter, by diluting with PGMEA of EL grade (a reagent manufactured by Kanto Chemical Co., Inc.) such that the concentration of the PGMEA solution was adjusted to 10% by mass, a PGMEA solution of R-DHN with a reduced metal content was obtained.

### (Reference Example 1) Purification of R-DHN with Ultrapure Water

In the same manner as of Example 13 except that ultrapure water was used instead of the aqueous oxalic acid solution, and by adjusting the concentration to 10% by mass, a PGMEA solution of R-DHN was obtained.

For the 10 mass % R-DHN solution in PGMEA before the treatment, and the solutions obtained in Example 13 and Reference Example 1, the contents of various metals were measured by ICP-MS. The measurement results are shown in Table 3.

### (Example 14) Purification of RBisN-2 with Acid

In a four necked flask (capacity: 1000 mL, with a detachable bottom), 140 g of a solution (10% by mass) formed by dissolving RBisN-2 obtained in Synthesis Example 4-1 in PGMEA was charged, and was heated to 60° C. with stirring. Then, 37.5 g of an aqueous oxalic acid solution (pH 1.3) was added thereto, and the resultant mixture was stirred for 5 minutes and then left to stand still for 30 minutes. This separated the mixture into an oil phase and an aqueous phase, and the aqueous phase was thus removed. After repeating this operation once, 37.5 g of ultrapure water was charged to the obtained oil phase, and after stirring for 5 minutes, the mixture was left to stand still for 30 minutes and the aqueous phase was removed. After repeating this operation three times, the residual water and PGMEA were concentrated and removed by heating to 80° C. and reducing the pressure in the flask to 200 hPa or less. Thereafter, by diluting with PGMEA of EL grade (reagent manufactured by Kanto Chemical Co., Inc.) such that the concentration of the PGMEA solution was adjusted to 10% by mass, a PGMEA solution of RBisN-2 with a reduced metal content was obtained.

### (Reference Example 2) Purification of RBisN-2 with Ultrapure Water

In the same manner as of Example 14 except that ultrapure water was used instead of the aqueous oxalic acid solution, and by adjusting the concentration to 10% by mass, a PGMEA solution of RBisN-2 was obtained.

For the 10 mass % RBisN-2 solution in PGMEA before the treatment, and the solutions obtained in Example 14 and Reference Example 2, the contents of various metals were measured by ICP-MS. The measurement results are shown in Table 3.

### (Example 15) Purification by Filter Passage

In a class 1000 clean booth, 500 g of a solution of 10% by mass concentration of the resin (R-DHN) obtained in Synthesis Example 1 dissolved in propylene glycol monomethyl ether (PGME) was prepared in a four necked flask (capacity: 1000 mL, with a detachable bottom), and then the air inside the flask was depressurized and removed, nitrogen gas was introduced to return it to atmospheric pressure, and the oxygen concentration inside was adjusted to less than 1% under the ventilation of 100 mL of nitrogen gas per minute, and the flask was heated to 30° C. with stirring. The solution was drawn out from the bottom-vent valve, passed through a pressure tube made of fluororesin through a diaphragm pump at a flow rate of 100 mL per minute to a hollow fiber membrane filter (KITZ MICRO FILTER CORPORATION, product name: Polyfix Nylon Series) made of nylon with a nominal pore size of 0.01 μm. The contents of various metals in the obtained R-DHN solution were measured by ICP-MS. The oxygen concentration was measured with an oxygen concentration meter “OM-25MF10” manufactured by AS ONE Corporation (the same applies hereinafter). The measurement results are shown in Table 3.

### Example 16

The solution was passed through in the same manner as in Example 15 except that a hollow fiber membrane filter (KITZ MICRO FILTER CORPORATION, product name: Polyfix) made of polyethylene (PE) with a nominal pore size of 0.01 μm was used, and the contents of various metals in the obtained R-DHN solution were measured by ICP-MS. The measurement results are shown in Table 3.

### Example 17

The solution was passed through in the same manner as in Example 15 except that a hollow fiber membrane filter (KITZ MICRO FILTER CORPORATION, product name: Polyfix) made of nylon with a nominal pore size of 0.04 μm was used, and the contents of various metals in the obtained R-DHN were measured by ICP-MS. The measurement results are shown in Table 3.

### Example 18

The solution was passed through in the same manner as in Example 15 except that a Zeta Plus filter 40QSH (manufactured by 3M Company, having an ion exchange capacity) with a nominal pore size of 0.2 μm was used, and the contents of various metals in the obtained R-DHN solution were measured by ICP-MS. The measurement results are shown in Table 3.

### Example 19

The solution was passed through in the same manner as in Example 15 except that a Zeta Plus filter 020GN (manufactured by 3M Company, having an ion exchange capacity, and having different filtration areas and filter material thicknesses from those of Zeta Plus filter 40QSH) with a nominal pore size of 0.2 μm was used, and the obtained R-DHN solutions were analyzed under the following conditions. The measurement results are shown in Table 3.

### Example 20

The solution was passed through in the same manner as in Example 15 except that the resin (RBisN-2) obtained in Synthesis Example 4-1 was used instead of the resin (R-DHN) in Example 15, and the contents of various metals in the obtained RBisN-2 solutions were measured by ICP-MS. The measurement results are shown in Table 3.

### Example 21

The solution was passed through in the same manner as in Example 16 except that the resin (RBisN-2) obtained in Synthesis Example 4-1 was used instead of the resin (R-DHN) in Example 16, and the contents of various metals in the obtained RBisN-2 solutions were measured by ICP-MS. The measurement results are shown in Table 3.

### Example 22

The solution was passed through in the same manner as in Example 17 except that the resin (RBisN-2) obtained in Synthesis Example 4-1 was used instead of the compound (R-DHN) in Example 17, and the contents of various metals in the obtained RBisN-2 solutions were measured by ICP-MS. The measurement results are shown in Table 3.

### Example 23

The solution was passed through in the same manner as in Example 18 except that the resin (RBisN-2) obtained in Synthesis Example 4-1 was used instead of the compound (R-DHN) in Example 18, and the contents of various metals in the obtained RBisN-2 solutions were measured by ICP-MS. The measurement results are shown in Table 3.

### Example 24

The solution was passed through in the same manner as in Example 19 except that the resin (RBisN-2) obtained in Synthesis Example 4-1 was used instead of the compound (R-DHN) in Example 19, and the contents of various metals in the obtained RBisN-2 solutions were measured by ICP-MS. The measurement results are shown in Table 3.

### (Example 25) Combination of Acid Washing and Filter Passage 1

In a class 1000 clean booth, 140 g of the 10 mass % PGMEA solution of R-DHN with a reduced metal content obtained by Example 13 was prepared in a four necked flask (capacity: 300 mL, with a detachable bottom), and then the air inside the flask was depressurized and removed, nitrogen gas was introduced to return it to atmospheric pressure, and the oxygen concentration inside was adjusted to less than 1% under the ventilation of 100 mL of nitrogen gas per minute, and the flask was heated to 30° C. with stirring. The solution was drawn out from the bottom-vent valve, passed through a pressure tube made of fluororesin through a diaphragm pump at a flow rate of 10 mL per minute to an ion exchange filter (manufactured by Nihon Pall Ltd., product name: IonKleen Series) with a nominal pore size of 0.01 μm. The collected solution was then returned to the four necked flask (capacity: 300 mL), and the filter was changed to a filter made of high-density PE with a nominal diameter of 1 nm (manufactured by Entegris Japan Co., Ltd.), and pumped through the flask in the same manner. The contents of various metals in the obtained R-DHN solution were measured by ICP-MS. The oxygen concentration was measured with an oxygen concentration meter “OM-25MF10” manufactured by AS ONE Corporation (the same applies hereinafter). The measurement results are shown in Table 3.

### (Example 26) Combination of Acid Washing and Filter Passage 2

In a class 1000 clean booth, 140 g of the 10 mass % PGMEA solution of R-DHN with a reduced metal content obtained by Example 13 was prepared in a four necked flask (capacity: 300 mL, with a detachable bottom), and then the air inside the flask was depressurized and removed, nitrogen gas was introduced to return it to atmospheric pressure, and the oxygen concentration inside was adjusted to less than 1% under the ventilation of 100 mL of nitrogen gas per minute, and the flask was heated to 30° C. with stirring. The solution was drawn out from the bottom-vent valve, passed through a pressure tube made of fluororesin through a diaphragm pump at a flow rate of 10 mL per minute to a hollow fiber membrane filter (KITZ MICRO FILTER CORPORATION, product name: Polyfix) made of nylon with a nominal pore size of 0.01 μm. The collected solution was then returned to the four necked flask (capacity: 300 mL), and the filter was changed to a filter made of high-density PE with a nominal diameter of 1 nm (manufactured by Entegris Japan Co., Ltd.), and pumped through the flask in the same manner. The contents of various metals in the obtained R-DHN solution were measured by ICP-MS. The oxygen concentration was measured with an oxygen concentration meter “OM-25MF10” manufactured by AS ONE Corporation (the same applies hereinafter). The measurement results are shown in Table 3.

### (Example 27) Combination of Acid Washing and Filter Passage 3

The same procedure as in Example 25 was carried out except that the 10 mass % PGMEA solution of R-DHN used in Example 25 was changed to the 10 mass % PGMEA solution of RBisN-2 obtained by Example 14 to collect a 10 mass % PGMEA solution of RBisN-2 with a reduced metal amount. The contents of various metals in the obtained solution were measured by ICP-MS. The oxygen concentration was measured with an oxygen concentration meter “OM-25MF10” manufactured by AS ONE Corporation (the same applies hereinafter). The measurement results are shown in Table 3.

### (Example 28) Combination of Acid Washing and Filter Passage 4

The same procedure as in Example 26 was carried out except that the 10 mass % PGMEA solution of R-DHN used in Example 26 was changed to the 10 mass % PGMEA solution of RBisN-2 obtained by Example 14 to collect a 10 mass % PGMEA solution of RBisN-2 with a reduced metal amount. The contents of various metals in the obtained solution were measured by ICP-MS. The oxygen concentration was measured with an oxygen concentration meter “OM-25MF10” manufactured by AS ONE Corporation (the same applies hereinafter). The measurement results are shown in Table 3.

TABLE 3

| | Purification | Metal amount (ppb) | | | | Storage |
|---|---|---|---|---|---|---|
| | method | Cr | Fe | Cu | Zn | stability |
| R-DHN before | — | 122 | 470 | 935 | 106 | poor |
| treatment | | | | | | |
| Example 13 | acid washing | 36 | 21 | 76 | 11 | good |
| Example 15 | hollow nylon filter | 6 | 8 | 22 | 16 | good |
| Example 16 | PE filter | 100 | 110 | 260 | 94 | fair |
| Example 17 | hollow nylon filter | 15 | 13 | 30 | 12 | good |
| Example 18 | zeta potential filter | 16 | 13 | 28 | 9 | good |
| Example 19 | zeta potential filter | 12 | 20 | 31 | 13 | good |
| Example 25 | acid washing/ion | <0.1 | <0.1 | <0.1 | <0.1 | good |
| | exchange filter/PE | | | | | |
| | filter combination | | | | | |
| Example 26 | acid washing/hollow | <0.1 | <0.1 | <0.1 | <0.1 | good |
| | nylon filter/PE filter | | | | | |
| | combination | | | | | |
| Reference | water washing | 103 | 312 | 643 | 98 | poor |
| Example 1 | | | | | | |
| RBisN-2 before | — | 113 | 364 | 855 | 205 | poor |
| treatment | | | | | | |
| Example 14 | acid washing | 24 | 21 | 56 | 13 | good |
| Example 20 | hollow nylon filter | 10 | 7 | 34 | 11 | good |
| Example 21 | PE filter | 97 | 150 | 360 | 135 | fair |
| Example 22 | hollow nylon filter | 12 | 13 | 38 | 10 | good |
| Example 23 | zeta potential filter | 14 | 22 | 26 | 6 | good |
| Example 24 | zeta potential filter | 1.0 | >99 | 2 | 98 | good |
| Example 27 | acid washing/ion | <0.1 | <0.1 | <0.1 | <0.1 | good |
| | exchange filter/PE | | | | | |
| | filter combination | | | | | |
| Example 28 | acid washing/hollow | <0.1 | <0.1 | <0.1 | <0.1 | good |
| | nylon filter/PE filter | | | | | |
| | combination | | | | | |
| Reference | water washing | 95 | 244 | 533 | 190 | poor |
| Example 2 | | | | | | |

As shown in Table 3, it was confirmed that the storage stability of the resin solutions according to the present embodiment was improved by reducing the metal derived from the oxidizing agent through various purification methods.

In particular, the acid cleaning method and the use of ion exchange or nylon filters can effectively reduce ionic metals, and the combination of high-definition high-density polyethylene particulate removal filters can provide dramatic metal removal effects.

The present application claims the priority based on the Japanese patent application (Japanese Patent Application No. 2019-003493) filed on Jan. 11, 2019, and the entire contents of the Japanese patent application are incorporated herein by reference.

### INDUSTRIAL APPLICABILITY

The present invention provides a novel polycyclic polyphenolic resin in which aromatic hydroxy compounds having a specific skeleton are linked to each other without a crosslinking group, that is, the aromatic rings are linked to each other by a direct bond. Such a polycyclic polyphenolic resin is excellent in heat resistance, etching resistance, heat flow property, solvent solubility, and the like, and particularly excellent in heat resistance and etching resistance, and can be used as a coating agent for semiconductors, a material for resists, and a semiconductor underlayer film forming material.

1. A polycyclic polyphenolic resin having a repeating unit derived from at least one monomer selected from the group consisting of an aromatic hydroxy compound represented by the following formulae (1A) and (1B),
wherein the repeating units are linked to each other by a direct bond between aromatic rings: 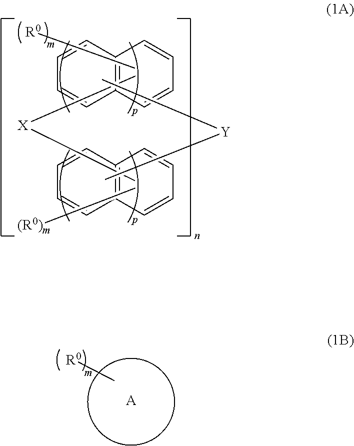
wherein X represents an oxygen atom, a sulfur atom, a single bond or non-crosslinked state, and Y represents a 2n-valent group having 1 to 60 carbon atoms or a single bond, wherein when X is non-crosslinked state, Y represents the 2n-valent group; A represents a benzene ring or a fused ring; each RD is independently an alkyl group having 1 to 40 carbon atoms and optionally having a substituent, an aryl group having 6 to 40 carbon atoms and optionally having a substituent, an alkenyl group having 2 to 40 carbon atoms and optionally having a substituent, an alkynyl group having 2 to 40 carbon atoms, an alkoxy group having 1 to 40 carbon atoms and optionally having a substituent, a halogen atom, a thiol group, or a hydroxy group, wherein at least one RD is a hydroxy group; and each m is independently an integer of 1 to 9; and n is an integer of 1 to 4; and each p is independently an integer of 0 to 3.

2. The polycyclic polyphenolic resin according to claim 1, wherein the aromatic hydroxy compound represented by the formula (1A) is an aromatic hydroxy compound represented by the following formula (1): 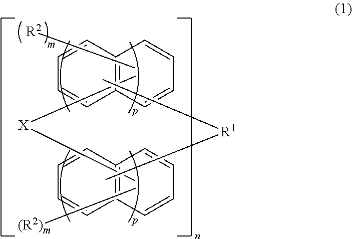
wherein X, m, n, and p are as defined in the formula (1A); R¹ is as defined in Y in the formula (1A); and each R² is independently an alkyl group having 1 to 40 carbon atoms, an aryl group having 6 to 40 carbon atoms, an alkenyl group having 2 to 40 carbon atoms, an alkynyl group having 2 to 40 carbon atoms, an alkoxy group having 1 to 40 carbon atoms, a halogen atom, a thiol group, or a hydroxy group, wherein at least one R² is a hydroxy group.

3. The polycyclic polyphenolic resin according to claim 2, wherein the aromatic hydroxy compound represented by the formula (1) is an aromatic hydroxy compound represented by the following formula (1-1): 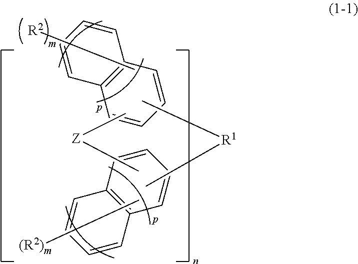
wherein Z is an oxygen atom or a sulfur atom; and R¹, R², m, p, and n are as defined in the formula (1).

4. The polycyclic polyphenolic resin according to claim 3, wherein the aromatic hydroxy compound represented by the formula (1-1) is an aromatic hydroxy compound represented by the following formula (1-2): 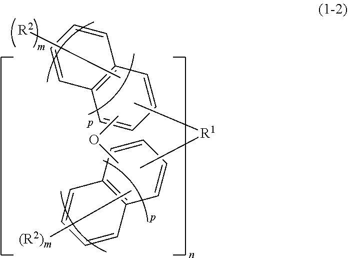
wherein R¹, R², m, p, and n are as defined in the formula (1).

5. The polycyclic polyphenolic resin according to claim 4, wherein the aromatic hydroxy compound represented by the formula (1-2) is an aromatic hydroxy compound represented by the following formula (1-3): 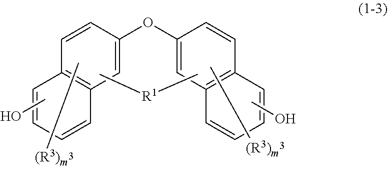
wherein R¹ is as defined in the formula (1); each R³ is independently an alkyl group having 1 to 40 carbon atoms, an aryl group having 6 to 40 carbon atoms, an alkenyl group having 2 to 40 carbon atoms, an alkynyl group having 2 to 40 carbon atoms, an alkoxy group having 1 to 40 carbon atoms, a halogen atom, or a thiol group; and each m³ is independently an integer of 0 to 5.

6. The polycyclic polyphenolic resin according to claim 1, wherein the aromatic hydroxy compound represented by the formula (1A) is an aromatic hydroxy compound represented by the following formula (2): 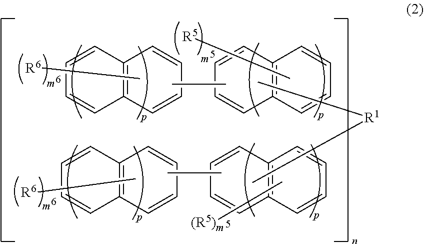
wherein R¹ is as defined in Y in the formula (1A); and R⁵, n, and p are as defined in the formula (1A), each R⁶ is independently a hydrogen atom, an alkyl group having 1 to 34 carbon atoms, an aryl group having 6 to 34 carbon atoms, an alkenyl group having 2 to 34 carbon atoms, an alkynyl group having 2 to 40 carbon atoms, an alkoxy group having 1 to 34 carbon atoms, a halogen atom, a thiol group, or a hydroxy group; each m⁵ is independently an integer of 1 to 6; and each m⁶ is independently an integer of 1 to 7, wherein at least one R⁵ is a hydroxy group.

7. The polycyclic polyphenolic resin according to claim 6, wherein the aromatic hydroxy compound represented by the formula (2) is an aromatic hydroxy compound represented by the following formula (2-1): 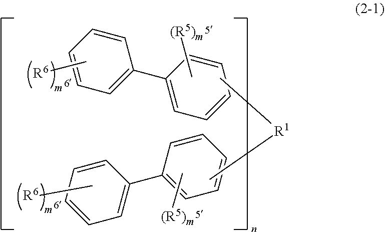
wherein R¹, R⁵, R⁶, and n are as defined in the formula (2); each m⁵′ is independently an integer of 1 to 4; and each m⁶′ is independently an integer of 1 to 5, wherein at least one R⁵ is a hydroxy group.

8. The polycyclic polyphenolic resin according to claim 6, wherein at least one R⁶ is a hydroxy group.

9. The polycyclic polyphenolic resin according to claim 7, wherein the aromatic hydroxy compound represented by the formula (2-1) is an aromatic hydroxy compound represented by the following formula (2-2): 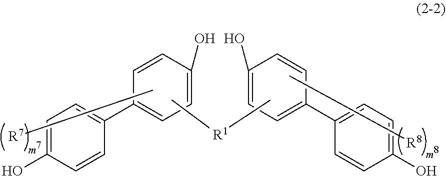
wherein R¹ is as defined in the formula (2); R⁷ and R⁸ are each independently a hydrogen atom, an alkyl group having 1 to 40 carbon atoms, an aryl group having 6 to 40 carbon atoms, an alkenyl group having 2 to 40 carbon atoms, an alkynyl group having 2 to 40 carbon atoms, an alkoxy group having 1 to 40 carbon atoms, a halogen atom, a thiol group, or a hydroxy group; and m⁷ and m⁸ are each independently an integer of 0 to 7.

10. The polycyclic polyphenolic resin according to claim 1, further having a modified moiety derived from a crosslinking compound.

11. (canceled)

12. (canceled)

13. (canceled)

14. The polycyclic polyphenolic resin according to claim 1, wherein A in the formula (1B) is the fused ring.

15. The polycyclic polyphenolic resin according to claim 2, wherein the R¹ is a group represented by R^{A}—R^{B}, wherein R^{A} is a methine group, and R^{B} is an aryl group having 6 to 30 carbon atoms and optionally having a substituent.

16. A composition comprising the polycyclic polyphenolic resin according to claim 1.

17. The composition according to claim 16, further comprising a solvent.

18. The composition according to claim 17, wherein the solvent comprises one or more selected from the group consisting of propylene glycol monomethyl ether, propylene glycol monomethyl ether acetate, cyclohexanone, cyclopentanone, ethyl lactate, and methyl hydroxyisobutyrate.

19. The composition according to claim 16, wherein a content of impurity metal is less than 500 ppb for each metallic species.

20. The composition according to claim 19, wherein the impurity metal comprises at least one selected from the group consisting of copper, manganese, iron, cobalt, ruthenium, chromium, nickel, tin, lead, silver and palladium.

21. The composition according to claim 19, wherein the content of the impurity metal is 1 ppb or less.

22. A method for producing the polycyclic polyphenolic resin according to claim 1, the method comprising:
polymerizing one or more aromatic hydroxy compounds in a presence of an oxidizing agent.

23. The method for producing the polycyclic polyphenolic resin according to claim 22, wherein the oxidizing agent is a metal salt or a metal complex comprising at least one selected from the group consisting of copper, manganese, iron, cobalt, ruthenium, chromium, nickel, tin, lead, silver and palladium.
